(19) United States
(12) Patent Application Publication
(10) Pub. No.: US 2026/0050878 A1
(43) Pub. Date: Feb. 19, 2026

(54) MULTI-COMMUNICATION-INTERFACE SYSTEM FOR FINE LOCATIONING

(71) Applicant: Trackonomy Systems, Inc., San Jose, CA (US)

(72) Inventors: Hendrik J. Volkerink, Palo Alto, CA (US); Ajay Khoche, West San Jose, CA (US); Carl M. Skonberg, Long Beach, NY (US); Saurabh Sanghai, Cupertino, CA (US)

(21) Appl. No.: 19/367,557

(22) Filed: Oct. 23, 2025

Related U.S. Application Data
(63) Continuation of application No. 18/126,707, filed on Mar. 27, 2023.
Application No. 18/126,707 is a continuation-in-part of application No. 17/931,518, filed on Sep. 12, 2022, now Pat. No. 12,363,512.
Application No. 17/931,518 is a continuation-in-part of application No. 17/873,072, filed on Jul. 25, 2022.
(60) Provisional application No. 63/225,550, filed on Jul. 25, 2021.
(60) Provisional application No. 63/225,550, filed on Jul. 25, 2021.
(60) Provisional application No. 63/243,182, filed on Sep. 12, 2021.
(60) Provisional application No. 63/324,024, filed on Mar. 26, 2022.
(60) Provisional application No. 63/324,024, filed on Mar. 26, 2022.

(51) Int. Cl. G06Q 10/0833; G06K 7/10; G06Q 10/083

(52) U.S. Cl. CPC G06Q 10/0833; G06K 7/10297; G06Q 10/0838

(57) ABSTRACT

A multi-communication-interface system methods implement fine locationing while conserving battery power. A first wireless-communication interface of a first multi-communication-interface tape node located at a first location in an area detect a first wireless signal from a second tape node at a first time. A first receiver of a second wireless-communication interface of the first multi-communication-interface tape node is activated in response to detecting the first wireless signal and used to receive a first response signal from a first wireless tag in response to an interrogation signal. The first receiver is deactivated to conserve power within an internal battery of the at least one second multi-communication-interface tape node and a location of the first wireless tag at the first time is determined as the first location.

### RELATED APPLICATIONS

This application is a Continuation of U.S. patent application Ser. No. 18/126,707, titled “System and Method for Detection and Tracking of Assets in a Vehicle”, filed Mar. 27, 2023, which is a Continuation-In-Part of U.S. patent application Ser. No. 17/931,518 titled “Multi-Communication-Interface System For Fine Locationing” filed Sep. 12, 2022, which claims priority to U.S. Patent Application No. 63/243,182, titled “Hybrid RFID and Wireless Communication System for Fine Locationing,” filed Sep. 12, 2021, to U.S. Patent Application No. 63/324,024, titled “System and Method for Detection and Tracking of Assets in a Vehicle,” filed Mar. 26, 2022, and is a Continuation-In-Part of U.S. patent application Ser. No. 17/873,072, titled “Hybrid RFID and Wireless Communication System for Tracking of Assets and People and Method Thereof,” filed Jul. 25, 2022, which claims priority to U.S. Patent Application No. 63/225,550, filed Jul. 25, 2021. Each of the above applications is incorporated herein by reference in its entirety.

### FIELD OF THE DISCLOSURE

This disclosure generally relates to wireless internet of things (IOT) devices and systems and methods for asset tracking using wireless readers.

### BACKGROUND

Radio frequency identification (RFID) tags are frequently used to inventory assets in a monitored area. However, the accuracy of conventional RFID tag locationing is limited to determining whether the RFID tag (asset) is, or is not, within the monitored area. Asset logistics require transport of assets in vehicles, such as delivery vans. Transportation and delivery of assets is delayed and less efficient when assets are incorrectly loaded onto the wrong vehicle, when the wrong asset is unloaded from the vehicle, and when the operator is unable to locate the assets within the vehicle for drop off at its delivery location.

Location assets using Bluetooth has low power usage, but has limited resolution (e.g., accuracy of the location) due to the range of Bluetooth wireless signals. RFID readers require a significant amount power and therefore battery powered solutions are difficult.

### SUMMARY

One aspect of the present embodiments includes the realization that significant time and efficiency is lost when an asset is incorrectly loaded onto a vehicle. It is further realized that the optimal time to correct a loading error is during the loading of the asset onto the vehicle. A further realization is that it is also important to ensure that an asset is not incorrectly unloaded and delivered to the wrong location for example. Advantageously, the present embodiments solve this problem by detecting when an asset is being incorrectly loaded or incorrectly unloaded to/from a vehicle and providing an immediate alert to the operator. The immediate nature of the alert (e.g., in-real time via a notification device at the location of the vehicle) has the further advantage that the asset is likely in hand when the alert if given allowing immediate resolution of the error.

Another aspect of the present embodiments includes the realization that efficiency of delivery relies on assets being correctly stored and easily located within the vehicle. For example, when arriving at a delivery location for an asset the operator need to quickly find the correct asset to unload. Advantageously the present embodiments solve this problem by providing a fine RFID location tracking solution within the vehicle to (a) ensure each asset is placed in an expected rack and slot within the vehicle, and (b) provide an indication to the operator of where an asset to be unloaded is located within the vehicle, such as when arriving at its delivery location.

In some aspects, the techniques described herein relate to a system for a detecting and tracking assets in a vehicle, including: an RFID reader; at least one cargo area RFID antenna positioned within a cargo area of the vehicle and communicatively coupled with the RFID reader; and an RFID controller including: a status indicator for generating a visual indication; a processor; and memory, communicatively coupled with the processor and storing: a manifest defining RFID identifiers corresponding to assets expected to be transported by the vehicle; and firmware having machine-readable instructions that, when executed by the processor, cause the processor to: control the RFID reader to receive an RFID signal from an RFID tag using one of the at least one cargo area RFID antenna, decode the RFID signal to determine an RFID identifier of the RFID tag, and generate, using the status indicator, a visual indication indicative of an asset being loaded in error when the RFID identifier does not correspond to the manifest or not in error when the RFID identifier corresponds to the manifest.

In some aspects, the techniques described herein relate to a method including: receiving data indicative of a potential change in a load status of assets in a vehicle; in response, controlling an RFID reader to generate an interrogation signal by at least one cargo area RFID antenna located in a cargo area of the vehicle and receive an RFID signal associated with an RFID tag attached to an asset in response to the interrogation signal; determining that an asset is being loaded onto the vehicle based on the received RFID signal; decoding the RFID signal to determine an RFID identifier of the RFID tag; updating a local database stored on a device in the vehicle with the RFID identifier; and tracking the location of the asset within the interior of the vehicle, based on further received RFID signals from the RFID tag.

In some aspects, the techniques described herein relate to a method for a detecting and tracking assets in a vehicle, including: controlling an RFID reader to receive an RFID signal associated with an RFID tag in response to an interrogation signal transmitted by at least one cargo area RFID antenna located in a cargo area of the vehicle; decoding the RFID signal to determine an RFID identifier of the RFID tag; and generating, using a status indicator, a visual indication indicative of an asset being loaded in error when the RFID identifier is not listed in a manifest or not in error when the RFID identifier corresponds to the manifest.

In some aspects, the techniques described herein relate to a system for assisting in loading an unloading a vehicle, including: a rack having a plurality of slots each sized and shaped for storing an asset; a plurality of slot RFID devices each associated with one of the slots, each slot RFID device including: a wireless transducing circuit that facilitates communication with an RFID controller external to the slot RFID device, a processor, and memory storing computer-readable instructions that when executed by the processor cause the slot RFID device to respectively: identify one or more RFID tags located within the respective slot, transmit indication of presence of one or more RFID tags located within the slot.

One aspect of the present embodiments includes the realization that short-range wireless protocols, such as Bluetooth, when used for locationing, have a resolution that is relatively coarse due to the range of a Bluetooth signal, particularly where that signal is used for establishing a mesh network of devices. That is, any received Bluetooth signal is determined to be within a radius, defined by the Bluetooth signal range, of the receiving device. Radio frequency identification (RFID) has a shorter wireless signal range, and thereby improves the resolution/accuracy of location determined by proximity to an RFID reader; however, RFID readers require more power to operate as compared to Bluetooth, and therefore RFID readers suffer from limited operational lifespan due when powered via a battery power source. Accordingly, RFID readers are typically hard wired to a power source, thereby limiting their practicality for easy deployment and mobility. The present embodiments solve this problem by providing a battery-powered multi-communication-interface tape node that is (a) easily deployed, since it is battery powered and available in many form factors (e.g., stick-on flexible tape, stick-on rigid case, and so on), and (b) employs an event driven power management of a wireless reader to save power. Advantageously, by activating the wireless reader, which may be RFID-based, in response to detecting an event using another wireless-communication interface, which may be Bluetooth-based, the wireless reader remains powered off until needed to read a wireless tag and may be deactivated once the wireless tag has been read. This is an improvement over solutions that periodically activate a higher-power consumption wireless reader to detect wireless tags, since periodic activation misses wireless tags that pass through the range of the wireless reader when deactivated. By activating the wireless reader in response to certain events associated with wireless tag movement, the wireless reader does not miss changes in wireless tag inventory.

Another aspect of the present embodiments includes the realization that multi-communication-interface battery powered tape nodes may be easily deployed within an area to implement fine locationing in that area. These tape nodes are easily attached (e.g., stick-on) to walls, doors, and ceilings of the area (e.g., a room, a vehicle, a loading dock, and so on) since they do not require hard wiring for power or communications. These tape nodes may cooperate to improve locationing within the area by operating with a reduced range that improved locationing accuracy within the area.

Another aspect of the present embodiments includes the realization that the multi-communication-interface battery powered tape nodes may not require RFID transmit capability when a separate RFID illuminator is located within the same area. That is, the multi-communication-interface battery powered tape node may include an RFID receiver to receive and decode RFID signals from RFID tags. The RFID illuminator transmits an RFID interrogation signal to activate any RFID tag within the area, and the multi-communication-interface battery powered tape node receives the RFID tag responses. By using a shorter receiving range than a convention RFID reader, the multi-communication-interface battery powered tape node may improve locationing accuracy of the RFID tag.

Another aspect of the present embodiments includes the realization that when an external RFID reader and/or an external RFID illuminator operate substantially continuously to detect RFID tags, the multi-communication-interface battery powered tape nodes may operate in reverse, whereby an RFID reader substantially continually operates to receive RFID tag response signals and the multi-communication-interface battery powered tape nodes activate another wireless interface (e.g., Bluetooth) when an RFID tag response signal is detected—or changes in RFID response signals are detected.

Similar advantages are achieved using wireless protocols other than RFID and Bluetooth, such as where a first wireless protocol having a first power consumption rate is triggered using a second wireless protocol having a second power consumption less than the first power consumption rate.

In certain embodiments, a method implements fine locationing using a multi-communication-interface system. The method detects, at a first time using a first wireless-communication interface of a first multi-communication-interface tape node located at a first location in an area, a first wireless signal from a second tape node. A first receiver of a second wireless-communication interface of the first multi-communication-interface tape node is activated in response to detecting the first wireless signal and used to receive a first response signal from a first wireless tag in response to an interrogation signal. The first receiver is deactivated and a location of the first wireless tag at the first time is determined as the first location.

In certain embodiments, a method implements fine locationing using a multi-communication-interface system. A first wireless-communication interface of a first multi-communication-interface tape node at a first doorway of a first area is used to detect a first wireless signal transmitted from a second wireless-communication interface of a wearable multi-communication-interface tape node worn by an operator. The first multi-communication-interface tape node sends, via the first wireless-communication interface, a trigger event message. A first reader of at least one second multi-communication-interface tape node positioned within the first area is activated in response to receiving the trigger event message. At least one first response signal from at least one first wireless tag within a coverage area of the first reader is detected and the first reader is deactivated after detecting the at least one first response signal to conserve power within an internal battery of the at least one second multi-communication-interface tape node.

In certain embodiments, a multi-communication-interface tape node powered from an internal battery, includes: a first wireless-communication interface implementing a first wireless protocol; a second wireless-communication interface implementing a second wireless protocol that consumes more power than the first wireless protocol when operational, the second wireless-communication interface having a transmitter and a receiver; a processor; and memory storing machine-readable instructions that, when executed by the processor, cause the processor to: detect a trigger event using the first wireless-communication interface; transition the second wireless-communication interface from an off state to an on state; receive a wireless response signal from a wireless tag via the receiver; decode a wireless identifier from the wireless response signal; and transition the second wireless-communication interface from the on state to the off state to conserve power in the internal battery.

### BRIEF DESCRIPTION OF THE FIGURES

FIG. 1 is a schematic illustrating one example adhesive tape-agent platform used to seal a package for shipment, in embodiments.

FIG. 2 is a schematic illustrating a non-adhesive surface of a segment of the adhesive tape agent platform of FIG. 1, in embodiments.

FIG. 3 shows one example adhesive tape platform that includes a set of adhesive tape platform segments on a backing sheet, in embodiments.

FIG. 4 is a block diagram illustrating components of an example wireless transducing circuit that includes one or more wireless communication modules, in embodiments.

FIG. 5 is a top view of a portion of an example flexible adhesive tape platform illustrating a first segment and a portion of a second segment, in embodiments.

FIGS. 6A-C are schematic diagrams illustrating cross-sectional side views of portions of example segments of three types of flexible adhesive tape agent platforms, in embodiments.

FIG. 7A is a schematic diagram illustrating an adhesive tracking product with a first example wake circuit that delivers power from an energy source to the tracking circuit in response to an event, in embodiments.

FIG. 7B is a schematic diagram illustrating an adhesive tracking product with a second example wake circuit that delivers power from an energy source to the tracking circuit in response to an event.

FIG. 7C is a diagrammatic cross-sectional front view of an example adhesive tape platform and a perspective view of an example asset, in embodiments.

FIG. 8 is a schematic illustrating an example network communications environment that includes a network supporting communications between servers, mobile gateways, a stationary gateway, and various types of tape nodes associated with various assets, in embodiments.

FIG. 9 is a schematic illustrating one example hierarchical wireless communications network of tape nodes, in embodiments.

FIG. 10 is a flowchart illustrating one example method of creating a hierarchical communications network, in embodiments.

FIG. 11A shows a node (Node A) associated with a package (Package A), in embodiments.

FIG. 11B shows a node (Node C) associated with a package (Package C), in embodiments.

FIG. 11C shows a pallet associated with a master node that includes a low-power communications interface, a GPS receiver, and a cellular communications interface, in embodiments.

FIG. 12 is a schematic illustrating a truck configured as a mobile node, or mobile hub, with a cellular communications interface, a medium-power communications interface, and a low power communications interface, in embodiments.

FIG. 13 is a schematic illustrating a master node associated with a logistic item that is grouped together with other logistic items associated with peripheral nodes, in embodiments.

FIG. 14 is a schematic illustrating one example multi-communication-interface tape node that includes both a first wireless-communication interface and a second wireless-communication interface, in embodiments.

FIG. 15 is a schematic diagram illustrating operation of one example multi-communication-interface system for fine locationing, in embodiments.

FIG. 16 is a schematic diagram illustrating operation of one example multi-communication-interface system for fine locationing, in embodiments.

FIG. 17 is a flowchart illustrating one example method for fine locationing using a multi-communication-interface system, in embodiments.

FIG. 18 is a schematic diagram illustrating one example multi-communication-interface system that eliminates false detection of RFID tags, in embodiments.

FIG. 19 shows one example wearable RFID tape node, in embodiments.

FIG. 20 is a schematic diagram illustrating example use of a multi-communication-interface system to provide fine locationing for a vehicle carrying an asset having at least an RFID tag, in embodiments.

FIG. 21 is a flowchart illustrating one example method 2100 for fine locationing using a multi-communication-interface system, in embodiments.

FIG. 22 is a block diagram showing one example multi-communication-interface tape node with a wake circuit operated by an embedded wireless tag, in embodiments.

FIG. 23 shows one example computer apparatus that, either alone or in combination with one or more other computing apparatus, is operable to implement one or more of the computer systems described in this specification, in embodiments.

FIG. 24 is a block diagram illustrating one example RFID reader system configured for use in a vehicle, in embodiments.

FIG. 25 is a schematic diagram illustrating example fitting of RFID reader system to a vehicle, in embodiments.

FIG. 26 is a schematic illustrating one example monolithic RFID reader apparatus, in embodiments.

FIG. 27 is a schematic diagram illustrating example fitting of RFID reader system to the vehicle of FIG. 25, in embodiments.

FIG. 28 is a diagram illustrating a rear end of the vehicle of FIG. 27, according to certain embodiments.

FIG. 29 shows one example monolithic RFID reader apparatus, in embodiments.

FIG. 30 is a perspective schematic illustrating one example slot tracking system within the vehicle of FIG. 25, in embodiments.

FIG. 31 is a perspective view showing one slot of FIG. 30 in further example detail, in embodiments.

FIG. 32 is a block diagram showing a warehouse that stores assets for transportation by vehicles, in embodiments.

FIG. 33 is a perspective diagram illustrating example use of wireless RFID tape nodes within a vehicle to provide more fidelity to the RFID reader system of FIGS. 24-23, in embodiments.

FIG. 34 shows an example operating environment of the RFID reader systems, in embodiments.

FIG. 35 is a flowchart showing one example method for detecting and tracking assets in a vehicle, in embodiments.

### DETAILED DESCRIPTION OF THE EMBODIMENTS

The present invention is not limited in any way to the illustrated embodiments. Instead, the illustrated embodiments described below are merely examples of the invention. Therefore, the structural and functional details disclosed herein are not to be construed as limiting the claims. The disclosure merely provides bases for the claims and representative examples that enable one skilled in the art to make and use the claimed inventions. Furthermore, the terms and phrases used herein are intended to provide a comprehensible description of the invention without being limiting.

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements and are not drawn to scale.

In some contexts, the term “agent” may refer to a “node”, and an “agent” or “node” may be adhesively applied to a surface and denoted as a “tape node” or “tape agent”. These terms may be used interchangeably, depending on the context. Further, the “agent” or “node” may have two forms of hierarchy: one depending on the functionality of the “agent” or “node”, such as the range of a wireless-communication interface, and another depending on which “agent” or “node” may control another “agent” or “node”. For example, an agent with a low-power wireless-communication interface may be referred to a “master agent”.

In some embodiments, a low-power wireless-communication interface may have a first wireless range and be operable to implement one or more protocols including Zigbee, near-field communication (NFC), Bluetooth Low Energy, Bluetooth Classic, Wi-Fi, and ultra-wideband. For example, the low-power wireless-communication interface may have a range of between 0 and 300 meters or farther, depending on the implemented protocol. The communication interface implementation, e.g., Zigbee or Bluetooth Low Energy, may be selected based upon the distance of communication between the low-power wireless-communication interface and the recipient, and/or a remaining battery level of the low-power wireless-communication interface.

An agent with a medium-power wireless communication-interface may be referred to as a “secondary agent”. The medium-power wireless-communication interface may have a second wireless range and be operable to implement one or more protocols including Zigbee, Bluetooth Low Energy interface, LoRa. For example, the medium-power wireless-communication interface may have a range of between 0 and 20 kilometers. The communication interface implementation, e.g., Zigbee, Bluetooth Low Energy, or LoRa, may be selected based upon the distance of communication between the medium-power wireless-communication interface and the recipient, and/or a remaining battery level of the medium-power wireless-communication interface.

An agent with a high-power wireless communication-interface may be referred to as a “tertiary agent”. The high-power wireless-communication interface may have a third wireless range and be operable to implement one or more protocols including Zigbee, Bluetooth Low Energy, LoRa, Global System for Mobile Communication, General Packet Radio Service, cellular, near-field communication, and radio-frequency identification. For example, the high-power wireless-communication interface may have a global range, where the high-power wireless-communication interface may communicate with any electronic device implementing a similar communication protocol. The communication interface protocol selected may depend on the distance of communication between the high-power wireless-communication interface and a recipient, and/or a remaining battery level of the high-power wireless-communication interface.

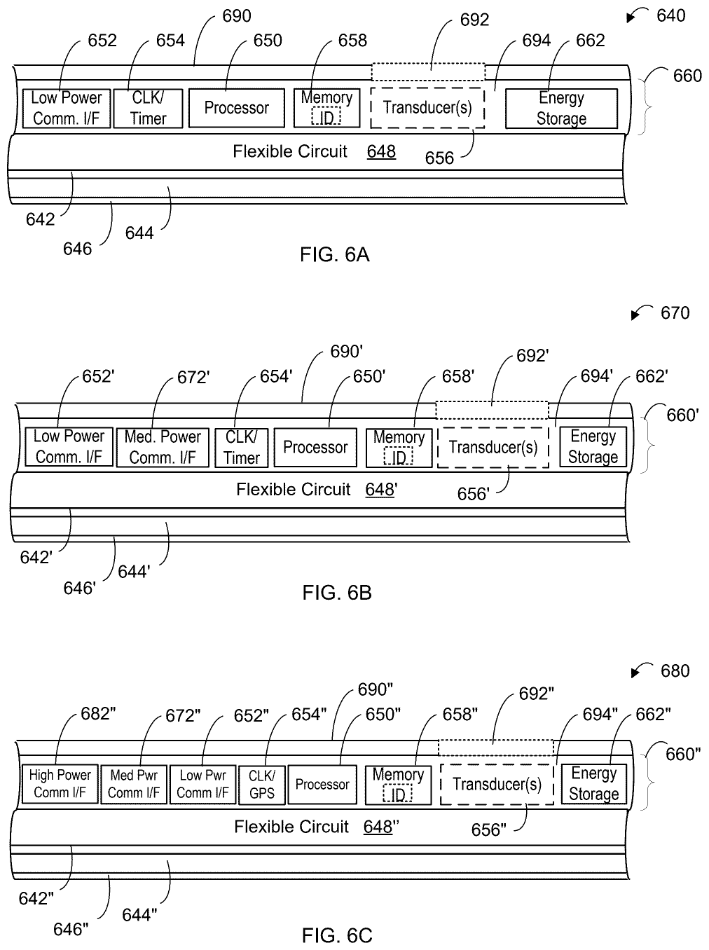

In some examples, a secondary agent may also include a low-power wireless-communication interface and a tertiary agent may also include low and medium-power wireless-communication interfaces, as discussed below with reference to FIGS. 6A-C and/or 11A-C. Further continuing the example, a “master agent”, a “secondary agent”, or a “tertiary agent” may refer to a “master tape node”, a “secondary tape node”, or a “tertiary tape node”.

With regard to the second form of hierarchy, the “agent”, “node”, “tape agent”, and “tape node”, may be qualified as a parent, child, or master, depending on whether a specific “agent” or “node” controls another “agent” or “node”. For example, a master-parent agent controls the master-child agent and a secondary or tertiary-parent agent controls a master-child agent. The default, without the qualifier of “parent” or “child” is that the master agent controls the secondary or tertiary agent Further, the “master tape node” may control a “secondary tape node” and a “tertiary tape node”, regardless of whether the master tape node is a parent node.

Further, each of the “agents”, “nodes”, “tape nodes”, and “tape agents” may be referred to as “intelligent nodes”, “intelligent tape nodes”, “intelligent tape agents”, and/or “intelligent tape agents” or any variant thereof, depending on the context and, for ease, may be used interchangeably.

Further, each of the “agents”, “nodes”, “tape nodes”, and “tape agents” may include flexible or non-flexible form factors unless otherwise specified. Thus, each of the “agents”, “nodes”, “tape nodes”, and “tape agents” include flexible and non-flexible (rigid) form factors, or a combination thereof including flexible components and non-flexible components.

An adhesive tape platform includes a plurality of segments that may be separated from the adhesive product (e.g., by cutting, tearing, peeling, or the like) and adhesively attached to a variety of different surfaces to inconspicuously implement any of a wide variety of different wireless communications-based network communications and transducing (e.g., sensing, actuating, etc.) applications. In certain embodiments, each segment of an adhesive tape platform has an energy source, wireless communication functionality, transducing functionality (e.g., sensor and energy harvesting functionality), and processing functionality that enable the segment to perform one or more transducing functions and report the results to a remote server or other computer system directly or through a network (e.g., formed by tape nodes and/or other network components). The components of the adhesive tape platform are encapsulated within a flexible adhesive structure that protects the components from damage while maintaining the flexibility needed to function as an adhesive tape (e.g., duct tape or a label) for use in various applications and workflows. In addition to single function applications, example embodiments also include multiple transducers (e.g., sensing and/or actuating transducers) that extend the utility of the platform by, for example, providing supplemental information and functionality relating characteristics of the state and/or environment of, for example, an article, object, vehicle, or person, over time.

Systems and processes for fabricating flexible multifunction adhesive tape platforms in efficient and low-cost ways also are described in US Patent Application Publication No. US-2018-0165568-A1. For example, in addition to using roll-to-roll and/or sheet-to-sheet manufacturing techniques, the fabrication systems and processes are configured to optimize the placement and integration of components within the flexible adhesive structure to achieve high flexibility and ruggedness. These fabrication systems and processes are able to create useful and reliable adhesive tape platforms that may provide local sensing, wireless transmitting, and positioning functionalities. Such functionality together with the low cost of production is expected to encourage the ubiquitous deployment of adhesive tape platform segments and thereby alleviate at least some of the problems arising from gaps in conventional infrastructure coverage that prevent continuous monitoring, event detection, security, tracking, and other logistics applications across heterogeneous environments.

As used herein, the term “or” refers an inclusive “or” rather than an exclusive “or.” In addition, the articles “a” and “an” as used in the specification and claims mean “one or more” unless specified otherwise or clear from the context to refer the singular form.

The terms “module,” “manager,” “component”, and “unit” refer to hardware, software, or firmware, or a combination thereof. The term “processor” or “computer” or the like includes one or more of: a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC), a memory controller, bus controller, and other components that manage data flow between said processor associated memory, and other components communicably coupled to the system bus. Thus the terms “module,” “manager,” “component”, and “unit” may include computer readable instructions that, when executed by a processor, implement the functionality discussed herein with respect to said “module,” “manager,” “component”, and “unit”.

### Adhesive Tape Agent Platform

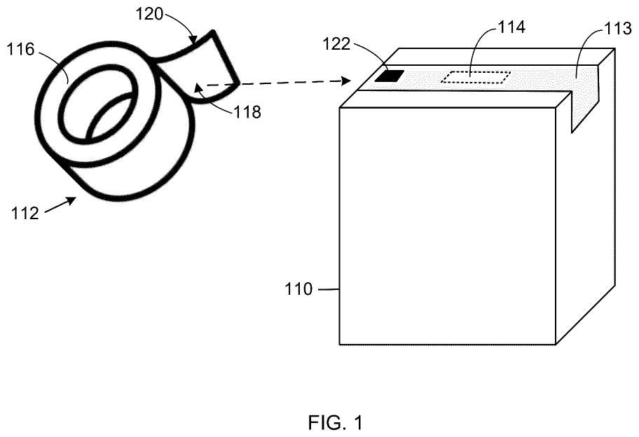

FIG. 1 is a schematic illustrating one example adhesive tape-agent platform 112, including wireless transducing circuit 114, used to seal a package 110 for shipment. In this example, a segment 113 of the adhesive tape-agent platform 112 is dispensed from a roll 116 and affixed to the package 110. The adhesive tape-agent platform 112 includes an adhesive side 118 and a non-adhesive surface 120. The adhesive tape-agent platform 112 may be dispensed from the roll 116 in the same way as any conventional packing tape, shipping tape, or duct tape. For example, the adhesive tape-agent platform 112 may be dispensed from the roll 116 by hand, laid across the seam where the two top flaps of the package 110 meet, and cut to a suitable length either by hand or using a cutting instrument (e.g., scissors or an automated or manual tape dispenser). Examples of such tape agents include tape agents having non-adhesive surface 120 that carry one or more coatings or layers (e.g., colored, light reflective, light absorbing, and/or light emitting coatings or layers). Further, the segment 113 may include an identifier 122 (e.g., a QR code, Radio Frequency Identification (RFID) chip, etc.) that may be used to associate the segment 113 with the package 110, as discussed below.

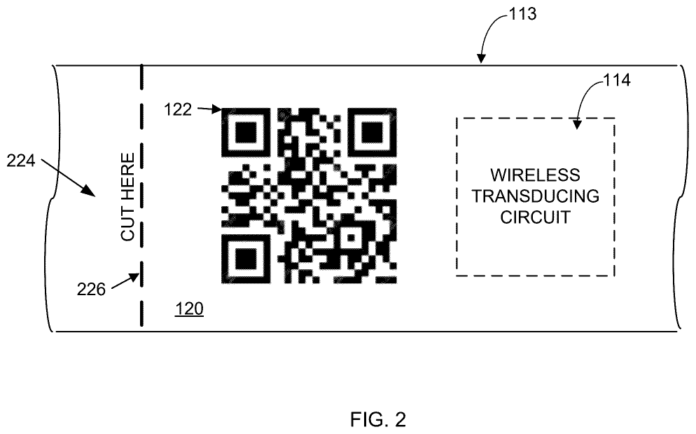

FIG. 2 is a schematic illustrating a non-adhesive surface 120 of the segment 113 of the adhesive tape agent platform 112 of FIG. 1 including writing or other markings that convey instructions, warnings, or other information to a person or machine (e.g., a bar code reader), or may simply be decorative and/or entertaining. For example, different types of adhesive tape-agent platforms may be marked with distinctive colorations to distinguish one type of adhesive tape agent platform from another. In the illustrated example of FIG. 2, the segment 113 of the adhesive tape agent platform 112 includes an identifier 122 (e.g., a two-dimensional bar code, such as a QR Code), written instructions 224 (e.g., “Cut Here”), and an associated cut line 226 that indicates where the user should cut the adhesive tape agent platform 112. The written instructions 224 and the cut line 226 typically are printed or otherwise marked on the top non-adhesive surface 120 of the adhesive tape agent platform 112 during manufacture. The identifier 122 (e.g., a two-dimensional bar code), on the other hand, may be marked on the non-adhesive surface 120 of the adhesive tape agent platform 112 during the manufacture of the adhesive tape agent platform 112 or, alternatively, may be marked on the non-adhesive surface 120 of the adhesive tape agent platform 112 as needed using, for example, a printer or other marking device.

To avoid damaging the functionality of the segments of the adhesive tape agent platform 112, the cut lines 226 may demarcate the boundaries between adjacent segments at locations that are free of any active components of the wireless transducing circuit 114. The spacing between the wireless transducing circuit 114 and the cut lines 226 may vary depending on the intended communication, transducing and/or adhesive taping application. In the example illustrated in FIG. 1, the length of the adhesive tape-agent platform 112 that is dispensed to seal the package 110 corresponds to a single segment of the adhesive tape-agent platform 112. In other examples, the length of the adhesive tape-agent platform 112 needed to seal a package or otherwise serve the adhesive function for which the adhesive tape-agent platform 112 is being applied may include multiple segments 113 of the adhesive tape-agent platform 112, one or more of which segments 113 may be activated upon cutting the length of the adhesive tape-agent platform 112 from the roll 116 and/or applying the segment 113 of the adhesive tape agent platform to the package 110.

In some examples, the wireless transducing circuits 114 embedded in one or more segments 113 of the adhesive tape-agent platform 112 are activated when the adhesive tape agent platform 112 is cut along the cut line 226. In these examples, the adhesive tape-agent platform 112 includes one or more embedded energy sources (e.g., thin film batteries, which may be printed, or conventional cell batteries, such as conventional watch style batteries, rechargeable batteries, or other energy storage device, such as a super capacitor or charge pump) that supply power to the wireless transducing circuit 114 in one or more segments of the adhesive tape-agent platform 112 in response to being separated from the adhesive tape-agent platform 112 (e.g., along the cut line 226).

In some examples, each segment 113 of the adhesive tape agent platform 112 includes its own respective energy source. In some embodiments, the energy source is a battery of a type described above, an energy harvesting component or system that harvests energy from the environment, or both. In some of these examples, each energy source is configured to only supply power to the components in its respective adhesive tape platform segment regardless of the number of contiguous segments that are in a given length of the adhesive tape-agent platform 112. In other examples, when a given length of the adhesive tape agent platform 112 includes multiple segments 113, the energy sources in the respective segments 113 are configured to supply power to the wireless transducing circuit 114 in all of the segments 113 in the given length of the adhesive tape agent platform 112. In some of these examples, the energy sources are connected in parallel and concurrently activated to power the wireless transducing circuit 114 in all of the segments 113 at the same time. In other examples, the energy sources are connected in parallel and alternately activated to power the wireless transducing circuit 114 in respective ones of the segments 113 at different time periods, which may or may not overlap.

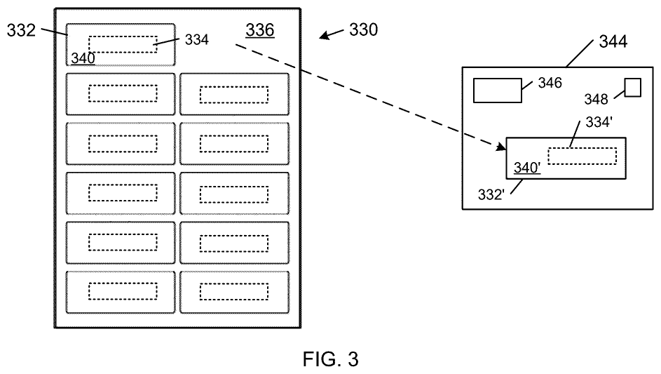

FIG. 3 shows an example adhesive tape platform 330 that includes a set of adhesive tape platform segments 332 each of which includes a respective set of embedded wireless transducing circuit components 334, and a backing sheet 336 with a release coating that prevents the adhesive segments 332 from adhering strongly to the backing sheet 336. Adhesive tape platform 330 may represent adhesive tape platform 112 of FIG. 1. Each adhesive tape platform segment 332 includes an adhesive side facing the backing sheet 336, and an opposing non-adhesive side 340. In this example, a particular segment 332 of the adhesive tape platform 330 has been removed from the backing sheet 336 and affixed to an envelope 344. Each segment 332 of the adhesive tape platform 330 can be removed from the backing sheet 336 in the same way that adhesive labels can be removed from a conventional sheet of adhesive labels (e.g., by manually peeling a segment 332 from the backing sheet 336). In general, the non-adhesive side 340 of the segment 332 may include any type of writing, markings, decorative designs, or other ornamentation. In the illustrated example, the non-adhesive side 340 of the segment 332 includes writing or other markings that correspond to a destination address for the envelope 344. The envelope 44 also includes a return address 346 and, optionally, a postage stamp or mark 348.

In some examples, segments of the adhesive tape platform 330 are deployed by a human operator. The human operator may be equipped with a mobile phone or other device that allows the operator to authenticate and initialize the adhesive tape platform 330. In addition, the operator can take a picture of a parcel including the adhesive tape platform and any barcodes associated with the parcel and, thereby, create a persistent record that links the adhesive tape platform 330 to the parcel. In addition, the human operator typically will send the picture to a network service and/or transmit the picture to the adhesive tape platform 330 for storage in a memory component of the adhesive tape platform 330.

In some examples, the wireless transducing circuit components 334 that are embedded in a segment 332 of the adhesive tape platform 330 are activated when the segment 332 is removed from the backing sheet 336. In some of these examples, each segment 332 includes an embedded capacitive sensing system that can sense a change in capacitance when the segment 332 is removed from the backing sheet 336. As explained in detail below, a segment 332 of the adhesive tape platform 330 includes one or more embedded energy sources (e.g., thin film batteries, common disk-shaped cell batteries, or rechargeable batteries or other energy storage devices, such as a super capacitor or charge pump) that can be configured to supply power to the wireless transducing circuit components 334 in the segment 332 in response to the detection of a change in capacitance between the segment 332 and the backing sheet 336 as a result of removing the segment 332 from the backing sheet 336.

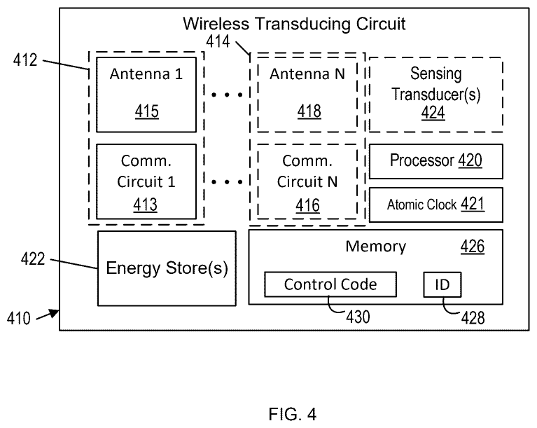

FIG. 4 shows a block diagram of the components of an example wireless transducing circuit 410 (e.g., an agent) that includes one or more wireless communication modules 412, 414. Each wireless communication module 412, 414 includes a wireless communication circuit 413, 416, and an antenna 415, 418, respectively. Each wireless communication circuit 413, 416 may represent a receiver or transceiver integrated circuit that implements one or more of GSM/GPRS, Wi-Fi, LoRa, Bluetooth, Bluetooth Low Energy, Z-wave, and ZigBee. The wireless transducing circuit 410 also includes a processor 420 (e.g., a microcontroller or microprocessor), a solid-state atomic clock 421, at least one energy store 422 (e.g., non-rechargeable or rechargeable printed flexible battery, conventional single or multiple cell battery, and/or a super capacitor or charge pump), one or more sensing transducers 424 (e.g., sensors and/or actuators, and, optionally, one or more energy harvesting transducers). In some examples, the conventional single or multiple cell battery may be a watch style disk or button cell battery that is in an associated electrical connection apparatus (e.g., a metal clip) that electrically connects the electrodes of the battery to contact pads on the wireless transducing circuit 410.

Sensing transducers 424 may represent one or more of a capacitive sensor, an altimeter, a gyroscope, an accelerometer, a temperature sensor, a strain sensor, a pressure sensor, a piezoelectric sensor, a weight sensor, an optical or light sensor (e.g., a photodiode or a camera), an acoustic or sound sensor (e.g., a microphone), a smoke detector, a radioactivity sensor, a chemical sensor (e.g., an explosives detector), a biosensor (e.g., a blood glucose biosensor, odor detectors, antibody based pathogen, food, and water contaminant and toxin detectors, DNA detectors, microbial detectors, pregnancy detectors, and ozone detectors), a magnetic sensor, an electromagnetic field sensor, a humidity sensor, a light emitting units (e.g., light emitting diodes and displays), electro-acoustic transducers (e.g., audio speakers), electric motors, and thermal radiators (e.g., an electrical resistor or a thermoelectric cooler).

Wireless transducing circuit 410 includes a memory 426 for storing data, such as profile data, state data, event data, sensor data, localization data, security data, and/or at least one unique identifier (ID) 428 associated with the wireless transducing circuit 410, such as one or more of a product ID, a type ID, and a media access control (MAC) ID. Memory 426 may also store control code 430 that includes machine-readable instructions that, when executed by the processor 420, cause processor 420 to perform one or more autonomous agent tasks. In certain embodiments, the memory 426 is incorporated into one or more of the processor 420 or sensing transducers 424. In other embodiments, memory 426 is integrated in the wireless transducing circuit 410 as shown in FIG. 4. The control code 430 may implement programmatic functions or program modules that control operation of the wireless transducing circuit 410, including implementation of an agent communication manager that manages the manner and timing of tape agent communications, a node-power manager that manages power consumption, and a tape agent connection manager that controls whether connections with other nodes are secure connections (e.g., connections secured by public key cryptography) or unsecure connections, and an agent storage manager that securely manages the local data storage on the wireless transducing circuit 410. In certain embodiments, a node connection manager ensures the level of security required by the end application and supports various encryption mechanisms. In some examples, a tape agent power manager and communication manager work together to optimize the battery consumption for data communication. In some examples, execution of the control code by the different types of nodes described herein may result in the performance of similar or different functions.

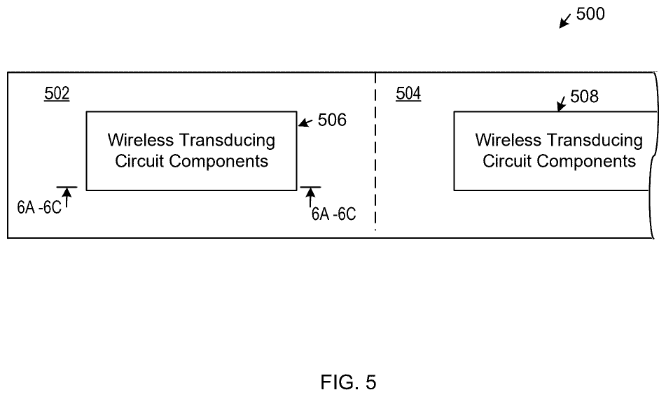

FIG. 5 is a top view of a portion of an example flexible adhesive tape platform 500 that shows a first segment 502 and a portion of a second segment 504. Each segment 502, 504 of the flexible adhesive tape platform 500 includes a respective set 506, 508 of the components of the wireless transducing circuit 410 of FIG. 4. The segments 502, 504 and their respective sets of components 506, 508 typically are identical and configured in the same way. In some other embodiments, however, the segments 502, 504 and/or their respective sets of components 506, 508 are different and/or configured in different ways. For example, in some examples, different sets of the segments of the flexible adhesive tape platform 500 have different sets or configurations of tracking and/or transducing components that are designed and/or optimized for different applications, or different sets of segments of the flexible adhesive tape platform may have different ornamentations (e.g., markings on the exterior surface of the platform) and/or different (e.g., alternating) lengths.

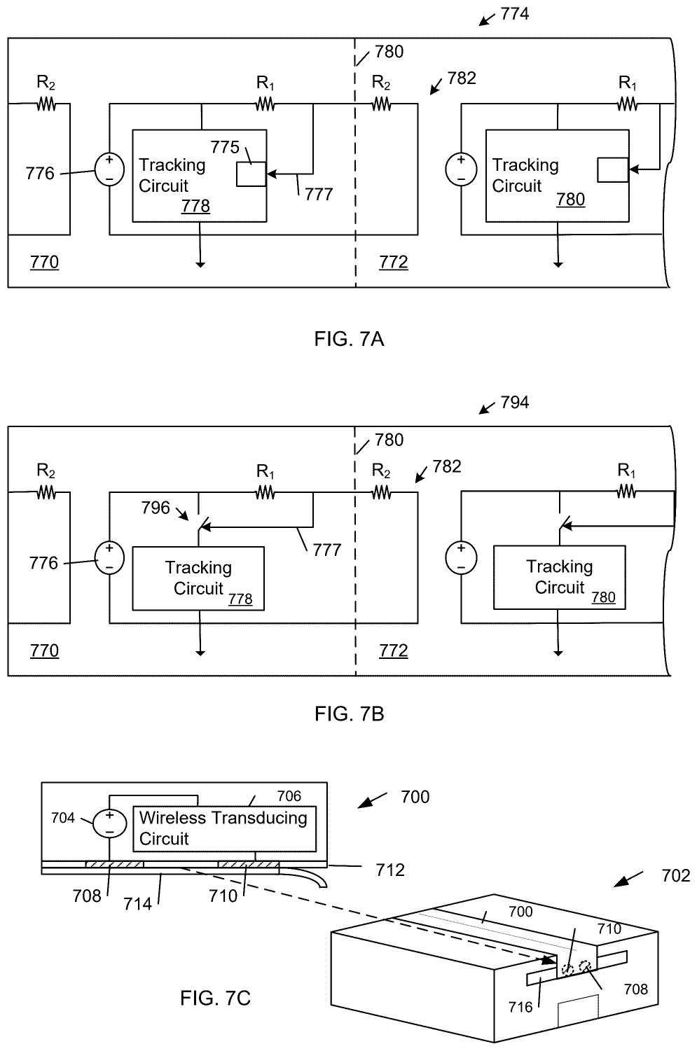

An example method of fabricating the adhesive tape platform 500 according to a roll-to-roll fabrication process is described in connection with FIGS. 6A-6C and as shown in FIGS. 7A and 7B of U.S. patent application Ser. No. 15/842,861, filed Dec. 14, 2017, the entirety of which is incorporated herein by reference.

The instant specification describes an example system of adhesive tape platforms (also referred to herein as “tape nodes”) that can be used to implement a low-cost wireless network infrastructure for performing monitoring, tracking, and other asset management functions relating to, for example, parcels, persons, tools, equipment and other physical assets and objects. The example system includes a set of three different types of tape nodes that have different respective functionalities and different respective cover markings that visually distinguish the different tape node types from one another. In one non-limiting example, the covers of the different tape node types are marked with different colors (e.g., white, green, and black). In the illustrated examples, the different tape node types are distinguishable from one another by their respective wireless communications capabilities and their respective sensing capabilities.

FIG. 6A is a schematic illustrating a cross-sectional side view of a portion of an example segment 640 of a flexible adhesive tape agent platform (e.g., platform 500 of FIG. 5) that includes a respective set of the components of the wireless transducing circuit 410 corresponding to the first tape-agent type (e.g., white). The segment 640 includes an adhesive layer 642, an optional flexible substrate 644, and an optional adhesive layer 646 on the bottom surface of the flexible substrate 644. When the bottom adhesive layer 646 is present, a release liner (not shown) may be (weakly) adhered to the bottom surface of the adhesive layer 646. In certain embodiments where adhesive layer 646 is included, the adhesive layer 646 is an adhesive (e.g., an acrylic foam adhesive) with a high-bond strength that is sufficient to prevent removal of the segment 640 from a surface on which the adhesive layer 646 is adhered to without destroying the physical or mechanical integrity of the segment 640 and/or one or more of its constituent components.

In certain embodiments including the optional flexible substrate 644, the optional flexible substrate 644 is a prefabricated adhesive tape that includes the adhesive layers 642 and 646 and the optional release liner. In other embodiments including the optional flexible substrate 644, the adhesive layers 642, 646 are applied to the top and bottom surfaces of the flexible substrate 644 during the fabrication of the adhesive tape platform. The adhesive layer 642 may bond the flexible substrate 644 to a bottom surface of a flexible circuit 648, that includes one or more wiring layers (not shown) that connect the processor 650, a low-power wireless-communication interface 652 (e.g., a Zigbee, Bluetooth® Low Energy (BLE) interface, or other low power communication interface), a clock and/or a timer circuit 654, transducing and/or transducer(s) 656 (if present), the memory 658, and other components in a device layer 660 to each other and to the energy storage device 662 and, thereby, enable the transducing, tracking and other functionalities of the segment 640. The low-power wireless-communication interface 652 typically includes one or more of the antennas 415, 418 and one or more of the wireless communication circuits 413, 416 of FIG. 4. The segment 640 may further include a flexible cover 690, an interfacial region 692, and a flexible polymer layer 694.

FIG. 6B shows a cross-sectional side-view of a portion of an example segment 670 of a flexible adhesive tape agent platform (e.g., platform 500 of FIG. 5) that includes a respective set of the components of the wireless transducing circuit 410 corresponding to a second tape-agent type (e.g., green). The segment 670 is similar to the segment 640 shown in FIG. 6A but further includes a medium-power communication-interface 672′ (e.g., a LoRa interface) in addition to the low-power communications-interface 652. The medium-power communication-interface 672′ has a longer communication range than the low-power communication-interface 652′. In certain embodiments, one or more other components of the segment 670 differ from the segment 640 in functionality or capacity (e.g., larger energy source). The segment 670 may include further components, as discussed above and below with reference to FIGS. 6A, and 6C.

FIG. 6C shows a cross-sectional side view of a portion of an example segment 680 of the flexible adhesive tape-agent platform that includes a respective set of the components of the wireless transducing circuit 410 corresponding to the third tape-node type (e.g., black). The segment 680 is similar to the segment 670 of FIG. 6B, but further includes a high-power communications-interface 682″ (e.g., a cellular interface; e.g., GSM/GPRS) in addition to a low-power communications-interface 652″ and may include a medium-power communications-interface 672″. The high-power communications-interface 682″ has a range that provides global coverage to available infrastructure (e.g., the cellular network). In certain embodiments, one or more other components of the segment 680 differ from the segment 670 in functionality or capacity (e.g., larger energy source).

FIGS. 6A-6C show embodiments in which the flexible covers 690, 690′, 690″ of the respective segments 640, 670, and 680 include one or more interfacial regions 692, 692′, 692″ positioned over one or more of the transducers 656, 656′, 656″. In certain embodiments, one or more of the interfacial regions 692, 692′, 692″ have features, properties, compositions, dimensions, and/or characteristics that are designed to improve the operating performance of the platform for specific applications. In certain embodiments, the flexible adhesive tape platform includes multiple interfacial regions 692, 692′, 692″ over respective transducers 656, 656′, 656″, which may be the same or different depending on the target applications. Interfacial regions may represent one or more of an opening, an optically transparent window, and/or a membrane located in the interfacial regions 692, 692′, 692″ of the flexible covers 690, 690′, 690″ that is positioned over the one or more transducers and/or transducers 656, 656′, 656″. Additional details regarding the structure and operation of example interfacial regions 692, 692′, 692″ are described in U.S. Provisional Patent Application No. 62/680,716, filed Jun. 5, 2018, and U.S. Provisional Patent Application No. 62/670,712, filed May 11, 2018.

In certain embodiments, a planarizing polymer 694, 694′, 694″ encapsulates the respective device layers 660, 660′, 660″ and thereby reduces the risk of damage that may result from the intrusion of contaminants and/or liquids (e.g., water) into the device layer 660, 660′, 660″. The flexible polymer layers 694, 694′, 694″ may also planarize the device layers 660, 660′, 660″. This facilitates optional stacking of additional layers on the device layers 660, 660′, 660″ and also distributes forces generated in, on, or across the segments 640, 670, 680 so as to reduce potentially damaging asymmetric stresses that might be caused by the application of bending, torquing, pressing, or other forces that may be applied to the segments 640, 670, 680 during use. In the illustrated example, a flexible cover 690, 690′, 690″ is bonded to the planarizing polymer 694, 694′, 694″ by an adhesive layer (not shown).

The flexible cover 690, 690′, 690″ and the flexible substrate 644, 644′, 644″ may have the same or different compositions depending on the intended application. In some examples, one or both of the flexible cover 690, 690′, 690″ and the flexible substrate 644, 644′, 644″ include flexible film layers and/or paper substrates, where the film layers may have reflective surfaces or reflective surface coatings. Compositions for the flexible film layers may represent one or more of polymer films, such as polyester, polyimide, polyethylene terephthalate (PET), and other plastics. The optional adhesive layer on the bottom surface of the flexible cover 690, 690′, 690″ and the adhesive layers 642, 642′, 642″, 646, 646′, 646″ on the top and bottom surfaces of the flexible substrate 644, 644′, 644″ typically include a pressure-sensitive adhesive (e.g., a silicon-based adhesive). In some examples, the adhesive layers are applied to the flexible cover 690, 690′, 690″ and the flexible substrate 644, 644′, 644″ during manufacture of the adhesive tape-agent platform (e.g., during a roll-to-roll or sheet-to-sheet fabrication process). In other examples, the flexible cover 690, 690′, 690″ may be implemented by a prefabricated single-sided pressure-sensitive adhesive tape and the flexible substrate 644, 644′, 644″ may be implemented by a prefabricated double-sided pressure-sensitive adhesive tape; both kinds of tape may be readily incorporated into a roll-to-roll or sheet-to-sheet fabrication process. In some examples, the flexible substrate 644, 644′, 644″ is composed of a flexible epoxy (e.g., silicone).

In certain embodiments, the energy storage device 662, 662′, 662″ is a flexible battery that includes a printed electrochemical cell, which includes a planar arrangement of an anode and a cathode and battery contact pads. In some examples, the flexible battery may include lithium-ion cells or nickel-cadmium electro-chemical cells. The flexible battery typically is formed by a process that includes printing or laminating the electro-chemical cells on a flexible substrate (e.g., a polymer film layer). In some examples, other components may be integrated on the same substrate as the flexible battery. For example, the low-power wireless-communication interface 652, 652′, 652″ and/or the processor(s) 650, 650′, 650″ may be integrated on the flexible battery substrate. In some examples, one or more of such components also (e.g., the flexible antennas and the flexible interconnect circuits) may be printed on the flexible battery substrate.

In examples of manufacture, the flexible circuit 648, 648′, 648″ is formed on a flexible substrate by one or more of printing, etching, or laminating circuit patterns on the flexible substrate. In certain embodiments, the flexible circuit 648, 648′, 648″ is implemented by one or more of a single-sided flex circuit, a double access or back-bared flex circuit, a sculpted flex circuit, a double-sided flex circuit, a multi-layer flex circuit, a rigid flex circuit, and a polymer-thick film flex circuit. A single-sided flexible circuit has a single conductor layer made of, for example, a metal or conductive (e.g., metal filled) polymer on a flexible dielectric film. A double access or back bared flexible circuit has a single conductor layer but is processed so as to allow access to selected features of the conductor pattern from both sides. A sculpted flex circuit is formed using a multi-step etching process that produces a flex circuit that has finished copper conductors that vary in thickness along their respective lengths. A multilayer flex circuit has three of more layers of conductors, where the layers typically are interconnected using plated through holes. Rigid flex circuits are a hybrid construction of flex circuit consisting of rigid and flexible substrates that are laminated together into a single structure, where the layers typically are electrically interconnected via plated through holes. In polymer thick film (PTF) flex circuits, the circuit conductors are printed onto a polymer base film, where there may be a single conductor layer or multiple conductor layers that are insulated from one another by respective printed insulating layers.

In the example segments 640, 670, 680 shown in FIGS. 6A-6C, the flexible circuit 648, 648′, 648″ represents a single-access flex-circuit that interconnects the components of the adhesive tape platform on a single side of the flexible circuit 648, 648′, 648″. However, in other embodiments, the flexible circuit 648, 648′, 648″ represents a double access flex circuit that includes a front-side conductive pattern that interconnects the low-power communications interface 652, 652′, 652″, the timer circuit 654, 654′, 654″, the processor 650, 650′, 650″, the one or more sensor transducers 656, 656′, 656″ (if present), and the memory 658, 658′, 658″, and allows through-hole access (not shown) to a back-side conductive pattern that is connected to the flexible battery (not shown). In these embodiments, the front-side conductive pattern of the flexible circuit 648, 648′, 648″ connects the communications circuits 652, 652′, 652″, 672′, 672″, 682″ (e.g., receivers, transmitters, and transceivers) to their respective antennas and to the processor 650, 650′, 650″ and also connects the processor 650, 650′, 650″ to the one or more sensors and the memory 658, 658′, and 658″. The backside conductive pattern connects the active electronics (e.g., the processor 650, 650′, 650″, the communications circuits 652, 652′, 652″, 672′, 672″, 682″ and the transducers) on the front-side of the flexible circuit 648, 648′, 648″ to the electrodes of the energy storage device 662, 662′, 662″ via one or more through holes in the substrate of the flexible circuit 648, 648′, 648″.

The various units of the segments 640, 670, 680 shown in FIGS. 6A-6C may be arranged to accommodate different objects or structures (e.g., trash bins, fire extinguishers, etc.) and sensors may be added to, or subtracted from, the segments 640, 670, and 680, according to a particular task.

Depending on the target application, the wireless transducing circuit 410 is distributed across the flexible adhesive tape platform 500 according to a specified sampling density, which is the number of wireless transducing circuits 410 for a given unit size (e.g., length or area) of the flexible adhesive tape platform 500. In some examples, a set of multiple flexible adhesive tape platforms 500 are provided that include different respective sampling densities in order to seal different asset sizes with a desired number of wireless transducing circuits 410. In particular, the number of wireless transducing circuits per asset size is given by the product of the sampling density specified for the adhesive tape platform and the respective size of the adhesive tape platform 500 needed to seal the asset. This allows an automated packaging system to select the appropriate type of flexible adhesive tape platform 500 to use for sealing a given asset with the desired redundancy (if any) in the number of wireless transducer circuits 410. In some example applications (e.g., shipping low value goods), only one wireless transducing circuit 410 is used per asset, whereas in other applications (e.g., shipping high value goods) multiple wireless transducing circuits 410 are used per asset. Thus, a flexible adhesive tape platform 500 with a lower sampling density of wireless transducing circuits 410 can be used for the former application, and a flexible adhesive tape platform 500 with a higher sampling density of wireless transducing circuits 410 can be used for the latter application. In some examples, the flexible adhesive tape platforms 500 are color-coded or otherwise marked to indicate the respective sampling densities with which the wireless transducing circuits 410 are distributed across the different types of adhesive tape platforms 500.

Referring to FIG. 7A, in some examples, each of one or more of the segments 770, 772 of a tracking adhesive product 774 includes a respective circuit 775 that delivers power from the respective energy source 776 to the respective tracking circuit 778 (e.g., a processor and one or more wireless communications circuits) in response to an event. In some of these examples, the wake circuit 775 is configured to transition from an off-state to an on-state when the voltage on the wake node 777 exceeds a threshold level, at which point the wake circuit transitions to an on-state to power-on the segment 770. In the illustrated example, this occurs when the user separates the segment from the tracking adhesive product 774, for example, by cutting across the tracking adhesive product 774 at a designated location (e.g., along a designated cut-line 780). In particular, in its initial, un-cut state, a minimal amount of current flows through the resistors R1 and R2. As a result, the voltage on the wake node 777 remains below the threshold turn-on level. After the user cuts across the tracking adhesive product 774 along the designated cut-line 780, the user creates an open circuit in the loop 782, which pulls the voltage of the wake node above the threshold level and turns on the wake circuit 775. As a result, the voltage across the energy source 776 will appear across the tracking circuit 778 and, thereby, turn on the segment 770. In particular embodiments, the resistance value of resistor R1 is greater than the resistance value of R2. In some examples, the resistance values of resistors R1 and R2 are selected based on the overall design of the adhesive product system (e.g., the target wake voltage level and a target leakage current).

In some examples, each of one or more of the segments of a tracking adhesive product includes a respective sensor and a respective wake circuit that delivers power from the respective energy source to the respective one or more components of the respective tracking circuit 778 in response to an output of the sensor. In some examples, the respective sensor is a strain sensor that produces a wake signal based on a change in strain in the respective segment. In some of these examples, the strain sensor is affixed to a tracking adhesive product and configured to detect the stretching of the tracking adhesive product segment as the segment is being peeled off a roll or a sheet of the tracking adhesive product. In some examples, the respective sensor is a capacitive sensor that produces a wake signal based on a change in capacitance in the respective segment. In some of these examples, the capacitive sensor is affixed to a tracking adhesive product and configured to detect the separation of the tracking adhesive product segment from a roll or a sheet of the tracking adhesive product. In some examples, the respective sensor is a flex sensor that produces a wake signal based on a change in curvature in the respective segment. In some of these examples, the flex sensor is affixed to a tracking adhesive product and configured to detect bending of the tracking adhesive product segment as the segment is being peeled off a roll or a sheet of the tracking adhesive product. In some examples, the respective sensor is a near field communications sensor that produces a wake signal based on a change in inductance in the respective segment.

FIG. 7B shows another example of a tracking adhesive product 794 that delivers power from the respective energy source 776 to the respective tracking circuit 778 (e.g., a processor and one or more wireless communications circuits) in response to an event. This example is similar in structure and operation as the tracking adhesive product 794 shown in FIG. 7A, except that the wake circuit 775 is replaced by a switch 796 that is configured to transition from an open state to a closed state when the voltage on the switch node 777 exceeds a threshold level. In the initial state of the tracking adhesive product 794, the voltage on the switch node is below the threshold level as a result of the low current level flowing through the resistors R1 and R2. After the user cuts across the tracking adhesive product 794 along the designated cut-line 780, the user creates an open circuit in the loop 782, which pulls up the voltage on the switch node above the threshold level to close the switch 796 and turn on the tracking circuit 778.

A wireless sensing system includes a plurality of wireless nodes configured to detect tampering in assets. Tampering may include, but is not limited to, opening assets such as boxes, containers, storage, or doors, moving the asset without authorization, moving the asset to an unintended location, moving the asset in an unintended way, damaging the asset, shaking the asset in an unintended way, orienting an asset in a way that it is not meant to be oriented. In many cases, these actions may compromise the integrity or safety of assets. Wireless nodes associated with the asset are configured to detect a tampering event. In an embodiment, a tampering event is associated with an action, a time, and a location. In an embodiment, the wireless nodes communicate the tampering event to the wireless sensing system. The wireless sensing system is configured to provide a notification or alert to a user of the wireless sensing system. In some embodiments, a wireless node may directly transmit the notification or alert to the user. In other embodiments, a wireless node may include a display that indicates whether or not a tampering event has occurred (e.g., the display may be an indicator light or LED).

Alerts may be transmitted to server/cloud, other wireless nodes, a client device, or some combination thereof. For example, in an embodiment, a wireless node of the wireless sensing system captures sensor data, detects a tampering event, and transmits an alarm to a user of the wireless sensing system (e.g., without communicating with a server or cloud of the wireless sensing system). In another embodiment, a wireless node of the wireless sensing system captures sensor data and transmits the sensor data to a gateway, parent node (e.g., black tape), or client device. The gateway, parent node, or client device detects a tampering event based on the received sensor data and transmits an alarm to a user of the wireless sensing system. In another embodiment, the wireless node of the wireless sensing system captures sensor data, detects a tampering event, and transmits information describing the tampering event to a server or cloud of the wireless sensing system. The server or cloud of the wireless sensing system transmits an alarm to a user of the wireless sensing system.

FIG. 7C shows a diagrammatic cross-sectional front view of an example adhesive tape platform 700 and a perspective view of an example asset 702. Instead of activating the adhesive tape platform in response to separating a segment of the adhesive tape platform from a roll or a sheet of the adhesive tape platform, this example is configured to supply power from the energy source 704 to turn on the wireless transducing circuit 706 in response to establishing an electrical connection between two power terminals 708, 710 that are integrated into the adhesive tape platform. In particular, each segment of the adhesive tape platform 700 includes a respective set of embedded tracking components, an adhesive layer 712, and an optional backing sheet 714 with a release coating that prevents the segments from adhering strongly to the backing sheet 714. In some examples, the power terminals 708, 710 are composed of an electrically conductive material (e.g., a metal, such as copper) that may be printed or otherwise patterned and/or deposited on the backside of the adhesive tape platform 700. In operation, the adhesive tape platform can be activated by removing the backing sheet 714 and applying the exposed adhesive layer 712 to a surface that includes an electrically conductive region 716. In the illustrated embodiment, the electrically conductive region 716 is disposed on a portion of the asset 702. When the adhesive backside of the adhesive tape platform 700 is adhered to the asset with the exposed terminals 708, 710 aligned and in contact with the electrically conductive region 716 on the asset 702, an electrical connection is created through the electrically conductive region 716 between the exposed terminals 708, 710 that completes the circuit and turns on the wireless transducing circuit 706. In particular embodiments, the power terminals 708, 710 are electrically connected to any respective nodes of the wireless transducing circuit 706 that would result in the activation of the tracking circuit 706 in response to the creation of an electrical connection between the power terminals 708, 710.

In some examples, after a tape node is turned on, it will communicate with the network service to confirm that the user/operator who is associated with the tape node is an authorized user who has authenticated himself or herself to the network service. In these examples, if the tape node cannot confirm that the user/operator is an authorized user, the tape node will turn itself off.

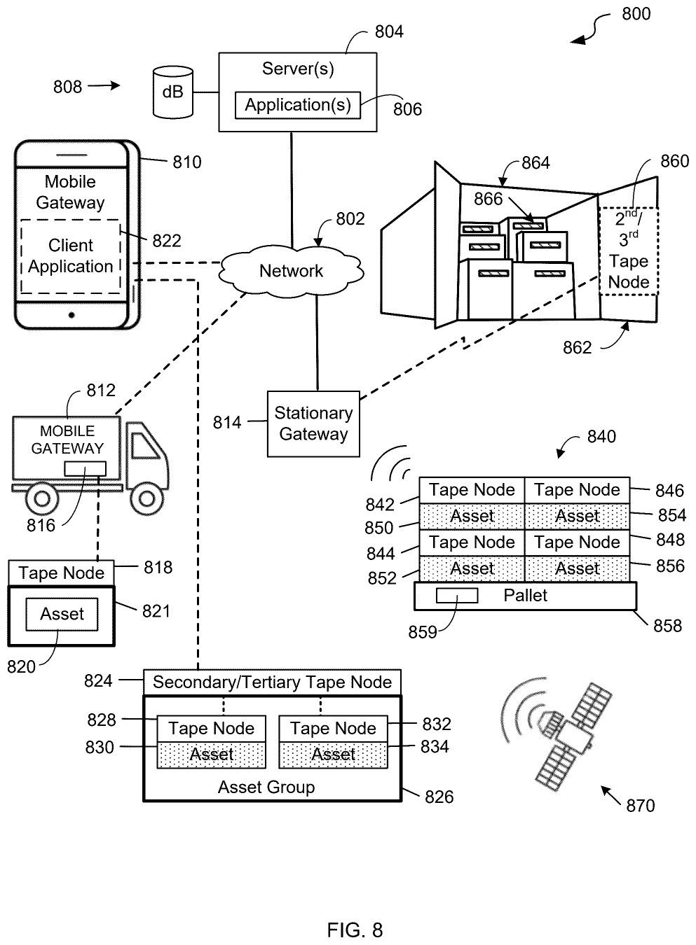

FIG. 8 shows an example network communications environment 800 that includes a network 802 that supports communications between one or more servers 804 executing one or more applications of a network service 808, mobile gateways 810 (a smart device mobile gateway), 812 (a vehicle mobile gateway), a stationary gateway 814, and various types of tape nodes that are associated with various assets (e.g., parcels, equipment, tools, persons, and other things). Hereinafter “tape nodes” may be used interchangeably with the “agents”, as described above, with reference to FIGS. 1-7; the “agents” are in the form of a “tape node” attached to different objects, e.g., an asset, storage container, vehicle, equipment, etc.; the master agent may be referred to as a master tape node, a secondary agent may be referred to as a secondary tape node; and a tertiary agent may be referred to as a tertiary tape node.

In some examples, the network 802 (e.g., a wireless network) includes one or more network communication systems and technologies, including any one or more of wide area networks, local area networks, public networks (e.g., the internet), private networks (e.g., intranets and extranets), wired networks, and wireless networks. For example, the network 802 includes communications infrastructure equipment, such as a geolocation satellite system 870 (e.g., GPS, GLONASS, and NAVSTAR), cellular communication systems (e.g., GSM/GPRS), Wi-Fi communication systems, RF communication systems (e.g., LoRa), Bluetooth communication systems (e.g., a Bluetooth Low Energy system), Z-wave communication systems, and ZigBee communication systems.

In some examples, the one or more network service applications leverage the above-mentioned communications technologies to create a hierarchical wireless network of tape nodes improves asset management operations by reducing costs and improving efficiency in a wide range of processes, from asset packaging, asset transporting, asset tracking, asset condition monitoring, asset inventorying, and asset security verification. Communication across the network is secured by a variety of different security mechanisms. In the case of existing infrastructure, a communication link uses the infrastructure security mechanisms. In the case of communications among tapes nodes, the communication is secured through a custom security mechanism. In certain cases, tape nodes may also be configured to support block chain to protect the transmitted and stored data.

A network of tape nodes may be configured by the network service to create hierarchical communications network. The hierarchy may be defined in terms of one or more factors, including functionality (e.g., wireless transmission range or power), role (e.g., master-tape node vs. peripheral-tape node), or cost (e.g., a tape node equipped with a cellular transceiver vs. a peripheral tape node equipped with a Bluetooth LE transceiver). As described above with reference to the agents, tape nodes may be assigned to different levels of a hierarchical network according to one or more of the above-mentioned factors. For example, the hierarchy may be defined in terms of communication range or power, where tape nodes with higher-power or longer-communication range transceivers are arranged at a higher level of the hierarchy than tape nodes with lower-power or lower-range power or lower range transceivers. In another example, the hierarchy is defined in terms of role, where, e.g., a master tape node is programmed to bridge communications between a designated group of peripheral tape nodes and a gateway node or server node. The problem of finding an optimal hierarchical structure may be formulated as an optimization problem with battery capacity of nodes, power consumption in various modes of operation, desired latency, external environment, etc. and may be solved using modern optimization methods e.g. neural networks, artificial intelligence, and other machine learning computing systems that take expected and historical data to create an optimal solution and may create algorithms for modifying the system's behavior adaptively in the field.

The tape nodes may be deployed by automated equipment or manually. In this process, a tape node typically is separated from a roll or sheet and adhered to a parcel (e.g., asset 820) or other stationary (e.g., stationary gateway 814) or mobile object (e.g., a, such as a delivery truck, such as mobile gateway 812) or stationary object (e.g., a structural element of a building). This process activates the tape node (e.g., the tape node 818) and causes the tape node 818 to communicate with the one or more servers 804 of the network service 808. In this process, the tape node 418 may communicate through one or more other tape nodes (e.g., the tape nodes 842, 844, 846, 848) in the communication hierarchy. In this process, the one or more servers 804 executes the network service application 806 to programmatically configure tape nodes 818, 824, 828, 832, 842, 844, 846, 848, that are deployed in the network communications environment 800. In some examples, there are multiple classes or types of tape nodes (e.g., a master agent, a secondary agent, or tertiary agent), where each tape node class has a different respective set of functionalities and/or capacities, as described herein with respect to the “agents” in FIGS. 1-7. For example, the master agents have a lower-power wireless-communication interface (e.g., the low-power wireless-communication interface 652, with reference to FIG. 6), in comparison to the secondary and tertiary agents.

In some examples, the one or more servers 804 communicate over the network 802 with one or more gateways 810, 812, 814 that are configured to send, transmit, forward, or relay messages to the network 802 in response to transmissions from the tape nodes 818, 824, 828, 832, 842, 844, 846, 848 that are associated with respective assets and within communication range. Example gateways include mobile gateways 810, 812 and a stationary gateway 814. In some examples, the mobile gateways 810, 812, and the stationary gateway 814 are able to communicate with the network 802 and with designated sets or groups of tape nodes.

In some examples, the mobile gateway 812 is a vehicle (e.g., a delivery truck or other mobile hub) that includes a wireless communications unit 816 that is configured by the network service 808 to communicate with a designated network of tape nodes, including tape node 818 (e.g., a master tape node) in the form of a label that is adhered to a parcel 821 (e.g., an envelope) that contains an asset 820, and is further configured to communicate with the network service 808 over the network 802. In some examples, the tape node 818 includes a lower-power wireless-communications interface of the type used in, e.g., segment 640 (shown in FIG. 6A), and the wireless communications unit 816 may be implemented by a secondary or tertiary tape node (e.g., one of segment 670 or segment 680, respectively shown in FIGS. 6B and 6C) that includes a lower-power communications interfaces for communicating with tape nodes within range of the mobile gateway 812 and a higher-power communications-interface for communicating with the network 802. In this way, the tape node 818 and wireless communications unit 816 create a hierarchical wireless network of tape nodes for transmitting, forwarding, bridging, relaying, or otherwise communicating wireless messages to, between, or on behalf of the tape node 818 in a power-efficient and cost-effective way.

In some examples, a mobile gateway 810 is a mobile phone that is operated by a human operator and executes a client application 822 that is configured by a network service to communicate with a designated set of tape nodes, including a secondary or tertiary tape node 824 that is adhered to a parcel 826 (e.g., a box), and is further configured to communicate with a server 804 over the network 802. In the illustrated example, the parcel 826 contains a first parcel labeled or sealed by a master tape node 828 and containing a first asset 830, and a second parcel labeled or sealed by a master tape node 832 and containing a second asset 834. The secondary or tertiary tape node 824 communicates with each of the master tape nodes 828, 832 and also communicates with the mobile gateway 810. In some examples, each of the master tape nodes 828, 832 includes a lower-power wireless-communications interface of the type used in, e.g., segment 640 (shown in FIG. 6A), and the secondary/tertiary tape node 824 is implemented by a tape node (e.g., segment 670 or segment 680, shown in FIGS. 6B and 6C) that includes a low-power communications interface for communicating with the master tape nodes 828, 832 contained within the parcel 826, and a higher-power communications interface for communicating with the mobile gateway 810. The secondary or tertiary tape node 824 is operable to relay wireless communications between the master tape nodes 828, 832 contained within the parcel 826 and the mobile gateway 810, and the mobile gateway 810 is operable to relay wireless communications between the secondary or tertiary tape node 824 and the server 804 over the network 802. In this way, the master tape nodes 828 and 832 and the secondary or tertiary tape node 824 create a wireless network of nodes for transmitting, forwarding, relaying, or otherwise communicating wireless messages to, between, or on behalf of the master tape nodes 828, 832, the secondary or tertiary tape node 824, and the network service (not shown) in a power-efficient and cost-effective way.

In some embodiments, the client application 822 is installed on a mobile device (e.g., smartphone) that may also operate as mobile gateway 810. The client application 822 may cause the mobile device to function as a mobile gateway 810. For example, the client application 822 runs in the background to allow the mobile device to bridge communications between tape nodes that are communicating on one protocol to other tape nodes that are communicating on another protocol. For example, a tape node transmits data to the mobile device through Bluetooth, and the mobile device (running the client application 822) relays that data to the server 804 via cellular (2G, 3G, 4G, 5G) or Wi-Fi. Further, the client application 822 may cause the mobile device to establish a connection with, and receive pings (e.g., alerts to nearby assets that an environmental profile threshold has been exceeded), from the tape nodes or from the server 804. The tape nodes or server may request services (e.g., to display alert messages within a graphical user interface of the mobile device, relay messages to nearby tape nodes or mobile or stationary gateways, delegate tasks to the mobile device, such as determining the location of the tape node, etc.) from the mobile device. For example, the mobile device running the client application 822 may share location data with the tape node, allowing the tape node to pinpoint its location.

In some examples, the stationary gateway 814 is implemented by a server 804 executing a network service application 806 that is configured by the network service 808 to communicate with a designated set 840 of master tape nodes 842, 844, 846, 848 that are adhered to respective parcels containing respective assets 850, 852, 854, 856 on a pallet 858. In other examples, the stationary gateway 814 is implemented by a secondary or tertiary tape node 860 (e.g., segments 670 or 680, respectively shown in FIGS. 6B and 6C) that is adhered to, for example, a wall, column or other infrastructure component of the physical premise's environment 800, and includes a low-power communications interface for communicating with nodes within range of the stationary gateway 814 and a higher-power communications interface for communicating with the network 802.

In one embodiment, each of the master tape nodes 842-848 is a master tape node and is configured by the network service 808 to communicate individually with the stationary gateway 814, which relays communications from the master tape nodes 842-848 to the network service 808 through the stationary gateway 814 and over the network 802. In another embodiment, one of the master tape nodes 842-848 at a time is configured to transmit, forward, relay, or otherwise communicate wireless messages to, between, or on behalf of the other master nodes on the pallet 858. In this embodiment, the master tape node may be determined by the master tape nodes 842-848 or designated by the network service 808. In some examples, the master tape nodes 842-848 with the longest range or highest remaining power level is determined to be the master tape node. In some examples, when the power level of the current master tape node drops below a certain level (e.g., a fixed power threshold level or a threshold level relative to the power levels of one or more of the other master tape nodes), another one of the master tape nodes assumes the role of the master tape node. In some examples, a master tape node 859 is adhered to the pallet 858 and is configured to perform the role of a master node for the other master tape nodes 842-848. In these ways, the master tape nodes 842-848, 859 are configurable to create different wireless networks of nodes for transmitting, forwarding, relaying, bridging, or otherwise communicating wireless messages with the network service 408 through the stationary gateway 814 and over the network 802 in a power-efficient and cost-effective way.

In the illustrated example, the stationary gateway 814 also is configured by the network service 808 to communicate with a designated network of tape nodes, including the secondary or tertiary tape node 860 that is adhered to the inside of a door 862 of a shipping container 864, and is further configured to communicate with the network service 808 over the network 802. In the illustrated example, the shipping container 864 contains a number of parcels labeled or sealed by respective master tape nodes 866 and containing respective assets. The secondary or tertiary tape node 860 communicates with each of the master tape nodes 866 within the shipping container 864 and communicates with the stationary gateway 814. In some examples, each of the master tape nodes 866 includes a low-power wireless communications-interface (e.g., the low-power wireless-communication interface 652, 652′, 652″, with reference to FIGS. 6A-6C), and the secondary or tertiary tape node 860 includes a low-power wireless-communications interface (low-power wireless-communication interfaces 652′, 652″, with reference to FIGS. 6B-6C) for communicating with the master tape nodes 866 contained within the shipping container 864, and a higher-power wireless-communications interface (e.g., medium-power wireless-communication interface 672′, medium-power wireless-communication interface 672″, high-power wireless-communication interface 682″, with reference to FIGS. 6B-6C) for communicating with the stationary gateway 814. In some examples, either a secondary or tertiary tape node, or both, may be used, depending on whether a high-power wireless-communication interface is necessary for sufficient communication.

In some examples, when the doors of the shipping container 864 are closed, the secondary or tertiary tape node 860 is operable to communicate wirelessly with the master tape nodes 866 contained within the shipping container 864. In some embodiments, both a secondary and a tertiary node are attached to the shipping container 864. Whether a secondary and a tertiary node are used may depend on the range requirements of the wireless-communications interface. For example, if out at sea a node will be required to transmit and receive signals from a server located outside the range of a medium-power wireless-communications interface, a tertiary node will be used because the tertiary node includes a high-power wireless-communications interface.

In an example, the secondary or tertiary tape node 860 is configured to collect sensor data from master tape nodes 866 and, in some embodiments, process the collected data to generate, for example, statistics from the collected data. When the doors of the shipping container 864 are open, the secondary or tertiary tape node 860 is programmed to detect the door opening (e.g., using a photodetector or an accelerometer component of the secondary or tertiary tape node 860) and, in addition to reporting the door opening event to the network service 808, the secondary or tertiary tape node 860 is further programmed to transmit the collected data and/or the processed data in one or more wireless messages to the stationary gateway 814. The stationary gateway 814, in turn, is operable to transmit the wireless messages received from the secondary or tertiary tape node 860 to the network service 808 over the network 802. Alternatively, in some examples, the stationary gateway 814 also is operable to perform operations on the data received from the secondary or tertiary tape node 860 with the same type of data produced by the secondary or tertiary tape node 860 based on sensor data collected from the master tape nodes 842-848. In this way, the secondary or tertiary tape node 860 and master tape node 866 create a wireless network of nodes for transmitting, forwarding, relaying, or otherwise communicating wireless messages to, between, or on behalf of the master tape node 866, the secondary or tertiary tape nodes 860, and the network service 808 in a power-efficient and cost-effective way.

In an example of the embodiment shown in FIG. 8, there are three types of backward compatible tape nodes: a short-range master tape node (e.g., segment 640), a medium-range secondary tape node (e.g., segment 670), and a long-range tertiary tape node (e.g. segment 680), as respectively shown in FIGS. 6A-6C (here, “tape node” is used interchangeably with “agent”, as described with reference to FIGS. 1-7). The short-range master tape nodes typically are adhered directly to parcels containing assets. In the illustrated example, the master tape nodes 818, 828, 832, 842-848, 866 are short-range tape nodes. The short-range tape nodes typically communicate with a low-power wireless-communication protocol (e.g., Bluetooth LE, Zigbee, or Z-wave). The segments 670 are typically adhered to objects (e.g., a parcel 826 and a shipping container 864) that are associated with multiple parcels that are separated from the medium-range tape nodes by a barrier or a long distance. In the illustrated example, the secondary and/or tertiary tape nodes 824 and 860 are medium-range tape nodes. The medium-range tape nodes typically communicate with low and medium-power wireless-communication protocols (e.g., Bluetooth, LoRa, or Wi-Fi). The segments 680 typically are adhered to mobile or stationary infrastructure of the network communications environment 800.

In the illustrated example, the mobile gateway 812 and the stationary gateway 814 are implemented by, e.g., segment 680. The segments 680 typically communicate with other nodes using a high-power wireless-communication protocol (e.g., a cellular data communication protocol). In some examples, the wireless communications unit 416 (a secondary or tertiary tape node) is adhered to a mobile gateway 812 (e.g., a truck). In these examples, the wireless communications unit 816 may be moved to different locations in the network communications environment 800 to assist in connecting other tape nodes to the wireless communications unit 816. In some examples, the stationary gateway 814 is a tape node that may be attached to a stationary structure (e.g., a wall) in the network communications environment 800 with a known geographic location (e.g., GPS coordinates). In these examples, other tape nodes in the environment may determine their geographic location by querying the stationary gateway 814.

In some examples, in order to conserve power, the tape nodes typically communicate according to a schedule promulgated by the network service 808. The schedule usually dictates all aspects of the communication, including the times when particular tape nodes should communicate, the mode of communication, and the contents of the communication. In one example, the server (not shown) transmits programmatic Global Scheduling Description Language (GSDL) code to the master tape node and each of the secondary and tertiary tape nodes in the designated set. In this example, execution of the GSDL code causes each of the tape nodes in the designated set to connect to the master tape node at a different respective time that is specified in the GSDL code, and to communicate a respective set of one or more data packets of one or more specified types of information over the respective connection. In some examples, the master tape node simply forwards the data packets to the server 804, either directly or indirectly through a gateway tape node (e.g., the long-range tape node, such as wireless communication unit 816, adhered to the mobile gateway 812, or a long-range tape node, such as stationary gateway 814, that is adhered to an infrastructure component of the network communications environment 800). In other examples, the master tape node processes the information contained in the received data packets and transmits the processed information to the server 804.

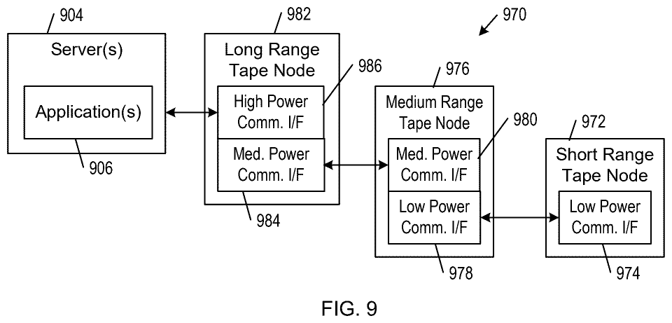

FIG. 9 is a schematic illustrating one example hierarchical wireless communications network of tape nodes 970. In this example, the short-range tape node 972 and the medium range tape node 976 communicate with one another over their respective low power wireless-communication interfaces 974, 978. The medium range tape node 976 and the long-range tape node 982 communicate with one another over their respective medium power wireless-communication interfaces 980, 984. The long-range tape node 982 and the one or more network service servers 904 (e.g., server(s) 804, FIG. 8) running application(s) 906 (e.g., application(s) 806) communicate with one another over the high-power communication interface 986. In some examples, the low power communication interfaces 974, 978 establish wireless communications with one another in accordance with the Bluetooth LE protocol, the medium power communication interfaces 980, 984 establish wireless communications with one another in accordance with the LoRa communications protocol, and the high-power communication interface 986 establishes wireless communications with the one or more network service servers 904 in accordance with a cellular communications protocol.

In some examples, the different types of tape nodes are deployed at different levels in the communications hierarchy according to their respective communications ranges, with the long-range tape nodes generally at the top of the hierarchy, the medium range tape nodes generally in the middle of the hierarchy, and the short-range tape nodes generally at the bottom of the hierarchy. In some examples, the different types of tape nodes are implemented with different feature sets that are associated with component costs and operational costs that vary according to their respective levels in the hierarchy. This allows system administrators flexibility to optimize the deployment of the tape nodes to achieve various objectives, including cost minimization, asset tracking, asset localization, and power conservation.

In some examples, one or more network service servers 904 designates a tape node at a higher level in a hierarchical communications network as a master node of a designated set of tape nodes at a lower level in the hierarchical communications network. For example, the designated master tape node may be adhered to a parcel (e.g., a box, pallet, or shipping container) that contains one or more tape nodes that are adhered to one or more packages containing respective assets. In order to conserve power, the tape nodes typically communicate according to a schedule promulgated by the one or more network service servers 904. The schedule usually dictates all aspects of the communication, including the times when particular tape nodes should communicate, the mode of communication, and the contents of the communication. In one example, the one or more network service servers 904 transmits programmatic Global Scheduling Description Language (GSDL) code to the master tape node and each of the lower-level tape nodes in the designated set. In this example, execution of the GSDL code causes each of the tape nodes in the designated set to connect to the master tape node at a different respective time that is specified in the GSDL code, and to communicate a respective set of one or more data packets of one or more specified types of information over the respective connection. In some examples, the master tape node simply forwards the data packets to the one or more network service servers 904, either directly or indirectly through a gateway tape node (e.g., the long-range wireless communication unit 816 adhered to the mobile gateway 812 (which could be a vehicle, ship, plane, etc.) or the stationary gateway 814 is a long-range tape node adhered to an infrastructure component of the environment 800). In other examples, the master tape node processes the information contained in the received data packets and transmits the processed information to the one or more network service servers 904/804.

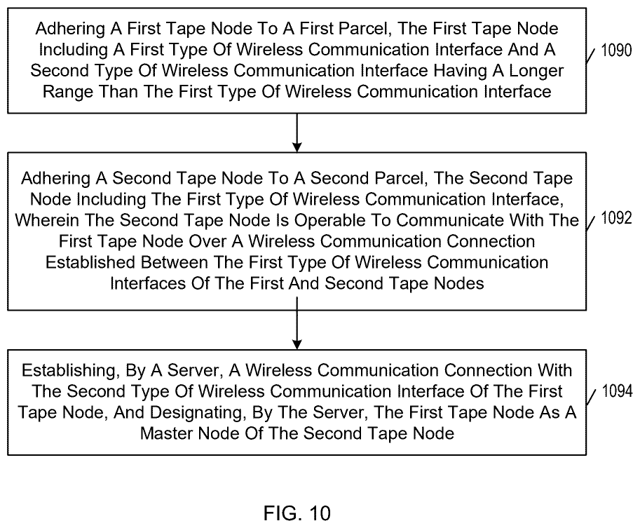

FIG. 10 is a flowchart illustrating one example method of creating a hierarchical communications network. In accordance with this method, a first tape node is adhered to a first parcel in a set of associated parcels, the first tape node including a first type of wireless-communication interface and a second type of wireless-communication interface having a longer range than the first type of wireless-communication interface (FIG. 10, block 1090). A second tape node is adhered to a second parcel in the set, the second tape node including the first type of wireless-communication interface, wherein the second tape node is operable to communicate with the first tape node over a wireless communication connection established between the first type of wireless-communication interfaces of the first and second tape nodes (FIG. 10, block 1092). An application executing on a computer system (e.g., the one or more network service servers 904 of a network service 908) establishes a wireless communication connection with the second type of wireless-communication interface of the first tape node, and the application transmits programmatic code executable by the first tape node to function as a master tape node with respect to the second tape node (FIG. 10, block 1094).

As used herein, the term “node” refers to both a tape node and a non-tape node unless the node is explicitly designated as a “tape node” or a “non-tape node.” In some embodiments, a non-tape node may have the same or similar communication, sensing, processing and other functionalities and capabilities as the tape nodes described herein, except without being integrated into a tape platform. In some embodiments, non-tape nodes can interact seamlessly with tape nodes. Each node is assigned a respective unique identifier.

Embodiments of the present disclosure further describe a distributed software operating system that is implemented by distributed hardware nodes executing intelligent agent software to perform various tasks or algorithms. In some embodiments, the operating system distributes functionalities (e.g., performing analytics on data or statistics collected or generated by nodes) geographically across multiple intelligent agents that are bound to logistic items (e.g., parcels, containers, packages, boxes, pallets, a loading dock, a door, a light switch, a vehicle such as a delivery truck, a shipping facility, a port, a hub, etc.). In addition, the operating system dynamically allocates the hierarchical roles (e.g., master and slave roles) that nodes perform over time in order to improve system performance, such as optimizing battery life across nodes, improving responsiveness, and achieving overall objectives. In some embodiments, optimization is achieved using a simulation environment for optimizing key performance indicators (PKIs).

In some embodiments, the nodes are programmed to operate individually or collectively as autonomous intelligent agents. In some embodiments, nodes are configured to communicate and coordinate actions and respond to events. In some embodiments, a node is characterized by its identity, its mission, and the services that it can provide to other nodes. A node's identity is defined by its capabilities (e.g., battery life, sensing capabilities, and communications interfaces). A node may be defined by the respective program code, instructions, or directives it receives from another node (e.g., a server or a master node) and the actions or tasks that it performs in accordance with that program code, instructions, or directives (e.g., sense temperature every hour and send temperature data to a master node to upload to a server). A node's services may be defined by the functions or tasks that it is permitted to perform for other nodes (e.g., retrieve temperature data from a peripheral node and send the received temperature data to the server). At least for certain tasks, once programmed and configured with their identities, missions, and services, nodes can communicate with one another and request services from and provide services to one another independently of the server.

Thus, in accordance with the runtime operating system every agent knows its objectives (programmed). Every agent knows which capabilities/resources it needs to fulfill objective. Every agent communicates with every other node in proximity to see if it can offer the capability. Examples include communicate data to the server, authorize going to lower-power level, temperature reading, send an alert to local hub, send location data, triangulate location, any boxes in same group that already completed group objectives.

Nodes can be associated with logistic items. Examples of a logistic item includes, for example, a package, a box, pallet, a container, a truck or other conveyance, infrastructure such as a door, a conveyor belt, a light switch, a road, or any other thing that can be tracked, monitored, sensed, etc. or that can transmit data concerning its state or environment. In some examples, a server or a master node may associate the unique node identifiers with the logistic items.

Communication paths between tape and/or non-tape nodes may be represented by a graph of edges between the corresponding logistic items (e.g., a storage unit, truck, or hub). In some embodiments, each node in the graph has a unique identifier. A set of connected edges between nodes is represented by a sequence of the node identifiers that defines a communication path between a set of nodes.

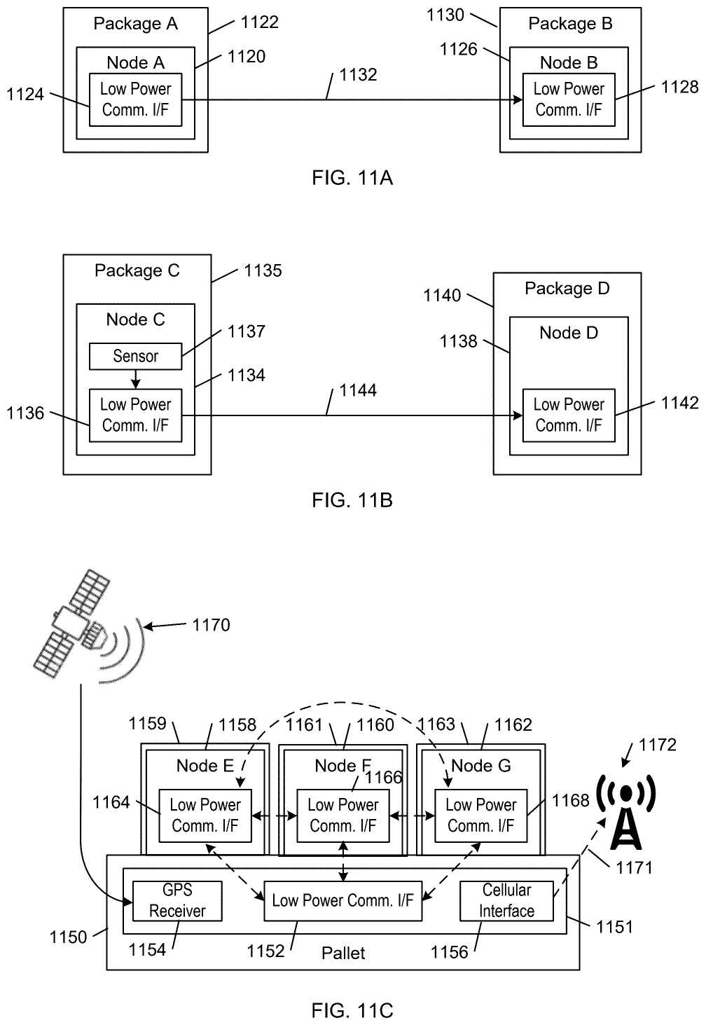

Referring to FIG. 11A, a node 1120 (Node A) is associated with a package 1122 (Package A). In some embodiments, the node 1120 may be implemented as a tape node that is used to seal the package 1122 or it may be implemented as a label node that is used to label the package 1122; alternatively, the node 1120 may be implemented as a non-tape node that is inserted within the package 1122 or embedded in or otherwise attached to the interior or exterior of the package 1122. In the illustrated embodiment, the node 1120 includes a low power communications interface 1124 (e.g., a Bluetooth Low Energy communications interface). Another node 1126 (Node B), which is associated with another package 1130 (Package B), is similarly equipped with a compatible low power communications interface 1128 (e.g., a Bluetooth Low Energy communications interface).

In an example scenario, in accordance with the programmatic code stored in its memory, node 1126 (Node B) requires a connection to node 1120 (Node A) to perform a task that involves checking the battery life of Node A. Initially, Node B is unconnected to any other nodes. In accordance with the programmatic code stored in its memory, Node B periodically broadcasts advertising packets into the surrounding area. When the other node 1120 (Node A) is within range of Node B and is operating in a listening mode, Node A will extract the address of Node B and potentially other information (e.g., security information) from an advertising packet. If, according to its programmatic code, Node A determines that it is authorized to connect to Node B, Node A will attempt to pair with Node B. In this process, Node A and Node B determine each other's identities, capabilities, and services. For example, after successfully establishing a communication path 1132 with Node A (e.g., a Bluetooth Low Energy formatted communication path), Node B determines Node A's identity information (e.g., master node), Node A's capabilities include reporting its current battery life, and Node A's services include transmitting its current battery life to other nodes. In response to a request from Node B, Node A transmits an indication of its current battery life to Node B.

Referring to FIG. 11B, a node 1134 (Node C) is associated with a package 1135 (Package C). In the illustrated embodiment, the Node C includes a low power communications interface 1136 (e.g., a Bluetooth Low Energy communications interface), and a sensor 1137 (e.g., a temperature sensor). Another node 1138 (Node D), which is associated with another package 1140 (Package D), is similarly equipped with a compatible low power communications interface 1142 (e.g., a Bluetooth Low-Energy communications interface).

In an example scenario, in accordance with the programmatic code stored in its memory, Node D requires a connection to Node C to perform a task that involves checking the temperature in the vicinity of Node C. Initially, Node D is unconnected to any other nodes. In accordance with the programmatic code stored in its memory, Node D periodically broadcasts advertising packets in the surrounding area. When Node C is within range of Node D and is operating in a listening mode, Node C will extract the address of Node D and potentially other information (e.g., security information) from the advertising packet. If, according to its programmatic code, Node C determines that it is authorized to connect to Node D, Node C will attempt to pair with Node D. In this process, Node C and Node D determine each other's identities, capabilities, and services. For example, after successfully establishing a communication path 1144 with Node C (e.g., a Bluetooth Low Energy formatted communication path), Node D determines Node C's identity information (e.g., a peripheral node), Node C's capabilities include retrieving temperature data, and Node C's services include transmitting temperature data to other nodes. In response to a request from Node D, Node C transmits its measured and/or locally processed temperature data to Node D.

Referring to FIG. 11C, a pallet 1150 is associated with a master node 1151 that includes a low-power communications interface 1152, a GPS receiver 1154, and a cellular communications interface 1156. In some embodiments, the master node 1151 may be implemented as a tape node or a label node that is adhered to the pallet 1150. In other embodiments, the master node 1151 may be implemented as a non-tape node that is inserted within the body of the pallet 1150 or embedded in or otherwise attached to the interior or exterior of the pallet 1150.

The pallet 1150 provides a structure for grouping and containing packages 1159, 1161, 1163 each of which is associated with a respective peripheral node 1158, 1160, 1162 (Node E, Node F, and Node G). Each of the peripheral nodes 1158, 1160, 1162 includes a respective low power communications interface 1164, 1166, 1168 (e.g., Bluetooth Low Energy communications interface). In the illustrated embodiment, each of the nodes E, F, G, and the master node 1151 are connected to each of the other nodes over a respective low power communications path (shown by dashed lines).

In some embodiments, the packages 1159, 1161, 1163 are grouped together because they are related. For example, the packages 1159, 1161, 1163 may share the same shipping itinerary or a portion thereof. In an example scenario, the master pallet node 1151 scans for advertising packets that are broadcasted from the peripheral nodes 1158, 1160, 1162. In some examples, the peripheral nodes broadcast advertising packets during respective scheduled broadcast intervals. The master node 1151 can determine the presence of the packages 1159, 1161, 1163 in the vicinity of the pallet 1150 based on receipt of one or more advertising packets from each of the nodes E, F, and G. In some embodiments, in response to receipt of advertising packets broadcasted by the peripheral nodes 1158, 1160, 1162, the master node 1151 transmits respective requests to the server to associate the master node 1151 and the respective peripheral nodes 1158, 1160, 1162. In some examples, the master tape node requests authorization from the server to associate the master tape node and the peripheral tape nodes. If the corresponding packages 1159, 1161, 1163 are intended to be grouped together (e.g., they share the same itinerary or certain segments of the same itinerary), the server authorizes the master node 1151 to associate the peripheral nodes 1158, 1160, 1162 with one another as a grouped set of packages. In some embodiments, the server registers the master node and peripheral tape node identifiers with a group identifier. The server also may associate each node ID with a respective physical label ID that is affixed to the respective package.

In some embodiments, after an initial set of packages is assigned to a multi package group, the master node 1151 may identify another package arrives in the vicinity of the multi-package group. The master node may request authorization from the server to associate the other package with the existing multi-package group. If the server determines that the other package is intended to ship with the multi-package group, the server instructs the master node to merge one or more other packages with currently grouped set of packages. After all packages are grouped together, the server authorizes the multi-package group to ship. In some embodiments, this process may involve releasing the multi-package group from a containment area (e.g., customs holding area) in a shipment facility.

In some embodiments, the peripheral nodes 1158, 1160, 1162 include environmental sensors for obtaining information regarding environmental conditions in the vicinity of the associated packages 1159, 1161, 1163. Examples of such environmental sensors include temperature sensors, humidity sensors, acceleration sensors, vibration sensors, shock sensors, pressure sensors, altitude sensors, light sensors, and orientation sensors.

In the illustrated embodiment, the master node 1151 can determine its own location based on geolocation data transmitted by a satellite-based radio navigation system 1170 (e.g., GPS, GLONASS, and NAVSTAR) and received by the GPS receiver 1154 component of the master node 1151. In an alternative embodiment, the location of the master pallet node 1151 can be determined using cellular based navigation techniques that use mobile communication technologies (e.g., GSM, GPRS, CDMA, etc.) to implement one or more cell-based localization techniques. After the master node 1151 has ascertained its location, the distance of each of the packages 1159, 1161, 1163 from the master node 1151 can be estimated based on the average signal strength of the advertising packets that the master node 1151 receives from the respective peripheral node. The master node 1151 can then transmit its own location and the locations of the package nodes E, F, and G to a server over a cellular interface connection with a cellular network 1172. Other methods of determining the distance of each of the packages 1159, 1161, 1163 from the master node 1151, such as Received Signal-Strength Index (RSSI) based indoor localization techniques, also may be used.

In some embodiments, after determining its own location and the locations of the peripheral nodes, the master node 1151 reports the location data and the collected and optionally processed (e.g., either by the peripheral nodes peripheral nodes 1158, 1160, 1162 or the master node 1151) sensor data to a server over a cellular communication path 1171 on a cellular network 1172.

In some examples, nodes are able to autonomously detect logistics execution errors if packages that are supposed to travel together no longer travel together and raise an alert. For example, a node (e.g., the master node 1151 or one of the peripheral nodes 1158, 1160, 1162) alerts the server when the node determines that a particular package 1159 is being or has already been improperly separated from the group of packages. The node may determine that there has been an improper separation of the particular package 1159 in a variety of ways. For example, the associated peripheral node 1158 that is bound to the particular package 1159 may include an accelerometer that generates a signal in response to movement of the package from the pallet. In accordance with its intelligent agent program code, the associated peripheral node 1158 determines that the master node 1151 has not disassociated the particular package 1159 from the group and therefore broadcasts advertising packets to the master node, which causes the master node 1151 to monitor the average signal strength of the advertising packets and, if the master node 1151 determines that the signal strength is decreasing over time, the master node 1151 will issue an alert either locally (e.g., through a speaker component of the master node 1151) or to the server.

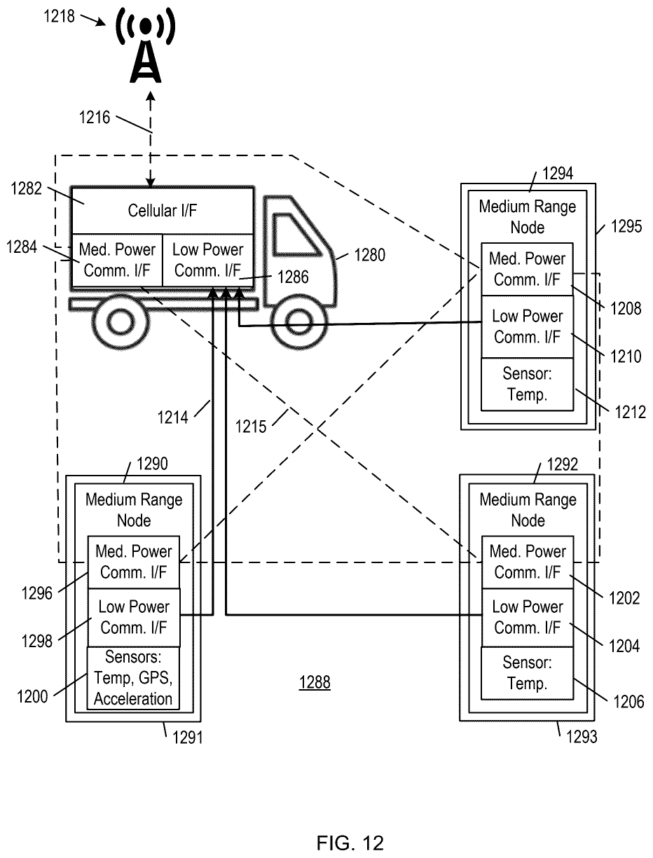

FIG. 12 is a schematic illustrating a truck 1280 configured as a mobile node or mobile hub that includes a cellular communications interface 1282, a medium-power communications interface 1284, and a low power communications interface 1286. The communications interfaces 1280-1286 may be implemented on one or more tape and non-tape nodes. In an illustrative scenario, the truck 1280 visits a logistic storage facility, such as a warehouse 1288, to wirelessly obtain temperature data generated by temperature sensors in the medium range nodes 1290, 1292, 1294. The warehouse 1288 contains nodes 1290, 1292, and 1294 that are associated with respective logistic containers 1291, 1293, 1295. In the illustrated embodiment, each node 1290-1294 is a medium range node that includes a respective medium power communications interface 1296, 1202, 1208, a respective low power communications interface 1298, 1204, 1210 and one or more respective sensors 1200, 1206, 1212. In the illustrated embodiment, each of the package nodes 1290, 1292, 1294 and the truck 1280 is connected to each of the other ones of the package nodes through a respective medium power communications path (shown by dashed lines). In some embodiments, the medium power communications paths are LoRa formatted communication paths.

In some embodiments, the communications interfaces 1284 and 1286 (e.g., a LoRa communications interface and a Bluetooth Low Energy communications interface) on the node on the truck 1280 is programmed to broadcast advertisement packets to establish connections with other network nodes within range of the truck node. A warehouse 1288 includes medium range nodes 1290, 1292, 1294 that are associated with respective logistic containers 1291, 1293, 1295 (e.g., packages, boxes, pallets, and the like). When the truck node's low power interface 1286 is within range of any of the medium range nodes 1290, 1292, 1294 and one or more of the medium range nodes is operating in a listening mode, the medium range node will extract the address of truck node and potentially other information (e.g., security information) from the advertising packet. If, according to its programmatic code, the truck node determines that it is authorized to connect to one of the medium range nodes 1290, 1292, 1294, the truck node will attempt to pair with the medium range node. In this process, the truck node and the medium range node determine each other's identities, capabilities, and services. For example, after successfully establishing a communication path with the truck node (e.g., a Bluetooth Low Energy formatted communication path 1214 or a LoRa formatted communication path 1217), the truck node determines the identity information for the medium range node 1290 (e.g., a peripheral node), the medium range node's capabilities include retrieving temperature data, and the medium range node's services include transmitting temperature data to other nodes. Depending of the size of the warehouse 1288, the truck 1280 initially may communicate with the nodes 1290, 1292, 1294 using a low power communications interface (e.g., Bluetooth Low Energy interface). If any of the anticipated nodes fails to respond to repeated broadcasts of advertising packets by the truck 1280, the truck 1280 will try to communicate with the non-responsive nodes using a medium power communications interface (e.g., LoRa interface). In response to a request from the medium-power communication interface 1284, the medium range node 1290 transmits an indication of its measured temperature data to the truck node. The truck node repeats the process for each of the other medium range nodes 1292, 1294 that generate temperature measurement data in the warehouse 1288. The truck node reports the collected (and optionally processed, either by the medium range nodes 1290, 1292, 1294 or the truck node) temperature data to a server over a cellular communication path 1216 with a cellular network 1218.

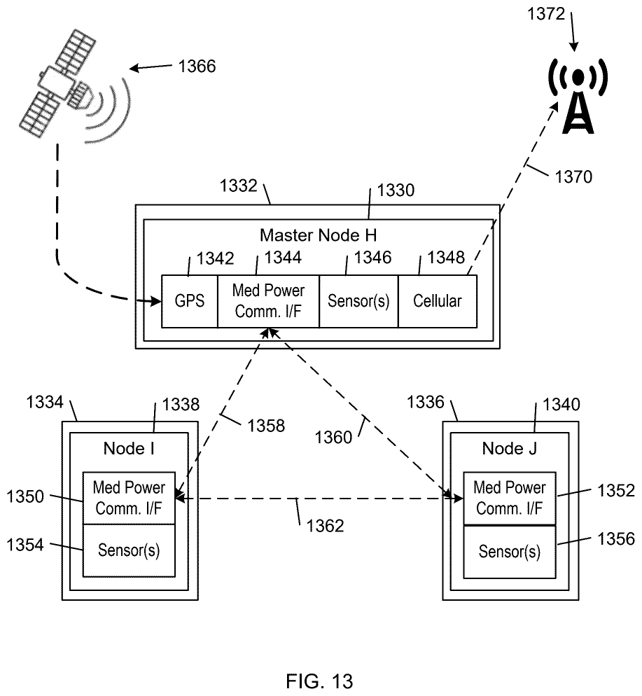

FIG. 13 is a schematic illustrating a master node 1330 is associated with a logistic item 1332 (e.g., a package) and grouped together with other logistic items 1334, 1336 (e.g., packages) that are associated with respective peripheral nodes 1338, 1340. The master node 1330 includes a GPS receiver 1342, a medium power communications interface 1344, one or more sensors 1346, and a cellular communications interface 1348. Each of the peripheral nodes 1338, 1340 includes a respective medium power communications interface 1350, 1352 and one or more respective sensors 1354, 1356. In the illustrated embodiment, the peripheral and master nodes are connected to one another other over respective pairwise communications paths (shown by dashed lines). In some embodiments, the nodes 1330, 1338, 1340 communicate through respective LoRa communications interfaces over LoRa formatted communications paths 1358, 1360, 1362.

In the illustrated embodiment, the master and peripheral nodes 1330, 1338, 1340 include environmental sensors for obtaining information regarding environmental conditions in the vicinity of the associated logistic items 1332, 1334, 1336. Examples of such environmental sensors include temperature sensors, humidity sensors, acceleration sensors, vibration sensors, shock sensors, pressure sensors, altitude sensors, light sensors, and orientation sensors.

In accordance with the programmatic code stored in its memory, the master node 1330 periodically broadcasts advertising packets in the surrounding area. When the peripheral nodes 1338, 1340 are within range of master node 1330, and are operating in a listening mode, the peripheral nodes 1338, 1340 will extract the address of master node 1330 and potentially other information (e.g., security information) from the advertising packets. If, according to their respective programmatic code, the peripheral nodes 1338, 1340 determine that they are authorized to connect to the master node 1330, the peripheral nodes 1338, 1340 will attempt to pair with the master node 1330. In this process, the peripheral nodes 1338, 1340 and the master node 1330 determine each other's identities, capabilities, and services. For example, after successfully establishing a respective communication path 1358, 1360 with each of the peripheral nodes 1338, 1340 (e.g., a LoRa formatted communication path), the master node 1330 determines certain information about the peripheral nodes 1338, 1340, such as their identity information (e.g., peripheral nodes), their capabilities (e.g., measuring temperature data), and their services include transmitting temperature data to other nodes.

After establishing LoRa formatted communications paths 1358, 1360 with the peripheral nodes 1338, 1340, the master node 1330 transmits requests for the peripheral nodes 1338, 1340 to transmit their measured and/or locally processed temperature data to the master node 1330.

In the illustrated embodiment, the master node 1330 can determine its own location based on geolocation data transmitted by a satellite-based radio navigation system 1366 (e.g., GPS, GLONASS, and NAVSTAR) and received by the GPS receiver 1342 component of the master node 1330. In an alternative embodiment, the location of the master node 1330 can be determined using cellular based navigation techniques that use mobile communication technologies (e.g., GSM, GPRS, CDMA, etc.) to implement one or more cell-based localization techniques. After the master node 1330 has ascertained its location, the distance of each of the logistic items 1334, 1336 from the master node 1330 can be estimated based on the average signal strength of the advertising packets that the master node 1330 receives from the respective peripheral node. The master node 1330 can then transmit its own location and the locations of the package nodes H, J, and I to a server over a cellular interface connection with a cellular network 1372. Other methods of determining the distance of each of the logistic items 1334, 1336 from the master node 1330, such as Received Signal-Strength Index (RSSI) based indoor localization techniques, also may be used.

In some embodiments, after determining its own location and the locations of the peripheral nodes, the master node 1330 reports the location data, the collected and optionally processed (e.g., either by the peripheral nodes peripheral nodes 1338, 1340 or the master node 1330) sensor data to a server over a cellular communication path 1370 on a cellular network 1372.

### Multi-Communication-Interface System for Fine Locationing

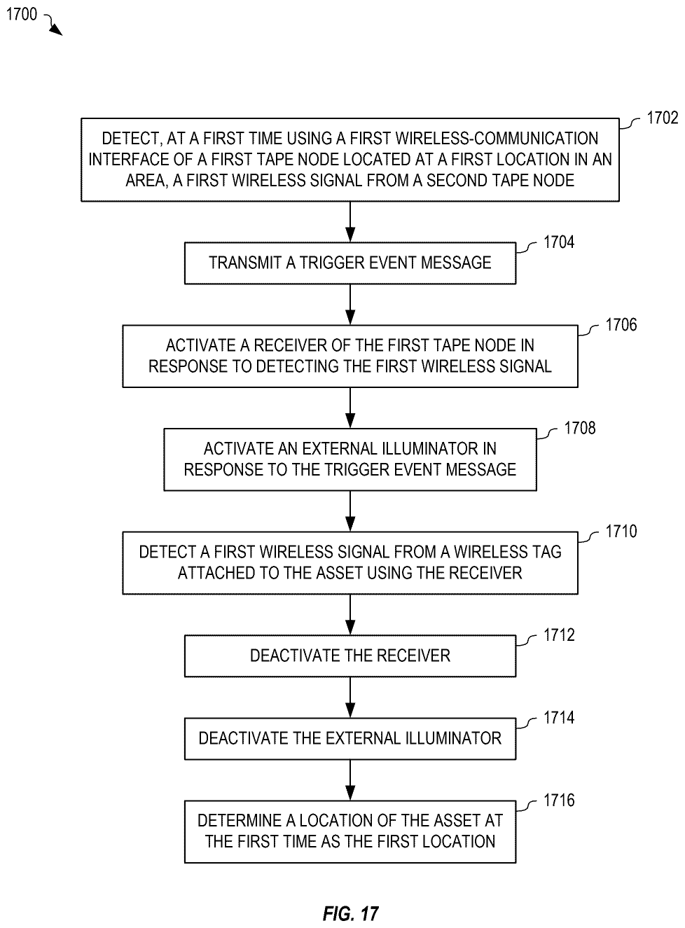

U.S. patent application Ser. No. 16/839,048, incorporated herein by reference in its entirety, and FIGS. 1A-1C of U.S. patent application Ser. No. 17/067,608, incorporated herein by reference in its entirety, teach how an RFID tag may be combined with a tape node and correlated together. FIGS. 17A and 17B of patent application Ser. No. 17/873,072, teach how a wireless transducing circuit of a tape node may also include an RFID reader.

As used herein, activating means either powering-on, such as applying power to or switching on, or transitioning from a sleep or low-power inactive state to an active or operational state; and deactivating means either powering-off, such as removing power to or switching off, or transitioning from an active or operational state to a sleep or low-power inactive state.

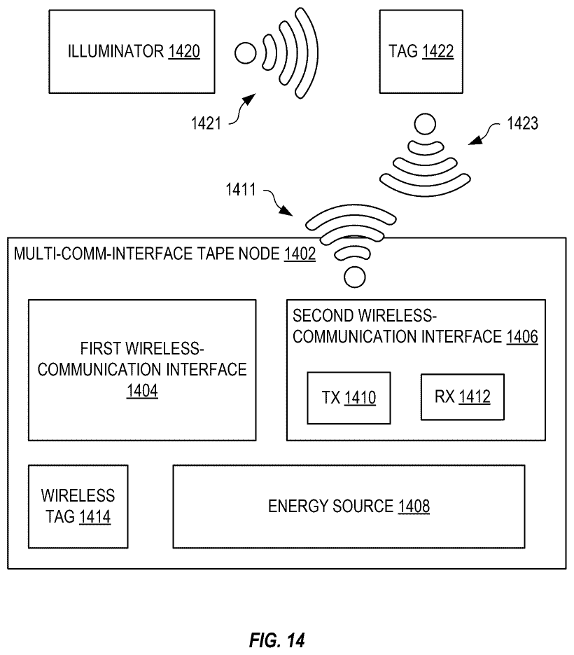

FIG. 14 is a schematic illustrating one example multi-communication-interface tape node 1402 that includes both a first wireless-communication interface 1404 (e.g., low power communication interface 652, FIG. 6A) and a second wireless-communication interface 1406 (e.g., RFID reader 1710 in FIGS. 17A and 17B of patent application Ser. No. 17/873,072). The first wireless-communication interface 1404 may operate according to a first communication protocol and the second wireless-communication interface may operate according to a second communication protocol that consumes more power than the first communication protocol. The discussion herein may refer to a specific embodiment where second wireless-communication interface 1406 is an “RFID reader” (e.g., “RFID reader 1406”). However, should be appreciated that, while in one embodiment, the second wireless-communication interface 1406 implements the second communication protocol as RFID-based, it is not limited to such.

Multi-communication-interface tape node 1402 is powered from an internal energy source 1408 (e.g., a one-time use battery, a rechargeable battery, etc.). First wireless-communication interface 1404 may implement one or more of a Bluetooth protocol, a cellular protocol, a Wi-Fi protocol, a Long Range (LoRa) protocol, a LoRaWAN protocol, a satellite communication protocol, a Zigbee protocol, an NFC protocol, an RF protocol, or some other wireless communications protocol. First wireless-communication interface 1404 consumes less power than second wireless-communication interface 1406, and its receiver may operate continuously without overly draining energy source 1408. However, second wireless-communication interface 1406 requires more power to operate than first wireless-communication interface 1404, and therefore cannot operate continuously without draining energy source 1408 too quickly for long-term lifespan of the multi-communication-interface tape node 1402.

In certain embodiments, second wireless-communication interface 1406 includes both a transmitter 1410 for transmitting an interrogation signal 1411 and a receiver 1412 for receiving tag response signals 1423. In any embodiment discussed herein, the transmitter 1410 may be an RFID transmitter 1410, the interrogation signal 1411 may be an RFID interrogation signal 1411, and the receiver may be an RFID receiver 1412, and the tag response signals 1423 may be RFID tag response signals 1423). In certain embodiments, transmitter 1410 is omitted from second wireless-communication interface 1406, whereby receiver 1412 receives wireless tag response signals caused by an illuminator signal 1421 of an external illuminator 1420. In any embodiment discussed herein, illuminator 1420 may be an RFID illuminator, and the illuminator signal 1421 may be an RFID illuminator signal. Accordingly, multi-communication-interface tape node 1402 may detect and interrogate nearby ID tags (e.g., RFID tags). In certain embodiments, multi-communication-interface tape node 1402 includes a circuit that activates second wireless-communication interface 1406 and/or receiver 1412 when a signal (e.g., interrogation signal 1421) is detected, and deactivates second wireless-communication interface 1406 and/or receiver 1412 when no interrogation signal is detected.

In other embodiments, where illuminator 1420 operates substantially continuously (or frequently) to detect wireless tags, multi-communication-interface tape node 1402 may deactivate first wireless-communication interface 1404 until receiver 1412 of second wireless-communication interface 1406 detects a wireless tag response signal 1423. For example, detecting, using receiver 1412, a response signal from an RFID tag that is interrogated by interrogation signal 1421 from illuminator 1420 causes multi-communication-interface tape node 1402 to activate first wireless-communication interface 1404 to enable Bluetooth communications.

Antennae and corresponding coverage area of second wireless-communication interface 1406 may be configured to have a more directional and/or smaller coverage area as compared to conventional wireless readers (e.g., off the shelf RFID readers). In certain embodiments, the coverage area of second wireless-communication interface 1406 is dynamically configurable by a user (e.g., an installer) using an interactive interface (e.g., using a mobile gateway. For example, based on the location of multi-communication-interface tape node 1402, a user may set the coverage area of second wireless-communication interface 1406/receiver 1412. Accordingly, second wireless-communication interface 1406 may provide fine locationing (e.g., more accuracy of location) of detected tags, as compared to conventional wireless readers. For example, second wireless-communication interface 1406 may have a granularity of one foot and may thereby be used to create or design any specific coverage area (e.g., a cone of operation) as needed within a specific environment.

Where an asset includes both a tape node and a wireless tag (e.g., a tape node with RFID inlay as taught by patent application Ser. No. 17/067,608, or a separate RFID tag), multi-communication-interface tape node 1402 may first detect the tape node (e.g., using Bluetooth/BLE) using the first wireless-communication interface, and then activate its second wireless-communication interface 1406 to read the wireless tag (e.g., activate the wireless-communication interface 1406 RFID reader to read an RFID tag). Accordingly, second wireless-communication interface 1406 is activated only as needed to conserver battery power of multi-communication-interface tape node 1402.

In certain embodiments, multi-communication-interface tape node 1402 may also include a wireless tag 1414, which may be an RFID-based tag.

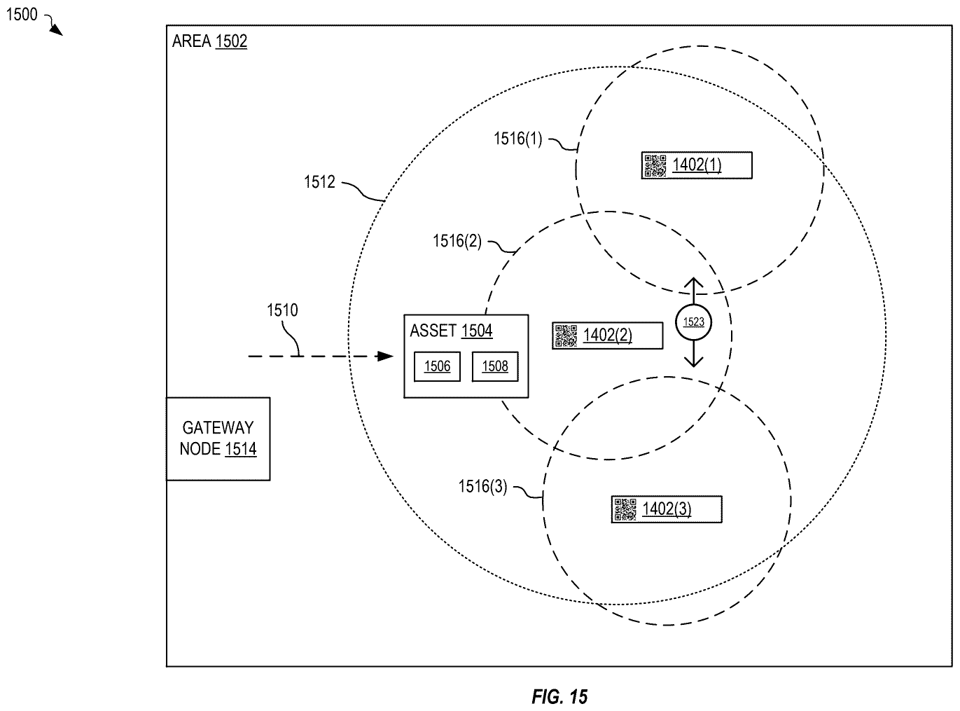

FIG. 15 is a schematic diagram illustrating operation of one example multi-communication-interface system 1500 for fine locationing. System 1500 includes three multi-communication-interface tape nodes 1402(1)-(3) of FIG. 14 (which are RFID tape nodes in at least one embodiment), deployed at different locations within an area 1502 (e.g., a storage facility, a vehicle, a warehouse, etc.). More or fewer multi-communication-interface tape nodes 1402 may be deployed without departing from the scope hereof. During installation of multi-communication-interface tape nodes 1402, their locations are registered in a database (e.g., database 808 of servers 804 of FIG. 8). For example, a mobile gateway (e.g., mobile gateway 810, such as a smartphone or tablet) allows a user to register a location of each multi-communication-interface tape node 1402 when installed and initialized, where the mobile gateway retrieves a unique identifier of the tape node by reding a bar code on the tape node or by communicating directly with the tape node. The user may indicate the location by dropping a pin on a map/floor plan of the area, for example, or a current location determined by the mobile gateway during the installation of the tape node may be used.

In one example, the database (e.g., database 808 in the cloud) stores a facility map/layout that is accessible by the mobile gateway device (e.g., mobile gateway 810). Accordingly, during installation of each multi-communication-interface tape node 1402 and gateway node 1514, the mobile gateway defines the location of each device on the map. Each multi-communication-interface tape node 1402 and gateway node 1514 may also store at least part of the database and/or map and therefore learns of the location of other devices. However, multi-communication-interface tape node 1402 and gateway node 1514 may only use distance and bearing information between devices. In certain embodiments, the server (e.g., server 804) and/or gateway nodes (e.g., the mobile gateway and/or gateway node 1514) may perform fine locationing calculations based on the database information.

The database (e.g., in the cloud) stores the location in association with the unique identifier. Each multi-communication-interface tape node 1402 may also store its own location as determined at its installation and provided by the mobile gateway. The recorded location may be one or more of geographic coordinates, a room number, a vehicle number, etc., which may be provided to other wireless nodes. In certain embodiments, a local gateway node (e.g., gateway node 1514) may also store location information of nearby tape nodes. Since multi-communication-interface tape nodes 1402 relay information (e.g., RFID tag identifiers) to remote servers via the gateway node, the gateway node may use the locations of each multi-communication-interface tape node 1402 to perform the fine locationing. The gateway node may then provide the location to the database and/or to the asset tape directly. Alternatively, the gateway node may relay the information to the server, whereby an application (e.g., applications 806) running on the server may process the information together with multi-communication-interface tape nodes 1402 identifiers to perform fine locationing. Multi-communication-interface tape nodes 1402 form a mesh network, as described above (see network communications environment 800, FIG. 8), and may each communicate using first wireless-communication interface 1404. First wireless-communication interface 1404 within each multi-communication-interface tape node 1402 is active, and since it is relatively low power as compared to second wireless-communication interface 1406, drain on energy source 1408 is relatively low. However, since a power requirement of second wireless-communication interface 1406 is not insignificant, second wireless-communication interface 1406 within each multi-communication-interface tape node 1402 is deactivated when not needed to reduce power drain on energy source 1408.

An asset 1504 has an associated tape node 1506 (e.g., segment 640, FIG. 6A) and an associated wireless tag 1508 (e.g., RFID tag). In certain embodiments, as wireless tag 1508 may be incorporated (e.g., embedded) with tape node 1506 (such as discussed in patent application Ser. No. 17/067,608). In the scenario illustrated by FIG. 15, as asset 1504 enters, indicated by arrow 1510, area 1502, its tape node 1506 enters a reception area 1512 of wireless-communication interface 1404 of multi-communication-interface tape node 1402(2), which detects, using first wireless-communication interface 1404, a wireless signal (e.g., Bluetooth, BLE, etc.) from tape node 1506. Detection of this wireless signal is associated with an event of asset 1504 entering area 1502, and therefore detecting the wireless signal is a triggering event. In this example, the event (e.g., detection of the wireless signal from tape node 1506) indicates that asset 1504 is within area 1502. However, given that reception area 1512 of wireless-communication interface 1404 is large, relative to area 1502, use of wireless-communication interface 1404 to detect the wireless signal from tape node 1506 may not provide fine locationing within area 1502.

In response to the triggering event, multi-communication-interface tape node 1402(2) may (a) activate its second wireless-communication interface 1406 (which may be RFID-based), and/or (b) send a trigger event message 1523 (e.g., a broadcast using its first wireless-communication interface 1404) to other multi-communication-interface tape nodes 1402(1) and 1402(3) within area 1502, indicating the triggering event (e.g., the detected wireless signal). On receiving trigger event message 1523, each other multi-communication-interface tape node 1402(1) and (3) may activate its own second wireless-communication interface 1406 (which may be RFID-based, or otherwise higher-power consumption than the first wireless-communication interface 1404).

Advantageously, since second wireless-communication interface 1406 of each multi-communication-interface tape node 1402 is activated in response to the triggering event (wireless signal from the tape node), wireless tags on asset 1504 are not missed due to inactivation of the second wireless-communication interface. Further, activation of second wireless-communication interface 1406 of each multi-communication-interface tape node 1402 occurs only when needed, and therefore the second wireless-communication interface is not activated to detect changes in wireless tag inventory, but in response to an event (e.g., arrival of asset 1504 in area 1502) that may indicate change in wireless tag inventory within area 1502.

Each second wireless-communication interface 1406(1)-(3) detects wireless tags (e.g., wireless tag 1508) within its second wireless-communication interface receive area 1516(1)-(3) (shown as circles in this example), respectively, which is smaller than reception area 1512 of first wireless-communication interface 1404. Advantageously, when wireless tag 1508 is detected by multi-communication-interface tape node 1402, its location is associated with second wireless-communication interface receive area 1516, thereby providing fine locationing within area 1502.

After operating for a certain period, or after detecting no change in wireless tag inventory for a certain period, each multi-communication-interface tape node 1402 deactivates its second wireless-communication interface 1406, until a next triggering event occurs.

In certain embodiments, a gateway node 1514 (e.g., one of mobile gateway 810 and stationary gateway 814 of FIG. 8) is positioned near an entrance of area 1502 to detect the wireless signal from tape node 1506 of asset 1504 as it enters area 1502. In response to detecting the presence of tape node 1506, gateway node 1514 may send trigger event message 1523 to multi-communication-interface tape nodes 1402(1)-(3) within area 1502. Each multi-communication-interface tape node 1402 may report change in its detected wireless tag inventory to gateway node 1514, and thereby to other components of its network communication environment (e.g., network communications environment 800, FIG. 8).

In a first example, fine locationing of asset 1504 within area 1502 is determined by multi-communication-interface tape node 1402(1) based on signals detected by one or both of first wireless-communication interface 1404 and second wireless-communication interface 1406. In a second example, fine locationing of asset 1504 within area 1502 is determined by gateway node 1514 based on communicated data (e.g., signal strength (RSSI)) from one or more multi-communication-interface tape nodes 1402. In a third example, fine locationing of asset 1504 within area 1502 is determined by tape node 1506 of asset 1504 based on RSSI data relayed to tape node 1506 from at least one of multi-communication-interface tape nodes 1402 via first wireless-communication interface 1404. In a fourth example, fine locationing of asset 1504 within area 1502 is determined by multi-communication-interface tape nodes 1402 sharing, via first wireless-communication interface 1404, RSSI data from each second wireless-communication interface 1406 of multi-communication-interface tape nodes 1402. The versatility of fine location described herein is based on a liquid computing hierarchy of multi-communication-interface tape nodes 1402 and gateway node 1514 that is implemented via first wireless-communication interfaces 1404.

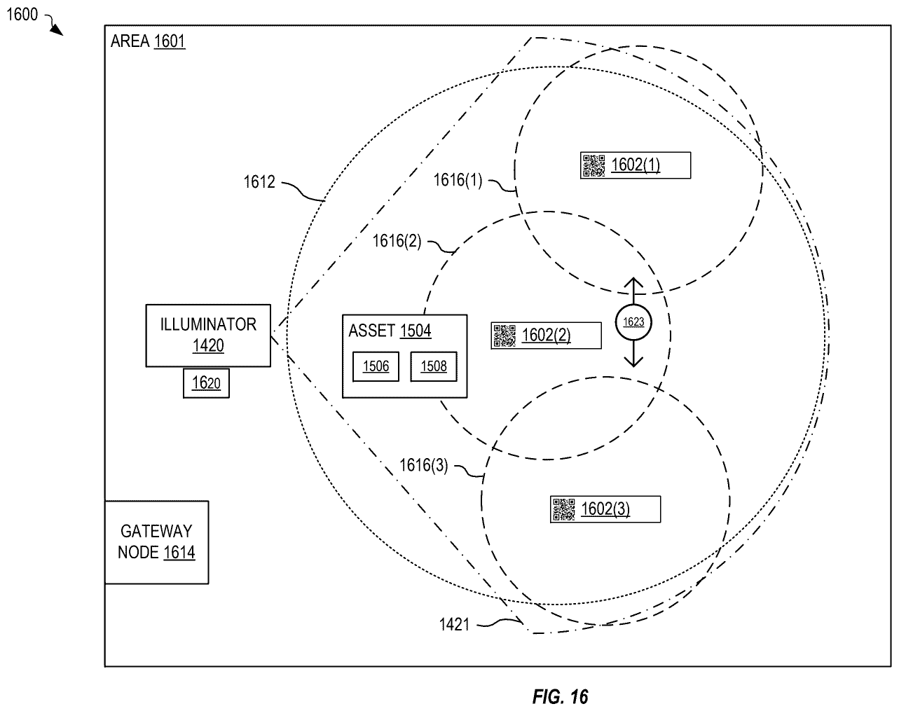

FIG. 16 is a schematic diagram illustrating operation of one example multi-communication-interface system 1600 for fine locationing. System 1600 includes three multi-communication-interface tape nodes 1602(1)-(3) (similar to multi-communication-interface tape nodes 1402 of FIG. 14 but with transmitter 1410 of second wireless-communication interface 1406 omitted), deployed at different locations within an area 1601 (e.g., a storage facility, a vehicle, a warehouse, etc.), and a wireless illuminator 1420 that transmits an wireless interrogation signal (e.g., RFID illuminator signal 1421) to activate any wireless tag within at least part of area 1601. More or fewer multi-communication-interface tape nodes 1602 may be deployed without departing from the scope hereof. Area 1601 may also include a gateway node 1614 that is similar to gateway node 1514 of FIG. 15. Multi-communication-interface tape nodes 1602 form a mesh network, as described above, and may each communicate using at least first wireless-communication interface 1404. First wireless-communication interface 1404 within each multi-communication-interface tape node 1602 is active, and since it is relatively low power, drain on energy source 1408 is relatively low. Although power requirements of second wireless-communication interface 1406 without transmitter 1410 is less than power required by second wireless-communication interface 1406 using transmitter 1410, it is still not insignificant, and second wireless-communication interface 1406 within each multi-communication-interface tape node 1602 is deactivated to reduce power drain on energy source 1408.

An asset 1504, with associated tape node 1506 and wireless tag 1508, enters area 1601, its tape node 1506 enters a reception area 1612 of wireless-communication interface 1404 of multi-communication-interface tape node 1602(2), which detects a wireless signal from tape node 1506 as a triggering event. In response to the triggering event, multi-communication-interface tape node 1602(2) may (a) activate its receiver 1412, and/or (b) send a trigger event message 1623 (e.g., a broadcast using its wireless-communication interface 1404) to other multi-communication-interface tape nodes 1602(1) and 1602(3) within area 1601, indicating the triggering event. On receiving trigger event message 1623, each other multi-communication-interface tape node 1602(1) and (3) may activate its own RFID receiver 1412.

In certain embodiments, illuminator 1420 is hard wired to a power source and operates continuously to transmit an RFID interrogation signal, thereby causing any RFID tag (e.g., wireless tag 1508) within area 1601 to respond with an RFID response signal that, when in range, may be detected by receivers 1412 of multi-communication-interface tape nodes 1602(1)-(3), where the second wireless-communication interface 1406 of multi-communication-interface tape nodes 1602(1)-(3) are RFID-based. In other embodiments, illuminator 1420 is not active continuously and includes, or is controlled by, a tape node 1620 that also receives (directly or indirectly) trigger event message 1623 and activates illuminator 1420 to transmit the RFID interrogation signal. In other embodiments, tape node 1620 may be implemented as a Bluetooth operated power switch that is controlled from a different tape node (e.g., multi-communication-interface tape node 1602(2), or gateway node 1614). As discussed above, wireless protocols other than RFID may be implemented by illuminator 1420, resulting in said interrogation signal and response signal being based on said other wireless communication protocol. In certain embodiments, illuminator 1420 turns off when no asset tape nodes (e.g., tape node 1506) are detected within area 1601 (e.g., within coverage area 1612) of multi-communication-interface tape nodes 1602), since fine locationing of tape nodes within area 1601 is not needed when no assets are present. For example, illuminator 1420 is activated when asset 1504 enters area 1601 and is deactivated when asset 1504 is detected leaving area 1601. In certain embodiments, illuminator 1420 is deactivated upon receiving a report that the fine location of asset 1504 has been determined and that asset 1504 has not moved for at least a predetermined period. In this case, illuminator 1420 may be reactivated when movement of asset 1504 is detected (either by a sensor on asset 1504, a sensor in area 1601 like a light/IR sensor or time of flight sensor, or by detection through Bluetooth/RSSI locationing). In certain embodiments, illuminator 1420 is activated based on a request to find an asset (for example a missing asset) and is deactivated upon receiving a report/confirmation that the asset is located. In certain embodiments, illuminator 1420 is deactivated after a predefined timeout period. If the fine locationing was unsuccessful, a subsequent request to activate illuminator 1420 is resubmitted to the illuminator. In certain embodiments, multi-communication-interface tape nodes 1602 provide confirmation that the wireless tag response signal from wireless tag 1508 was successful received to illuminator 1420 (e.g., tape node 1620), especially where tape node 1620 is operating as a gateway node for the network communications environment 800 and/or tape node 1620 is to deactivate illuminator 1420 after wireless tag 1508 is successfully read.

Advantageously, since receiver 1410 of each multi-communication-interface tape node 1602 is activated in response to the triggering event (wireless signal from the tape node), wireless tags are not missed due to inactivation of second wireless-communication interface 1406. Further, activation of receiver 1410 of each multi-communication-interface tape node 1602 occurs only when needed, and therefore each second wireless-communication interface 1406 is not activated to detect changes in wireless tag inventory but are activated in response to an event (e.g., arrival of asset 1504 in area 1601) that may indicate change in wireless tag inventory within area 1601 could potentially occur.

Accordingly, in response to trigger event message 1623, each second wireless-communication interface 1406(1)-(3) detects wireless tags (e.g., wireless tag 1508) within its coverage area 1616(1)-(3), respectively, which is smaller than reception area 1612 of first wireless-communication interface 1404. Advantageously, when wireless tag 1508 is detected by multi-communication-interface tape node 1602(1), its location is associated with the corresponding coverage area 1616, thereby providing fine locationing within area 1601.

After operating for a certain period, or after detecting no change in wireless tag inventory for a certain period, each multi-communication-interface tape node 1602 deactivates its second wireless-communication interface 1406, until a next triggering event occurs. Similarly, after a certain period, tape node 1620 may cause illuminator 1420 to deactivate.

In this embodiment, since multi-communication-interface tape nodes 1602 are not required to transmit an interrogation signal using second wireless-communication interface 1406, power usage of multi-communication-interface tape node 1602 is further reduced as compared to multi-communication-interface tape node 1402 of FIG. 15.

In certain embodiments, illuminator 1420/tape node 1620 may synchronize data with multi-communication-interface tape nodes 1602 and/or gateway node 1614 via first wireless-communication interfaces 1404 (e.g., Bluetooth protocol), where the synchronization data includes parameters for controlling second wireless-communication interface 1406 (e.g., RFID protocol) of multi-communication-interface tape nodes 1602. Illuminator 1420 may share the synchronization data with multi-communication-interface tape nodes 1602(1)-(3) and gateway node 1614 using first wireless-communication interface 1404 (e.g., Bluetooth), thereby enabling multi-communication-interface tape nodes 1602(1)-(3) and gateway node 1614 to receive and decode wireless response signal from wireless tag 1508. For example and without limitation, the synchronization data may include one or more of decryption keys, data for communication timing, frequency/wavelength parameters, credentials for authentication, authentication method, and any other parameter used by second wireless-communication interface 1406 for successful wireless communication. In one example of an embodiment where second wireless-communication interface 1406 implements the RFID protocol, illuminator 1420 may send a synchronization message defining a bit sequence used in illuminator signal 1421 with multi-communication-interface tape nodes 1602(1)-(3) and gateway node 1614. In another example of an embodiment where second wireless-communication interface 1406 implements the RFID protocol, each multi-communication-interface tape nodes 1602(1)-(3) and gateway node 1614 may send a bit sequence of received wireless tag response signal 1423 (e.g., a backscatter signal) to illuminator 1420 (and/or to other tape nodes) for decoding. Accordingly, one or more of illuminator 1420, multi-communication-interface tape nodes 1602(1)-(3), and gateway node 1614 may decode the wireless tag response signal 1423 from wireless tag 1508 to determine its unique wireless tag identifier.

Although coverage area 1612 of first wireless-communication interface 1404 is shown larger than coverage areas 1616 of receivers 1412, each coverage area 1612 and 1616 is dynamically configurable. As described above, coverage area 1616 of second wireless-communication interface 1406 and/or receiver 1412 is dynamically configurable by a user (e.g., an installer) using an interactive interface (e.g., using a mobile gateway. For example, based on the location of multi-communication-interface tape node 1402, a user may set the coverage area of second wireless-communication interface 1406/receiver 1412 to a physical area of an environment. Accordingly, second wireless-communication interface 1406 may provide fine locationing (e.g., more accuracy of location) of detected tags, as compared to conventional wireless readers. For example, second wireless-communication interface 1406 may have a granularity of one foot and may thereby be used to create or design any specific coverage area (e.g., a cone of operation) as needed within a specific environment.

FIG. 17 is a flowchart illustrating one example method 1700 for fine locationing using a multi-communication interface system. In certain embodiments, blocks 1702, 1704, 1706, 1710, 1712, and 1716 of method 1700 are implemented in multi-communication-interface tape node 1402 of FIG. 14 and/or multi-communication-interface tape node 1602 of FIG. 16, and blocks 1708 and 1714 are implemented by illuminator 1420 and/or tape node 1620 of FIG. 16.

In block 1702, method 1700 detects, at a first time using a first wireless-communication interface of a first tape node located at a first location in an area, a first wireless signal from a second tape node attached to an asset. In one example of block 1702, wireless-communication interface 1404 of multi-communication-interface tape node 1402(2) detects a Bluetooth wireless signal from tape node 1506 attached to asset 1504 as it enters area 1502. Wireless signals other than Bluetooth may be detected by first wireless-communication interface 1404 without departing from the scope hereof. Block 1704 may be optional. In block 1704, if included, method 1700 transmits a trigger event message. In one example of block 1704, multi-communication-interface tape node 1402(2) transmits trigger event message 1523 using its first wireless communication interface 1404 in response to detection of the wireless signal from tape node 1506 to one or more of gateway node 1514 and/or other tape nodes 1402.

In block 1706, method 1700 activates a receiver of the first tape node in response to detecting the first wireless signal. In one example of block 1706, in embodiments where multi-communication-interface tape node 1402(2) includes transmitter 1410, multi-communication-interface tape node 1402(2) activates both its transmitter 1410 and receiver 1412 of second wireless-communication interface 1406 in response to its first wireless-communication interface 1404 detecting the Bluetooth wireless signal from tape node 1506. The transmitter 1410 and receiver 1412 may be based on RFID protocol, or otherwise a wireless-communication interface requiring more power consumption than the first wireless-communication interface 1404. In another example of block 1706, in embodiments where transmitter 1410 is omitted (or not used) in multi-communication-interface tape node 1402(2), multi-communication-interface tape node 1402(2) activates its receiver 1412 in response to its first wireless-communication interface 1404 detecting the wireless signal (which may be Bluetooth-based) from tape node 1506. Block 1708 is included in embodiments where illuminator 1420 is activated to generate an interrogational signal (which may be RFID-based in at least one embodiment). In block 1708, if included, method 1700 activates an external illuminator in response to the trigger event message. In one example of block 1708, tape node 1620 receives trigger event message 1623 and activates illuminator 1420 associated therewith. In certain embodiments, where illuminator 1420 has a less limited and/or sustainable power source (e.g., line powered, large battery capacity, and/or uses energy harvesting such as solar power, wireless, etc.), illuminator 1420 may operate continuously, periodically, on a schedule (e.g., with time multiplexing) for finite periods, or operate without needing to be activated and deactivated by trigger event message 1623.

In block 1710, method 1700 detects a first signal from a wireless tag attached to the asset using the receiver. In one example of block 1710, multi-communication-interface tape node 1402(2) uses its receiver 1412 of the second wireless-communication interface 1406 to receive a response by wireless tag 1508 of asset 1504. In a specific embodiment of block 1710, the second wireless-communication interface 1406 and response received thereby from wireless tag 1508 are RFID-based. In block 1712, method 1700 deactivates the receiver. In one example of block 1712, multi-communication-interface tape node 1402(2) deactivates its receiver 1412 of second wireless-communication interface 1406.

Block 1714 is included in embodiments where illuminator 1420 is activated to generate an interrogational signal (which may be RFID in at least one embodiment), and thus is included when block 1708 is included. In block 1714, if included, method 1700 deactivates the illuminator. In one example of block 1714, tape node 1620 deactivates illuminator 1420 after a certain period.

In block 1716, method 1700 determines a location of the asset at the first time as the first location. In one example of block 1716, multi-communication-interface tape node 1402(2) determines that wireless tag 1508 is within receive area 1516(2) when its receiver 1412 receives the response from wireless tag 1508, and sends a message, via its wireless-communication interface 1404 to a gateway node (e.g., gateway node 1514) and/or a remote server (e.g., server(s) 804, FIG. 8). In another example of block 1716, multi-communication-interface tape node 1602(2) determines that wireless tag 1508 is within coverage area 1616(2) when its receiver 1412 receives the response from wireless tag 1508, and sends a message, via its wireless-communication interface 1404 to a gateway node (e.g., gateway node 1614) and/or a remote server (e.g., server(s) 804, FIG. 8). Method 1700 then returns to block 1702 to await a next event (e.g., detection of a next wireless signal from another tape node).

### Multi-Path and Bleed-Through Resolution

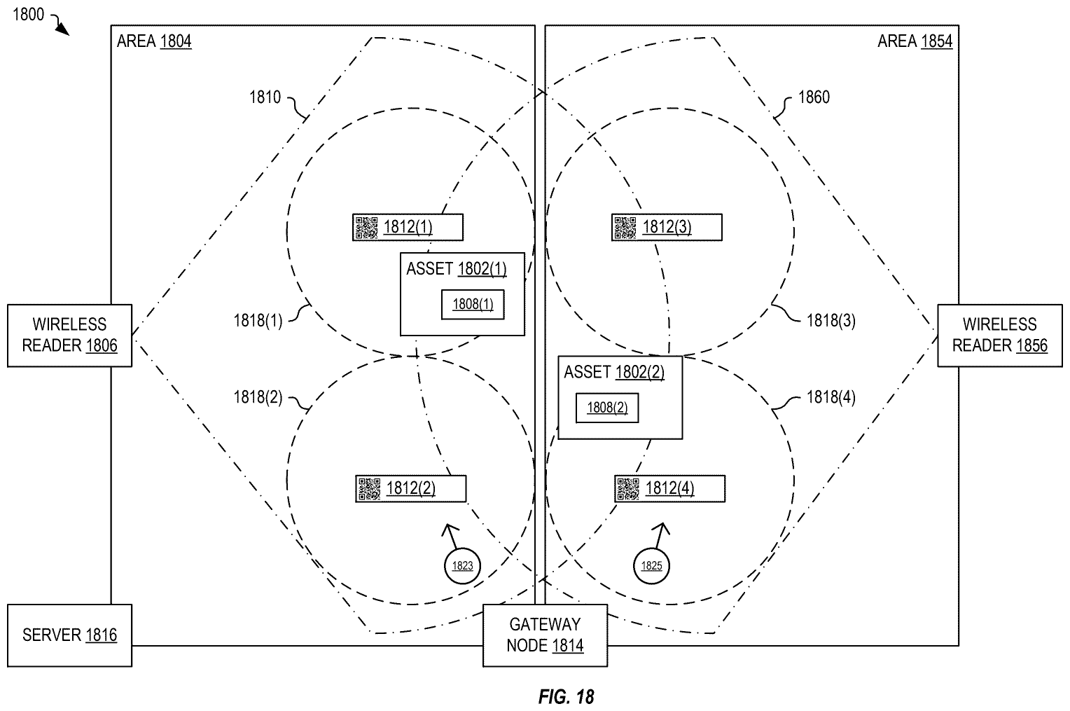

FIG. 18 is a schematic diagram illustrating one example multi-communication-interface system 1800 that eliminates false detection (e.g., bleed-through, multi-path detection) of wireless tags. In the example of FIG. 18, assets 1802 may be stored in two different areas 1804 and 1854 (e.g., rooms, storage areas, staging areas, etc.) that are adjacent to each other. Each area 1804, 1854, has a wireless reader 1806, 1856 (which, in embodiments may implement RFID-based wireless reading of wireless tags), respectively, for detecting wireless tags 1808 (which may be RFID-based) of assets 1802 within its corresponding area 1804, 1854. Wireless readers 1806 and 1856 may be off-the-shelf devices and have coverage areas 1810, 1860, respectively. Asset 1802(1) is within area 1804 and asset 1802(2) is within area 1854; however, both assets 1802(1) and 1802(2) are within both coverage areas 1810 and 1860. Accordingly, both assets 1802(1) and (2) are detected by wireless reader 1806 and asset 1802(2) is incorrectly assumed to be within area 1804, and both assets 1802(1) and (2) are detected by wireless reader 1856 and asset 1802(1) is incorrectly assumed to be within area 1854. Wireless reader 1806, 1856 and the wireless tags may be RFID based, or another wireless protocol such as a cellular protocol, a Wi-Fi protocol, a Long Range (LoRa) protocol, a LoRaWAN protocol, a satellite communication protocol, a Zigbee protocol, an NFC protocol, an RF protocol, or some other wireless communications protocol.

Advantageously, system 1800 may be deployed to resolve this problem. In the example of FIG. 18, system 1800 includes multi-communication-interface tape nodes 1812(1) and (2) that are deployed within area 1804 and multi-communication-interface tape nodes 1812(3) and (4) that are deployed within area 1854. Multi-communication-interface tape node 1812 may represent multi-communication-interface tape node 1602 of FIG. 16, each including one receiver 1412 and excluding (or not using) any transmitter 1410. System 1800 may include a gateway node 1814 that communicates with each multi-communication-interface tape node 1812, and optionally with an external server 1816 (e.g., a local control server/computer that operates wireless readers 1806 and 1856). In certain embodiments, where wireless readers 1806 and 1856 or server 1816 communicates with one of multi-communication-interface tape nodes 1812, the tape node may coordinate operation of wireless readers and other tape nodes 1812. In embodiments where the tape node includes long range communication, the tape node may also act as or replace gateway node 1814. For example, one of multi-communication-interface tape nodes 1812 may upload identification and location data to server 804 of network communications environment 800, provided it has sufficient battery power. In certain embodiments, multi-communication-interface tape nodes 1812 detect and use the interrogation signal from one of wireless readers 1806 and 1856 as a trigger to activate and perform the fine locationing of asset 1802. For example, each multi-communication-interface tape node 1812 periodically checks for the interrogation signal at a low enough frequency to conserve its battery power.

In certain embodiments, the multi-communication-interface tape node may include the passive wireless tag 1414 circuit that is powered by the interrogation signal and may be used to wake the multi-communication-interface tape node to activate and perform the fine locationing. In certain embodiments, gateway node 1814 may be combined with server 1816. In other embodiments, gateway node 1814 is supplemental to server 1816 to retrofit an existing wireless reader system.

As described above for multi-communication-interface tape node 1402 and 1602, each multi-communication-interface tape node 1812 is battery powered, thereby requiring minimal infrastructure for installation. For example, when implemented in the above-described adhesive tape platform form factor (e.g., see adhesive tape platform 330, FIG. 3), multi-communication-interface tape nodes may be adhered to a convenient surface (e.g., ceiling, walls, furniture, etc.). Battery power is conserved, as described above, by activating the receiver 1412 of each multi-communication-interface tape node 1812 as needed, and deactivating after use. Each multi-communication-interface tape node 1812(1)-(4) has a coverage area 1818(1)-(4), respectively, where coverage area 1818 is smaller than either of coverage areas 1810 or 1860. As shown, multi-communication-interface tape node 1812(1) and (2) are positioned such that coverage areas 1818(1) and (2) are within area 1804 and multi-communication-interface tape nodes 1812(3) and (4) are positioned such that coverage areas 1818(3) and (4) are within area 1854. Two multi-communication-interface tape nodes 1812 are shown withing each area 1804/1854 for clarity of illustration; however, more or fewer multi-communication-interface tape node 1812 may be used to effect coverage of each area 1804/1054 without departing from the scope hereof.

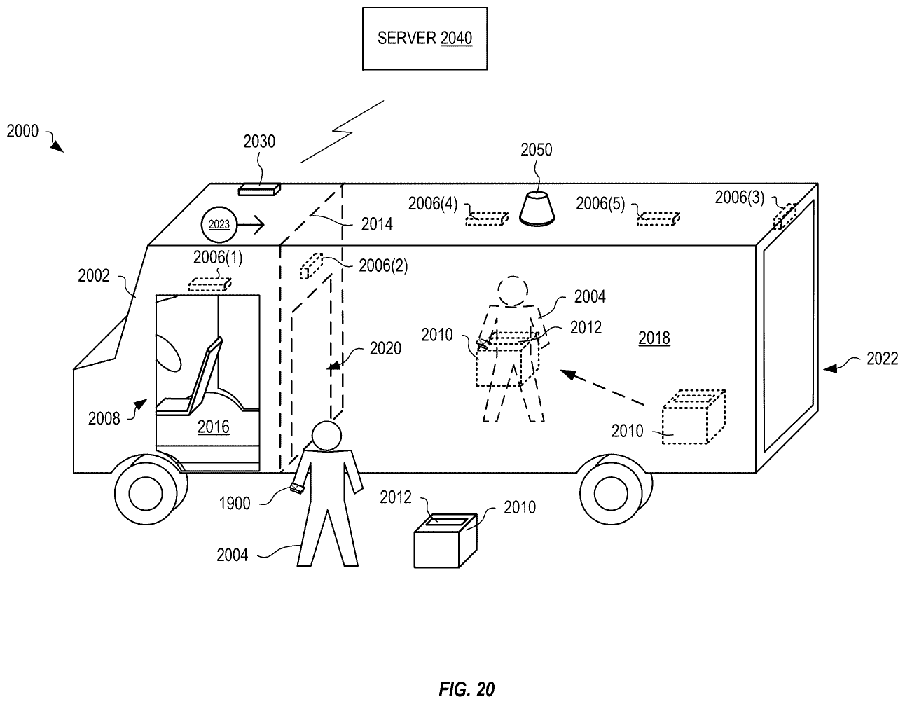

Each multi-communication-interface tape node 1812 activates its receiver 1412 to detect wireless tags 1808 (which may be RFID based) within its coverage area 1818 based on detected events. In one embodiment, the event corresponds to when the wireless readers are activated to take inventory of their respective areas. In another embodiment, where wireless readers 1806/1856 operate substantially continuously, the event may be triggered when inventory within each area 1804/1854 is expected to change. For example, where area 1804 has a door, an external sensor may generate the event when the door opens or closes. FIG. 20 and associated description provides another example of a person causing the trigger event.

In one example of operation, wireless reader 1806 is activated to take inventory of wireless tags 1808 (and, in at least some embodiments, the assets 1802 associated therewith) within area 1804 and generates a wireless interrogation signal within coverage area 1810. The wireless interrogation signal may be RFID based, or another protocol such as a cellular protocol, a Wi-Fi protocol, a Long Range (LoRa) protocol, a LoRaWAN protocol, a satellite communication protocol, a Zigbee protocol, an NFC protocol, an RF protocol, or some other wireless communications protocol. Activation of wireless reader 1806 causes a trigger event for system 1800, whereby gateway node 1814 sends a trigger event message 1823 to multi-communication-interface tape nodes 1812(1) and (2). In response to trigger event message 1823, each of multi-communication-interface tape nodes 1812(1) and (2) activates its receiver 1412. Wireless tag 1808(1) responds to the wireless interrogation signal by generating a wireless response signal (which may be RFID based) that is detected by both wireless reader 1806 and multi-communication-interface tape node 1812(1) and wireless tag 1808(2) responds to the wireless interrogation signal by generating a wireless response signal that is detected by wireless reader 1806. Multi-communication-interface tape node 1812(1) sends a message to gateway node 1814 indicating a time and information (e.g., at least an ID, as an RFID ID in embodiments where wireless reader 1806 is RFID based) of wireless tag 1808(1). When no additional wireless response signals are detected after a certain period and/or when not change in responses are detected, multi-communication-interface tape nodes 1812(1) and (2) deactivate their wireless receivers 1412 to conserve battery power.

At the same time or at a different time, wireless reader 1856 is activated to take inventory of wireless tags 1808 (e.g., the assets 1802 associated therewith) within area 1854 and generates an wireless interrogation signal within coverage area 1860. Activation of wireless reader 1856 causes a trigger event for system 1800, whereby gateway node 1814 sends a trigger event message 1825 to multi-communication-interface tape nodes 1812(3) and (4). In response to trigger event message 1825, each of multi-communication-interface tape nodes 1812(3) and (4) activates its wireless receiver 1412. Wireless tag 1808(2) responds to the wireless interrogation signal by generating a wireless response signal that is detected by both wireless reader 1856 and multi-communication-interface tape node 1812(4) and wireless tag 1808(1) responds to the wireless interrogation signal by generating a wireless response signal that is detected by wireless reader 1856. Multi-communication-interface tape node 1812(4) sends a message to gateway node 1814 indicating a time and information (e.g., at least a wireless ID, which is an RFID ID when the wireless reader is RFID based) of wireless tag 1808(2). When no additional wireless response signals are detected after a certain period and/or when not change in responses are detected, multi-communication-interface tape nodes 1812(3) and (4) deactivate their wireless receivers 1412 to conserve battery power.

Gateway node 1814 may send information of wireless tags detected by multi-communication-interface tape nodes 1812(1)-(4) to server 1816, the reported information includes fine location information derived from multi-communication-interface tape node 1812(1) for wireless tag 1808(1) and derived from multi-communication-interface tape node 1812(4) for wireless tag 1808(2). Accordingly, server 1816 learns that wireless tag 1808(1) is in area 1804 and wireless tag 1808(2) is in area 1854.

Server 1816 may ignore wireless response signals detected by wireless reader 1806 and wireless reader 1856 and instead use wireless tag information reported by gateway node 1814. Alternatively, server 1816 may correlate information received from wireless reader 1806 and wireless reader 1856 with information received from gateway node 1814. Advantageously, multi-communication-interface tape nodes 1812 provide fine locationing that overcomes the bleed-through and multipath problems of wireless tag response signals.

### Wearable RFID Reader

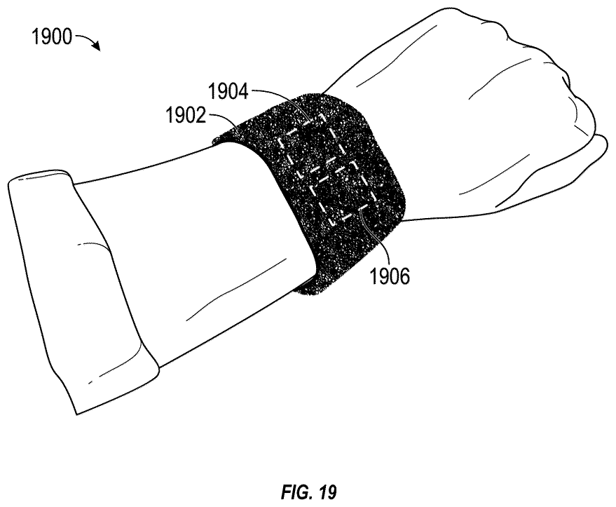

FIG. 19 shows one example wearable multi-communication-interface tape node 1900. Wearable multi-communication-interface tape node 1900 includes a band 1902 that supports a multi-communication-interface tape node 1904 and an optional wireless tag 1906. Band 1902 may be a latch-based, or hook-and-loop fastener based, and allows wearable multi-communication-interface tape node 1900 to be secured around a wrist of the user, for example. In certain embodiments, wearable multi-communication-interface tape node 1900 is a tape (e.g., disposable paper and/or plastic wrist band) that uses adhesive. Advantageously, band 1902 may adjust to any size of body part. Without departing from the scope hereof, wearable multi-communication-interface tape node 1900 may have other forms, including any one or more of: a pendant, a lapel tag/clip, a belt clip, a smart badge, and a necklace, a mobile device (e.g., smartphone, tablet, etc.), a multi-communication-interface tape node 1402 adhered to a mobile device), a master tape node 866 attached to an RFID reader, etc. Multi-communication-interface tape node 1904 may include components and functionality similar to multi-communication-interface tape node 1402 of FIG. 14. For example, multi-communication-interface tape node 1904 includes at least one first wireless-communication interface 1410 and a second wireless-communication interface 1412. In certain embodiments, multi-communication-interface tape node 1904 also include wireless tag 1414. For the following examples, second wireless-communication interface 1412 includes both transmitter 1410 and receiver 1412.

Advantageously, wearable multi-communication-interface tape node 1900 implements wireless reader functionality that may be worn by the user. In embodiments, the wireless reader functionality is RFID based. The at least one first wireless-communication interface 1404 may implement one or more of a Bluetooth protocol, a cellular protocol, a Wi-Fi protocol, a Long Range (LoRa) protocol, a LoRaWAN protocol, a satellite communication protocol, a Zigbee protocol, an NFC protocol, an RF protocol, or some other wireless communications protocol. Wearable multi-communication-interface tape node 1900 is powered by a battery (or similar power source) and accordingly benefits from the event driven activation of its second wireless-communication interface 1408, as described above. Further, since first wireless-communication interface 1404 may use Bluetooth or BLE, this may also provide accurate locationing of operator 2004 that enables wearable multi-communication-interface tape node 1900 to detect trigger events indicative of when reader 1410 should be enabled and/or disabled.

In one example of operation, wearable multi-communication-interface tape node 1900 uses its second wireless-communication interface 1406 to read at least one wireless tag and wirelessly communicate with other tape nodes and wireless nodes, such as infrastructure tape nodes (e.g., a tape node that acts as a gateway node in a fixed location) and gateway nodes (e.g., a tape node that acts as a gateway node) of network communications environment 800. Wearable multi-communication-interface tape node 1900 may receive location data from the infrastructure tape nodes and/or gateway nodes.

Accordingly, network communications environment 800 may receive data from wearable multi-communication-interface tape node 1900 indicating RFID tag identifiers scanned by the wearable multi-communication-interface tape node and may also receive location of wearable multi-communication-interface tape node 1900 based on communication between wearable multi-communication-interface tape node 1900 and a gateway node. In certain embodiments, the infrastructure tape node may have an inlay (e.g., a wireless tag, or an RFID wireless tag), whereby reading of the infrastructure tape node's wireless tag provides a location of wearable multi-communication-interface tape node 1900 based on the location of the infrastructure tape node.

Wearable multi-communication-interface tape node 1900 may include switches and/or sensors that detect when wearable multi-communication-interface tape node 1900 is being worn and/or when wearable multi-communication-interface tape node 1900 has been removed or taken off. In certain embodiments, when wearable multi-communication-interface tape node 1900 detects that it has been removed, it deactivates itself, there by preserving battery power when not in use. In certain embodiment, wearable multi-communication-interface tape node 1900 may automatically (re) activate itself when switches and/or sensors indicate that wearable multi-communication-interface tape node 1900 is being worn.

In certain embodiments, wearable multi-communication-interface tape node 1900 may detect and track when human operator interacts with other tape nodes, gateway nodes, and other wireless nodes of network communications environment 800, FIG. 8.

In certain embodiments, wearable multi-communication-interface tape node 1900 may also operate as a gateway node (e.g., similar to one of mobile gateway 810 and stationary gateway 814 of FIG. 8) and may include multiple wireless-communication interfaces for different protocols (e.g., one or more of medium-power wireless-communication interface 672′, medium-power wireless-communication interface 672″, and high-power wireless-communication interface 682″, with reference to FIGS. 6B-6C).

### Vehicle

FIG. 20 is a schematic diagram illustrating example use of a multi-communication-interface system 2000 to provide fine locationing for a vehicle 2002 (e.g., a package car) carrying an asset 2010 having at least a wireless tag 2012 (which, in embodiments, may be RFID based). Asset 2010 may also have an attached multi-communication-interface tape node, or single communication interface tape node, as described above, however, the system 2000 enhances operation where asset 2010 has wireless tag 2012 and no tape node. Although shown as a truck, vehicle 2002 may represent any storage building, warehouse, or type of apparatus used to transport assets, including a trailer, a shipping container, a sailing vessel, a rail wagon, plane, and so on. Vehicle 2002 is used by an operator 2004 wearing wearable multi-communication-interface tape node 1900 of FIG. 19. System 200 may detect both tape node identifier (e.g., using Bluetooth/BLE communication) and wireless tag identifiers (e.g., using second wireless-communication interface 1406), and may correlate any results based thereon.

System 2000 includes a plurality of multi-communication-interface tape nodes 2006 deployed at doorways of vehicle 2002. Multi-communication-interface tape nodes 2006 may represent multi-communication-interface tape node 1402 of FIG. 14. Multi-communication-interface tape node 2006(1) is positioned at a doorway 2008 (e.g., inside and above the doorway as shown) of vehicle 2002. Antennae and/or coverage area of multi-communication-interface tape node 2006(1) is configured to be limited to doorway 2008, thereby multi-communication-interface tape node 2006(1) operates as a geofence and/or curtain to detect tape nodes and/or wireless tags (e.g., RFID tags) passing through doorway 2008. In the example of FIG. 20, vehicle 2002 also has an internal bulkhead 2014 that separates a cab area 2016 from a freight area 2018 with an internal doorway 2020. A multi-communication-interface tape node 2006(2) is positioned near doorway 2020 and its antennae and/or coverage area are configured as a geofence and/or curtain to detect tape nodes and/or wireless tags (e.g., RFID tags) passing through doorway 2020. Vehicle 2002 also has a rear doorway 2022 that provides access (e.g., loading and unloading) to freight area 2018. A multi-communication-interface tape node 2006(3) is positioned near doorway 2022 and its antennae and/or coverage area are configured as a geofence and/or curtain to detect tape nodes and/or wireless tags (e.g., RFID tags) passing through doorway 2022.

Where operator 2004 is wearing wearable multi-communication-interface tape node 1900, when operator 2004 passes through doorway 2008, multi-communication-interface tape node 2006(1) detects (e.g., using first wireless interface 1404, such as Bluetooth/BLE messaging in a specific embodiment) wearable multi-communication-interface tape node 1900 and generates a trigger event message 2023. Where operator 2004 is not wearing wearable multi-communication-interface tape node 1900 but is wearing or carrying a wireless tag (e.g., a smart badge, etc.), multi-communication-interface tape node 2006(1) detects (e.g., using second wireless interface 1406, such as RFID in a specific embodiment) the wireless tag as operator 2004 passes through doorway 2008. Similarly, multi-communication-interface tape node 2006(2) detects when operator 2004 passes through doorway 2020, and multi-communication-interface tape node 2006(3) may detect when operator 2004 passes through doorway 2022. Trigger event message 2023 may indicate a location (e.g., doorway 2008), a time and an ID (e.g., wearable multi-communication-interface tape node 1900).

In certain embodiments, one or more of multi-communication-interface tape nodes 2006(1)-(3) may also determine a direction of movement of wearable multi-communication-interface tape node 1900 (e.g., operator 2004) by using two Bluetooth curtains (e.g., Bluetooth detection cones or coverage areas), using an additional tape node as needed. In other embodiments, one or more of multi-communication-interface tape nodes 2006(1)-(3) may also determine a direction of movement of operator 2004 based on other devices worn or carried by operator 2004. For example, where operator 2004 carries mobile gateway 810 (e.g., a smartphone, tablet, etc.; see FIG. 8), one or more of multi-communication-interface tape nodes 2006(1)-(3) may detect or receive movement information of mobile gateway 810.

In certain embodiments, trigger event message 2023 may also indicate a movement direction (e.g., into, out of) when the corresponding multi-communication-interface tape node 2006 determines such information (e.g., using Bluetooth/BLE ranging etc.) Additional multi-communication-interface tape nodes may be deployed at other doors (e.g., opposite-side front door, middle side doors, etc.) to generate trigger event messages 2023 when tape nodes and/or wireless tags are detected passing through the door. Accordingly, multi-communication-interface tape nodes 2006(1)-(3) generate trigger event messages 2023 when any tape node, mobile gateway, or wireless tag passes through any doorway 2008, 2020, 2022 of vehicle 2002.

In certain embodiments, vehicle 2002 may operate like a Faraday cage (e.g., where walls of vehicle 2002 are at least partially made of metal) and prevent wireless signals from existing or entering freight area 2018. Accordingly, multi-communication-interface tape nodes 2006 within freight area 2018 may detect when operator 2004 opens a door to freight area 2018 and wireless signals from wearable multi-communication-interface tape node 1900 and/or other devices carried by operator 2004 are detectable. Cab area 2016 may operate similarly to detect when operator 2004 opens a door to enter cab area 2016.

Multi-communication-interface tape nodes 2006(4) and 2006(5) are positioned on a ceiling of freight area 2018 and have coverage areas for detecting tape nodes and/or wireless tags (e.g., RFID tags) within freight area 2018. The number and location of multi-communication-interface tape nodes 2006 within freight area 2018 may be selected to provide a required coverage and locationing resolution for assets stored within freight area 2018. For example, multi-communication-interface tape nodes 2006 may be positioned on shelves or racks within freight area 2018 to detect assets positioned on the shelves or racks. Multi-communication-interface tape nodes 2006(4) and (5) may receive a trigger event message from may not generate trigger events. As noted above, to conserve battery power, second wireless-communication interface 1406 of multi-communication-interface tape nodes 2006 are not activated until needed. Trigger event messages 2023 generated by multi-communication-interface tape node 2006(1)-(3) are used to activate second wireless-communication interface 1406 of each multi-communication-interface tape nodes 2006(4)-(5), causing each multi-communication-interface tape nodes 2006(4)-(5) to take inventory of wireless tags 2012 within freight area 2018. After a certain period, or when no changes in inventory are detected, each multi-communication-interface tape nodes 2006(4)-(5) deactivates it second wireless-communication interface 1406. Advantageously, through use of trigger event messages, battery life of multi-communication-interface tape nodes 2006 is not drained unnecessarily since multi-communication-interface tape nodes 2006 are triggered only when inventory could have changed. In the prior art, RFID readers run continuously or periodically. When run periodically, the prior art RFID reader cannot detect inventory changes during inactive periods and is therefore cannot guarantee immediate detection of inventory changes. When run continuously, the prior art RFID reader has a short battery lifespan. In certain embodiments, multi-communication-interface tape nodes 2006(4) and (5) do not include transmitters 1410. Instead, an external illuminator, similar to illuminator 1420, is included within freight area 2018 and activated in response to trigger events. Accordingly, multi-communication-interface tape nodes 2006(4) and (5) detect wireless response signals from wireless tags (similar to the response signals discussed above) within freight area 2018 that are activated by illuminator signal from the illuminator.

In an alternative embodiment, wearable multi-communication-interface tape node 1900 detects, using Bluetooth/BLE, RFID tape node 2006(2) when it passes through doorway 2020 as operator 2004 enters freight area 2018 and activates its second wireless-communication interface 1406 and/or generates trigger event message 2023. Wearable multi-communication-interface tape node 1900 may also determine when operator 2004 exits freight area 2018 by detecting, using Bluetooth/BLE, multi-communication-interface tape node 2006(2), and deactivate its second wireless-communication interface 1406.

Where an operator uses a handheld device (e.g., a mobile phone, tablet, RFID reader, etc.), multi-communication-interface tape nodes 2006 may also detect presence of the handheld device. For example, where operator 2004 does not wear wearable multi-communication-interface tape node 1900 but carries a smartphone, system 2000 may detect presence of the smartphone to generate the trigger events and/or trigger event messages discussed herein.

In one example of operation, vehicle 2002 stops and multi-communication-interface tape node 2006(2) detects wearable multi-communication-interface tape node 1900, or another device (e.g., tape node, smart badge, mobile gateway, smartphone, tablet, wireless tag, etc.) worn or carried by operator 2004, as operator 2004 enters freight area 2018 through doorway 2020 and generates trigger event message 2023 indicative of operator 2004 entry to freight area 2018. Since operator 2004 is within freight area 2018, multi-communication-interface tape nodes 2006(4) and 2006(5) do not activate their second wireless-communication interfaces 1406. However, when worn by operator 2004, wearable multi-communication-interface tape node 1900 activates its second wireless-communication interface 1406 and detects wireless tag 2012 as operator 2004 collects asset 2010 for delivery. Coverage area for second wireless-communication interface 1406 of wearable multi-communication-interface tape node 1900 is limited (e.g., between one- and three-feet radius, and/or directionally) and therefore detects only wireless tag 2012 of asset 2010 as it is handled by operator 2004. When operator 2004 does not wear wearable multi-communication-interface tape node 1900, operator 2004 may use a handheld device (e.g., a handheld RFID reader, smartphone, etc.) for detecting wireless tag 2012 as asset 2010 is collected for delivery. Multi-communication-interface tape node 2006(2) detects wearable multi-communication-interface tape node 1900, or another device worn or carried by operator 2004, again as operator 2004 leaves freight area 2018 via doorway 2020 and generated trigger event message 2023 indicative of operator 2004 exit of freight area 2018. In response to receiving trigger event message 2023, multi-communication-interface tape nodes 2006(4) and 2006(5) activate their second wireless-communication interface 1406 and take inventory of wireless tags within freight area 2018.

As operator 2004 carries asset 2010 out through doorway 2008, multi-communication-interface tape node 2006(1) detects (e.g., using Bluetooth/BLE) wearable multi-communication-interface tape node 1900, or another device worn or carried by operator 2004, exiting vehicle 2002 and generates another trigger event message 2023 indicative of operator 2004 exiting doorway 2008. Multi-communication-interface tape node 2006(1) may also activate its second wireless-communication interface 1406 in response to the event and detects wireless tag 2012. Multi-communication-interface tape node 2006(1) may send an inventory message to a mobile gateway node 2030 deployed with vehicle 2002 and/or a server 2040 (e.g., server(s) 804, FIG. 8, or other cloud entity) that may validate delivery of asset 2010 with a location of vehicle 2002 (e.g., based on a GPS location determined by mobile gateway node 2030). Advantageously, system 2000 may detect when asset 2010 is being delivered to the wrong location and may also detect when other assets/packages are being delivered in error to a current location. In certain embodiments, multi-communication-interface tape node 2006 may be configured to operate as a gateway node for network communications environment 800, FIG. 8.

Since wearable multi-communication-interface tape node 1900 detects the user holding asset 2010 (e.g., by detecting wireless tag 2012, and optionally corresponding movement of the wireless tag 2012 and the multi-communication-interface tape node 1900, and/or proximity between multi-communication-interface tape node 1900 and wireless tag 2012), system 2000 may determine when asset 2010 is removed from freight area 2018 by operator 2004, thereby distinguishing when operator 2004 only moves asset 2010 within freight area 2018. Accordingly, by tracking assets entering and exiting freight area 2018, system 2000 tracks changes in asset inventory of freight area 2018.

Trigger events may be further qualified by system 2000. For example, gateway node 2030 may inhibit trigger events when vehicle 2002 is moving (e.g., detected using GPS or other locationing techniques), since inventory is not expected to change while vehicle 2002 is in motion. In certain embodiments, starting and stopping of vehicle 2002 may cause trigger events. If they exit cab and re-enter cab without opening bulkhead or cargo door, system can determine that the driver did not add assets (such as packages) to the truck. Gateway node 2030 may include intelligence to determine when wireless tag inventory is needed. For example, when operator 2004 exits and re-enters cab area 2016 but does enter freight area 2018 (either through doorway 2020 or doorway 2022), system 2000 may determine that operator 2004 did not pick-up assets/packages to add to the inventory of vehicle 2002, and therefore wireless tag inventory detection is not required.

Continuing with this example scenario, as operator 2004 returns to vehicle 2002, multi-communication-interface tape node 2006(1) detects wearable multi-communication-interface tape node 1900 entering through doorway 2008, sends trigger event message 2023, and activates its second wireless-communication interface 1406 (and optionally the second wireless-communication interface 1406 of one or more of other multi-communication-interface tape nodes 2006 associated with vehicle 2002. If operator 2004 has picked up any assets/packages from the current location, multi-communication-interface tape node 2006(1) reads any corresponding wireless tags as they enter vehicle 2002. When operator 2004 enters freight area 2018, with or without the picked-up assets/packages, multi-communication-interface tape node 2006(2) detects wearable RFID tape node 1900 entering freight area 2018 through doorway 2020 and sends trigger event message 2023 indicative of operator 2004 entering freight area 2018. In certain embodiment, in response to trigger event message 2023, each of multi-communication-interface tape node 2006(4) and 2006(5) activate their second wireless-communication interface 1406 to take inventory of wireless tags within freight area 2018, deactivating their RFID readers when the inventory taking is complete. In one example, when operator enters through doorway 2008, multi-communication-interface tape nodes 2006 are activated to take inventory of wireless tags 2012 to determine whether operator 2004 is bringing an asset onto vehicle 2002 and to determine whether any asset went missing (e.g., fell off) while operator 2004 was gone. Since the inventory is determined in real-time based on events occurring at vehicle 2002, system 2000 may send operator 2004 a timely notification (e.g., via phone/tablet/wearable device) of any unexpected inventory violations (e.g., a package being carried should not be loaded onto vehicle 2002). In another example, when operator 2004 exits vehicle 2002, system 2000 may take inventory to detect when an asset being removed from vehicle 2002 is a violation and send operator 2004 a timely notification to verify packages being carried.

Similarly, by comparing a first inventory of assets taken when operator 2004 enters vehicle 2002 with a second inventory taken when operator 2004 leaves vehicle 2002, system 2000 may notify operator 2004 when they exist with the same asset (e.g., did not leave the asset on vehicle 2002).

In certain embodiments, where vehicle 2002 includes an alarm 2050 (e.g., visual and/or auditory alarm such as a siren, flashing lights, and/or a speaker), system 220 may activate alarm 2050 when a rule violation is detected. In certain embodiments, alarm 2050 is activated to notifying operator 2004 when detected inventory is determined to be incorrect. In another example, system 2000 may activate alarm 2050 when asset 2010 is compromised.

Multi-communication-interface tape node 2006(2) may then detect operator 2004 exiting freight area 2018, generating trigger event message 2023 indicative of operator 2004 exiting through doorway 2020. In certain embodiment, in response to trigger event message 2023, each of multi-communication-interface tape nodes 2006(4) and 2006(5) activate their second wireless-communication interfaces 1406 to take inventory of wireless tags within freight area 2018, deactivating their second wireless-communication interfaces 1406 when the inventory taking is complete. Advantageously, multi-communication-interface tape nodes 2006 operate their second wireless-communication interfaces 1406 only as needed, thereby conserving battery power.

Gateway node 2030 and/or server 2040 may correlate identified multi-communication-interface tape nodes (e.g., Bluetooth identifiers of tape nodes) with wireless tag identifiers (e.g., RFID IDs) of wireless tags associated with assets (e.g., asset 2010) detected by multi-communication-interface tape nodes 2006(4) and 2006(5) to validate inventory within freight area 2018. Further, gateway node 2030 and/or server 2040 may correlate identified multi-communication-interface tape nodes (e.g., Bluetooth identifiers of tape nodes) with wireless tag identifiers (e.g., RFID IDs) of wireless tags inlayed with other tape nodes. Gateway node 2030 and/or server 2040 may determine that a multi-communication-interface tape node has failed (e.g., battery drained) when a wireless tag identifier is detected but a corresponding Bluetooth identifier (or another non-Bluetooth based ID captured using first wireless-communication interface 1404) was not detected. In certain embodiments, gateway node 2030 and/or multi-communication-interface tape nodes 2006(4) and (5) receive a manifest of wireless tag identifiers that are expected to be read. For example, the manifest may define, for each multi-communication-interface tape node 2006(4) and (5), whether wireless tags are expected be in its coverage area. When no wireless tags are expected to be in the coverage area of any of multi-communication-interface tape nodes 2006(4) and (5), that multi-communication-interface tape node may not activate its second wireless-communication interface 1406, thereby conserving battery power and extending its life.

Wireless tag identifier inventory may improve reliability of asset tracking over use of tape node Bluetooth identifier tracking alone, particularly where wireless tag identifiers and Bluetooth identifiers (or another non-Bluetooth based ID captured using first wireless-communication interface 1404) are correlated. Further, use of wireless tag tracking may also increase security where a ping rate of second wireless-communication interfaces 1406 is increased in response to certain detected events.

In certain embodiments, multi-communication-interface tape nodes 2006(4) and (5) may deactivate their second wireless-communication interfaces 1406 when they also detect a Bluetooth signal (or other non-Bluetooth based signal captured using first wireless-communication interface 1404) of wearable multi-communication-interface tape node 1900, since this indicated that operator 2004 is within freight area 2018 and inventory may change. Accordingly, multi-communication-interface tape nodes 2006(4) and (5) may wait until operator 2004 leaves freight area 2018 before activating their second wireless-communication interfaces 1406 to take inventory of wireless tags within freight area 2018.

In certain embodiments, other sensors may be used to generate trigger events. For example, the trigger event may be generated in response to one or more of: a signal from an infrared sensor, a vibration sensor, a light sensor, a capacitive sensor, or a signal from some other type of sensor.

Trigger events, detected by the mesh network of multi-communication-interface tape nodes 2006 may also be used to activate other detectors and/or devices. For example, trigger events may also be used to activate barcode readers, cameras, and so on.

System 2000 may use event-based logic, as described above, to selectively activate RFID readers 1406 and other wireless communication devices for detection and fine locationing of assets 2010. Wearable multi-communication-interface tape node 1900 provides an RFID detection solution when RFID infrastructure does not already exist. Advantageously, multi-communication-interface tape nodes 2006 are battery powered and easily deployed without the need for wiring and because RFID tag detection is event driven, using intelligent logic, RFID readers are activated when change in inventory is expected, and not activated to detect change.

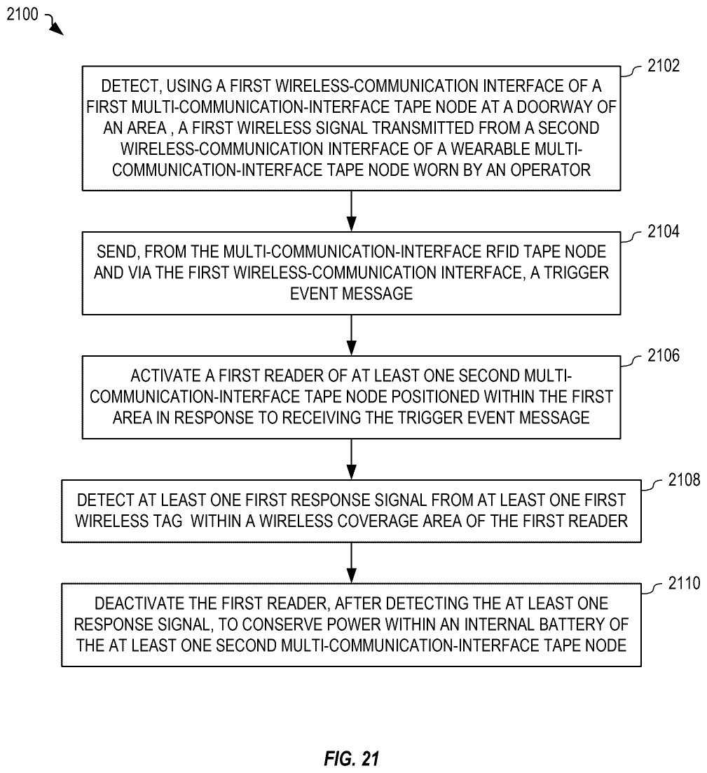

FIG. 21 is a flowchart illustrating one example method 2100 for fine locationing using a multi-communication-interface system (e.g., system 2000 of FIG. 20). Method 2100 is implemented by one or more of multi-communication-interface tape nodes 2006, gateway node 2030, and server 2040 of FIG. 20 for example.

In block 2102, method 2100 detects, using a first wireless-communication interface of a first multi-communication-interface tape node at a first doorway of a first area, a first wireless signal transmitted from a second wireless-communication interface of a wearable multi-communication-interface tape node worn by an operator. In one example of block 2102, multi-communication-interface tape node 2006(2) detects a Bluetooth wireless signal (or other non-Bluetooth based signal captured using first wireless-communication interface 1404) transmitted by wearable multi-communication-interface tape node 1900 worn by operator 2004 as operator 2004 moves into freight area 2018 via doorway 2020. In block 2104, method 2100 sends, from the first multi-communication-interface tape node and via the first wireless-communication interface, a trigger event message. In one example of block 2104, RFID tape node 2006(2) transmits trigger event message 2023 using its first wireless-communication interface 1404 (e.g., via Bluetooth).

In block 2106, method 2100 activates a second wireless-communication interface of at least one second multi-communication-interface tape node positioned within the first area in response to receiving the trigger event message. In one example of block 2106, multi-communication-interface tape node 2006(4) receives trigger event message 2023 using Bluetooth via its first wireless-communication interface 1404 (or other non-Bluetooth based signals captured using first wireless-communication interface 1404) and activates its second wireless-communication interface 1406. In block 2108, method 2100 detects at least one first wireless response signal (which may be RFID based in at least one embodiment) from at least one first wireless tag within a wireless coverage area of the second wireless-communication interface. In one example of block 2108, second wireless-communication interface 1406 of multi-communication-interface tape 2006(4) detects a wireless response signal from wireless tag 2012 positioned within a wireless coverage area of the second wireless-communication interface 1406.

In block 2110, method 2100 deactivates the second wireless-communication interface, after detecting the at least one wireless response signal, to conserve power within an internal battery of the second multi-communication-interface tape n. In one example of block 2110, multi-communication-interface tape 2006(4) deactivates its second wireless-communication interface 1406 after detecting the wireless response signal from wireless tag 2012 to conserver power within energy source 1408. In certain embodiments, multi-communication-interface tape 2006 deactivates its second wireless-communication interface 1406 after a predetermined period. In other embodiments, multi-communication-interface tape 2006 deactivates its second wireless-communication interface 1406 when the determined inventory is unchanged (e.g., when an inventory of assets 2010 detected within vehicle 2002 is the same as a previous inventory, indicating that no assets were added or removed after operator 2004 enters or exits. In other embodiments, multi-communication-interface tape 2006 deactivates its second wireless-communication interface 1406 when operator 2004 (e.g., wearable multi-communication-interface tape node 1900) has exited vehicle 2002 and/or when system 2000 determines that doors of vehicle 2002 have been closed for a predefined period.

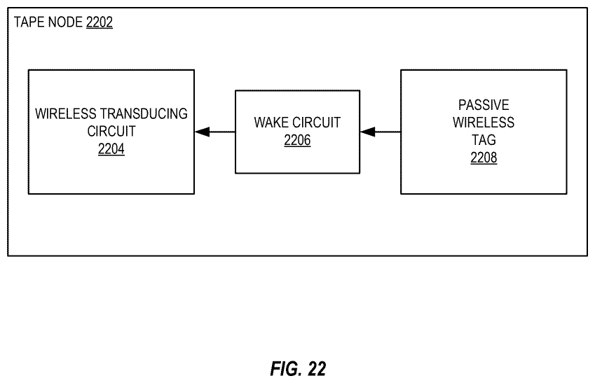

FIG. 22 is a block diagram showing one example tagged tape node 2202 with a wake circuit 2206 operated by an embedded wireless tag 2208. Wake circuit 2206 may be similar to wake circuit 775 of FIG. 7A that delivers power from energy source 776 to tracking circuit 778. However, wake circuit 2206 is triggered by passive wireless tag 2208.

Tagged tape node 2202 may be similar to any of segments 640, 670, and 680 of FIGS. 6A-6C, server(s) 804 and gateways 810, 812, and 814 of FIG. 8 and wireless transducing circuit 2204 may represents wireless transducing circuit 410 of FIG. 4. Wake circuit 2206 activates wireless transducing circuit 2204 and may provide an input to trigger wireless transducing circuit 2204 (e.g., an interrupt line to awaken a processor of wireless transducing circuit 2204) or connect power from a power source (e.g., a battery) to activate wireless transducing circuit 2204. Passive wireless tag 2208 may represent a passive RFID tag that provides an electrical input to wake circuit 2206.

In this scenario, wireless transducing circuit 2204 may deactivate (e.g., transition to a low power or inactive state) when a particular function is completed, thereby conserving its battery power. Passive wireless tag 2208 is inactive until awakened by an interrogation signal (e.g., an RFID interrogation signal), when awakened by the interrogation signal, passive wireless tag 2208 triggers wake circuit 2206, which in turn activates wireless transducing circuit 2204.

Wireless transducing circuit 2204 may only deactivate itself in certain situations and/or locations. For example, where tape node 2202 is attached to an asset for tracking purposes, wireless transducing circuit 2204 may determine that it (and the asset) is located in a storage area that includes a wireless tag reader (e.g., an external RFID reader that may be line powered) that periodically interrogates wireless tags in the storage area. Advantageously, wireless transducing circuit 2204 may deactivate to conserver its battery power until it is reawakened by the reader interrogating its passive wireless tag 2208, thereby allowing wireless transducing circuit 2204 to enable tracking and communication (e.g., Bluetooth). For example, where the storage area has controlled access (e.g., door sensors), the door opening triggers the wireless tag reader to take inventory of wireless tags in the storage area. Accordingly, in determining that it is located in the storage area, wireless transducing circuit 2204 deactivates itself and is only reactivated when the wireless tag reader is activated by the door opening.

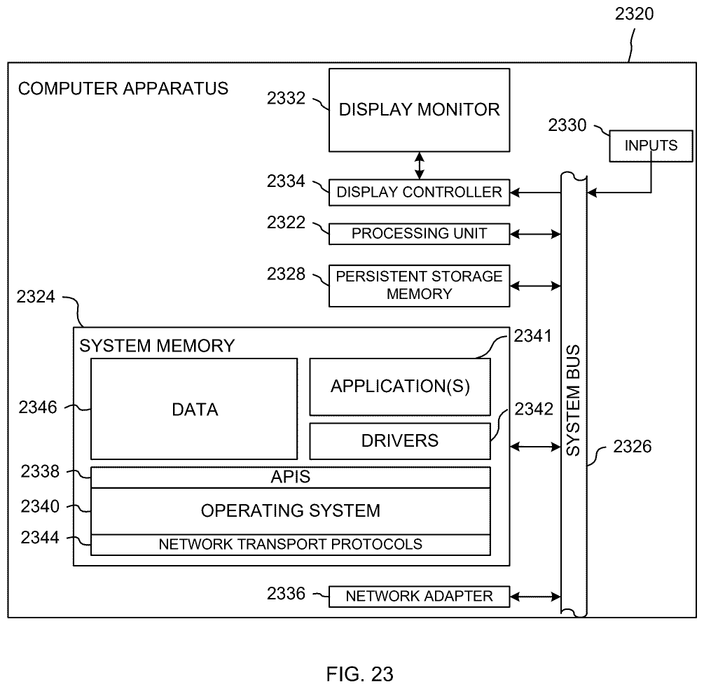

FIG. 23 shows an example embodiment of computer apparatus 2320 that, either alone or in combination with one or more other computing apparatus, is operable to implement one or more of the computer systems described in this specification. For example, computer apparatus 2320 may represent any of: computing apparatus of any of segments 113 of FIGS. 1 and 2, wireless transducing circuit 410 of FIG. 4, segments 640, 670, and 680 of FIGS. 6A-6C and any of the tape nodes derived therefrom, server(s) 804 and gateways 810, 812, and 814 of FIG. 8, server(s) 904 of FIG. 9, and any other computer implemented devices disclosed herein. The computer apparatus 2320 includes a processing unit 2322, a system memory 2324, and a system bus 2326 that couples the processing unit 2322 to the various components of the computer apparatus 2320. The processing unit 2322 may include one or more data processors, each of which may be in the form of any one of various commercially available computer processors. The system memory 2324 includes one or more computer-readable media that typically are associated with a software application addressing space that defines the addresses that are available to software applications. The system memory 2324 may include a read only memory (ROM) that stores a basic input/output system (BIOS) that contains start-up routines for the computer apparatus 2320, and a random-access memory (RAM). The system bus 2326 may be a memory bus, a peripheral bus, or a local bus, and may be compatible with any of a variety of bus protocols, including PCI, VESA, Microchannel, ISA, and EISA. The computer apparatus 2320 also includes a persistent storage memory 2328 (e.g., a hard drive, a floppy drive, a CD ROM drive, magnetic tape drives, flash memory devices, and digital video disks) that is connected to the system bus 2326 and contains one or more computer-readable media disks that provide non-volatile or persistent storage for data, data structures and computer-executable instructions.

A user may interact (e.g., input commands or data) with the computer apparatus 2320 using one or more input devices 2330 (e.g., one or more keyboards, computer mice, microphones, cameras, joysticks, physical motion sensors, and touch pads). Information may be presented through a graphical user interface (GUI) that is presented to the user on a display monitor 2332, which is controlled by a display controller 2334. The computer apparatus 2320 also may include other input/output hardware (e.g., peripheral output devices, such as speakers and a printer). The computer apparatus 2320 connects to other network nodes through a network adapter 2336 (also referred to as a “network interface card” or NIC).

A number of program modules may be stored in the system memory 2324, including application programming interfaces 2338 (APIs), an operating system (OS) 2340 (e.g., the Windows® operating system available from Microsoft Corporation of Redmond, Washington U.S.A.), software applications 2341 including one or more software applications programming the computer apparatus 2320 to perform one or more of the steps, tasks, operations, or processes of the positioning and/or tracking systems described herein, drivers 2342 (e.g., a GUI driver), network transport protocols 2344, and data 2346 (e.g., input data, output data, program data, a registry, and configuration settings).

### Detecting and Tracking Assets in a Vehicle

Embodiments of tape nodes of the adhesive tape platform may include RFID tags or RFID components integrated into the tape node. Tape nodes with integrated RFID components and the manufacturing of the tape nodes thereof is discussed in further detail in U.S. patent application Ser. No. 16/953,238, filed Nov. 19, 2020, U.S. patent application Ser. No. 16/839,048, filed on Apr. 2, 2020, and U.S. patent application Ser. No. 17/067,608, filed on Oct. 9, 2020, all of which are incorporated by reference herein in their entirety.

The tape nodes with RFID capabilities described above (referred to herein as “RFID tape nodes”) may be attached to, stored with, stored alongside, and/or otherwise coupled to assets that are tracked in the tracking system 700 of FIG. 7. The RFID tape nodes may be positioned at known locations and may communicate with an RFID reader system(s) in environments with a known location for identifying the asset and determining the asset's location. The RFID reader system(s) are associated with the tracking system 700 and communicate with server(s) of the tracking system 700 to update a database of the tracking system 700 on the location of the assets.

The “RFID tape nodes” may include varying functionality depending on the application. In one example of “RFID tape node”, the RFID tape node is an “RFID reader node” that may read passive or active RFID tags (or other RFID tape nodes) attached to assets. The RFID reader node may act as an infrastructure node, in that it is permanently (or semi-permanently) placed in a set location within the environment. In embodiments, the RFID reader node may be a “RFID illumination node” in which it only operates to illuminate a given area with an RFID illumination signal (also referred to as an interrogation signal herein), but the response thereto (e.g., RFID response signal) is captured by another device and sent to the RFID illumination node via a non-RFID-based communication channel, or sent to another external device. The RFID reader node embodiments of the RFID tape nodes may receive RFID response signal information about one or more RFID tags (or RFID tape nodes) attached to the assets and analyze said RFID response signal information according to one or more mission objectives. In one example, the one or more mission objectives includes transmitting the RFID response signal information to another device, such as a gateway over Bluetooth® or other wireless channel (Wi-Fi, LoRa, Cellular, etc.).

Thus, the term “illumination” or “illumination signal” indicates a signal, such as an RFID-based signal, generated by a device, such as the “RFID illumination node” or another RFID antenna (e.g., antennas 2420, 2430, 2440 or slot antennas 3006, 3110 discussed below) that causes another RFID device (e.g., RFID tags 2490, and/or reference RFID readers 3302 discussed below) to generate a response signal to the illumination. The illumination or illumination signal may be a generically broadcast signal that triggers any responding tags to respond, or it may be encoded such that only one or more select responding tags are triggered based on the encoding. The features associated with illuminator 2420 and illumination signal 2421 discussed in U.S. Patent Publication No. 2023/0024103, entitled “Multi-communication-interface system for fine locationing”, and filed Sep. 12, 2022, may apply to the RFID illumination signal, RFID interrogation signals, and devices that generate said RFID illumination signal or RFID interrogation signals herein. As such, U.S. Patent Publication No. 2023/0024103 is incorporated by reference herein to the extent that the illumination and response discussed therein applies to illumination and interrogation signals discussed herein.

In another example of “RFID tape node”, the RFID tape node is a “tape” or “flexible” form factor that adheres to an asset/package. The form factor may be a flexible or semi-flexible device. The RFID tape node may include a QR code for associating the RFID tape node with a given asset, wherein said association is stored in memory of another device (e.g., another RFID tape node, an RFID reader device, or an external server such as server 704 discussed above with respect to FIG. 7. The RFID tape node may be reprogrammable with read and write functionality for additional features, including changing the data the RFID tape node transmits to an RFID reader or other external device.

In another example of “RFID tape node”, the RFID tape node has an RFID tag inlay that is passive or active. The RFID tag inlay operates to respond to RFID interrogation signals and transmit an RFID response signal which is read by another device, which may be the device generating the RFID interrogation signal, or another device such as another RFID reader and/or another RFID tape node.

The above examples of RFID tape node are non-limiting. Any of the above-discussed features of “nodes” (such as features discussed with respect to “tape nodes”, “nodes”, “tape platforms”, or the like discussed above with respect to FIGS. 1-13) may be implemented in one or more RFID tape nodes, and any combination of types of RFID tape nodes may be implemented for a given environment (e.g., within a given vehicle as discussed below, or within a given monitoring area such as distribution center or warehouse.

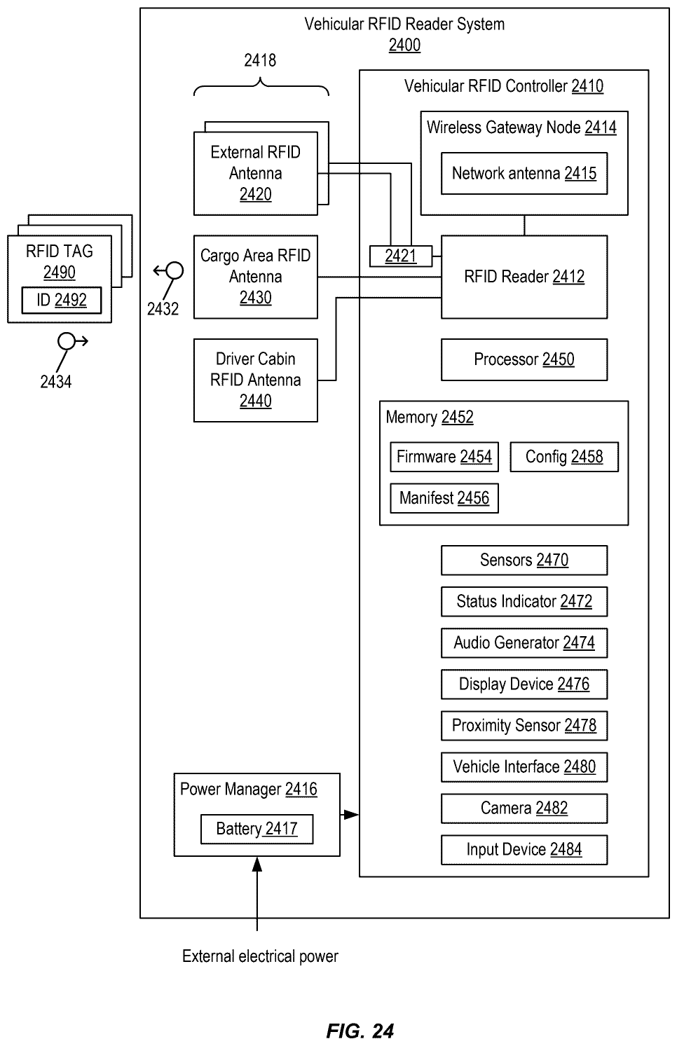

FIG. 24 is a block diagram illustrating one example RFID reader system 2400 configured for use in a vehicle, in embodiments. RFID reader system 2400 includes an RFID reader 2412 (which may be an RFID reader tape node, or a non-tape node embodiment) coupled to an RFID antenna array 2418 and a wireless gateway node 2414 (see also mobile gateway 812 in FIG. 8) that includes at least one network antenna 2415 and provides wireless communication with tracking system 800 and/or components thereof. Network antenna 2415 represents one or more antennas configured for communication using protocols selected from the group including LoRa, BLE, Wi-Fi, and satellite communication.

In the example of FIG. 24, RFID antenna array 2418 includes at least one external RFID antenna 2420, at least one cargo area RFID antenna 2430, and at least one driver cabin RFID antenna 2440. However, RFID antenna array 2418 may have more or fewer RFID antennas 2430 without departing from the scope hereof. For example, one or both of external RFID antenna 2420 and driver cabin RFID antenna 2440 may be omitted in certain embodiments. The RFID antennas 2430 are shown with a read area (“Field of View”) as indicated by the dashed lines extending downward from the RFID antennas 2430. The read area is not constrained to the angle shown, and may be manipulated to configure the beam shape to fit the desired monitored area (e.g., within the cargo area 2504). Similar read areas may be used for other RFID antennas herein (e.g., external RFID antennas 2420 and/or cabin RFID antennas 2440), and the read areas may be directed at other directions other than downward depending on position and intended monitoring area of the given RFID antenna.

RFID reader 2412 and wireless gateway node 2414 may be incorporated into the same physical housing, referred to herein as an RFID controller 2410. However, in other embodiments, one or both of RFID reader 2412 and wireless gateway node 2414 are external to RFID controller 2410. RFID controller 2410 may also implement a computer (e.g., a digital processor 2450 with memory 2452 storing firmware 2454 having machine readable instructions executable by processor 2450 to implement functionality of RFID reader system 2400) and/or other devices and controls RFID antennas 2420, 2430, 2440, and RFID reader 2412 to detect and read data from RFID return signals received via the RFID antennas. Processor 2450 and memory 2452 may represent parts of RFID reader 2412 or wireless gateway node 2414 without departing from the scope hereof. The Processor 2450 and memory 2452 may be the same computing elements of the RFID reader 2412, in that they directly control the RFID reader 2412 and also implement data analysis on data transmitted to or from the RFID reader 2412 and/or other components within the controller 2410.

In certain embodiments, RFID antennas 2420, 2430, and 2440 each operate to both transmit an RFID interrogation signal 2432 (e.g., an electromagnetic interrogation pulse) and receive RFID response signals 2434 from RFID tags 2490 within range. In other embodiments, one RFID antenna 2430 operates to transmit the RFID interrogation signal 2432, and other RFID antennas 2420, 2430, and 2440 operate to receive any RFID response signals 2434.

The RFID antenna(s) 2430 collectively have field of view that includes locations where assets enter and/or are loaded into a cargo area of a vehicle for example. The type and configuration of the RFID antenna 2430 may vary based on the number of RFID antennas 2430 included in the system. For example, in one embodiment where a single RFID antenna 2430 is used, a patch antenna may be implemented to increase the spatial coverage of the FOV of the antenna to allow for more coverage in the cargo area. Non-patch RFID antennas may be implemented in multi-RFID antenna 2430 embodiments, or where a single RFID antenna 2430 is monitoring a smaller cargo area and a patch antenna is not needed to provide adequate spatial coverage. Multi-RFID antenna 2430 embodiments may include combination of patch and non-patch antennas.

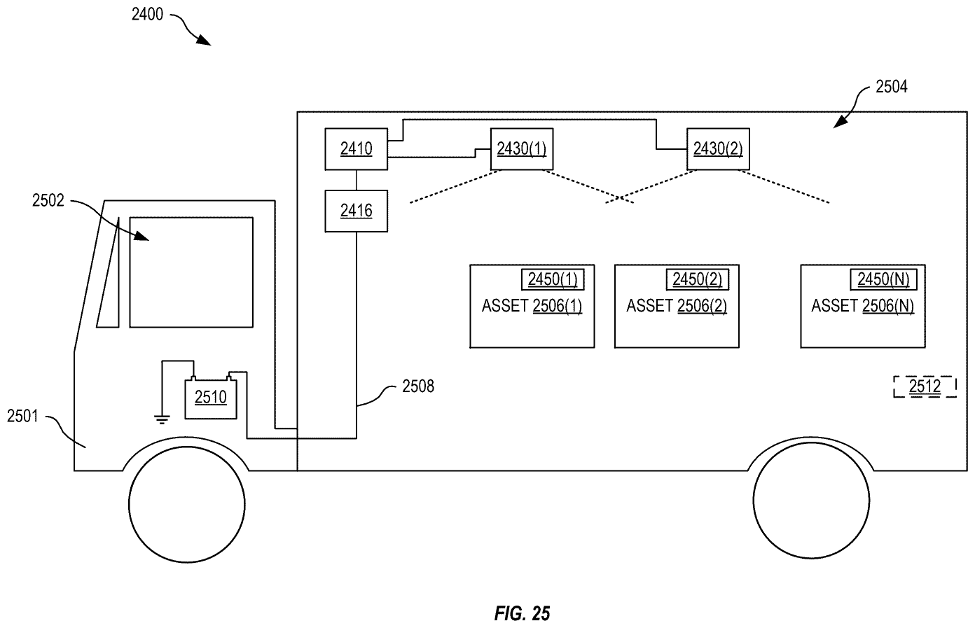

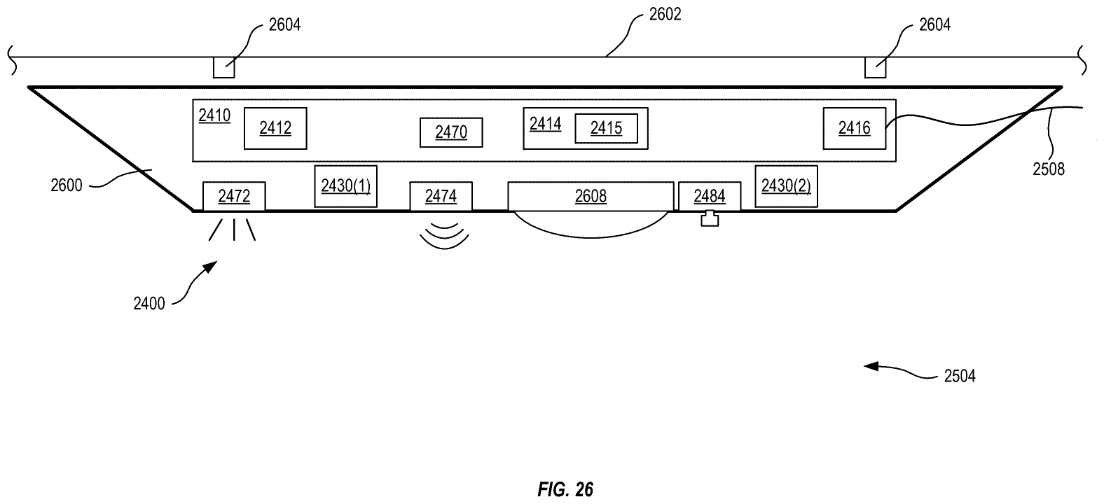

RFID reader system 2400 may also include a power manager 2416 that provides electrical power to RFID controller 2410. In certain embodiments, power manager 2416 includes a monitoring capability and an isolation circuit to connect/disconnect power to/from RFID reader system 2400 when anomalies (e.g., overvoltage, undervoltage, overcurrent, undercurrent, over temperature, etc.) are detected. Power manager 2416 may also include conditioning electronics that condition electrical power received from a vehicle (see vehicle 2501, FIGS. 25 and 26) in which RFID reader system 2400 is installed to power components of RFID reader system 2400.

In certain embodiments, power manager 2416 includes electrical storage, such as one or more rechargeable batteries 2417, that may be recharged from the received external electrical power and used to provide power to other components of RFID reader system 2400. The received external electrical power may be from a component of the vehicle (e.g., alternator, battery), or another external power source such as a solar panel, etc. Accordingly, power manager 2416 may use one or more rechargeable batteries 2417 to provide power to RFID reader system 2400 when vehicle power is unavailable. In certain embodiments, one or more rechargeable batteries 2417 may be located in RFID controller 2410 and are charged using power received from power manager 2416. Power manager 2416 may include one or more diodes to prevent inadvertent discharge of one or more rechargeable batteries 2417. Power manager 2416 may be included within the same housing as RFID controller 2410, or in a separate housing therefrom, without departing from the scope hereof.

In one example of operation, RFID controller 2410 controls RFID reader 2412 to detect and read any RFID tags 2490 withing wireless range of RFID antennas 2420, 2430, and 2440. RFID tags 2490 may be passive or active RFID tags and/or RFID tape nodes.

RFID controller 2410 may also include one or more sensors 2470 that may be read to determine environmental characteristics of RFID reader system 2400. For example, sensors 2470 may include at least one temperature sensor, a UV sensor, at least one accelerometer, and so on, that are used to monitor conditions within a vehicle in which RFID reader system 2400 is installed.

RFID controller 2410 may also include at least one status indicator 2472 and/or at least one audio generator 2474. Status indicator 2472 and/or audio generator 2474 may be used to indicate an operating status or RFID controller 2410 and/or to indicate when an anomalous situation has been detected, described in further detail below.

RFID controller 2410 may also include at least one display device 2476 for providing textual and/or graphical outputs. Display device 2476 is for example one of an LCD display, an E-ink display, and an HMI display capable of outputting alphanumeric and/or graphical information.

RFID controller 2410 may also include a proximity sensor 2478 that detects proximity of a person to RFID controller 2410. For example, proximity sensor 2478 may be one of an infra-red movement detector, a camera, light sensor and so on.

RFID controller 2410 may also include a vehicle interface 2480 that communicates with components of vehicle 2501. For example, vehicle interface 2480 may be an OBD port that facilitates communication with computers of vehicle 2501 to receive global navigation satellite system (GNSS) location information (e.g., GPS coordinates) from a vehicle navigation unit.

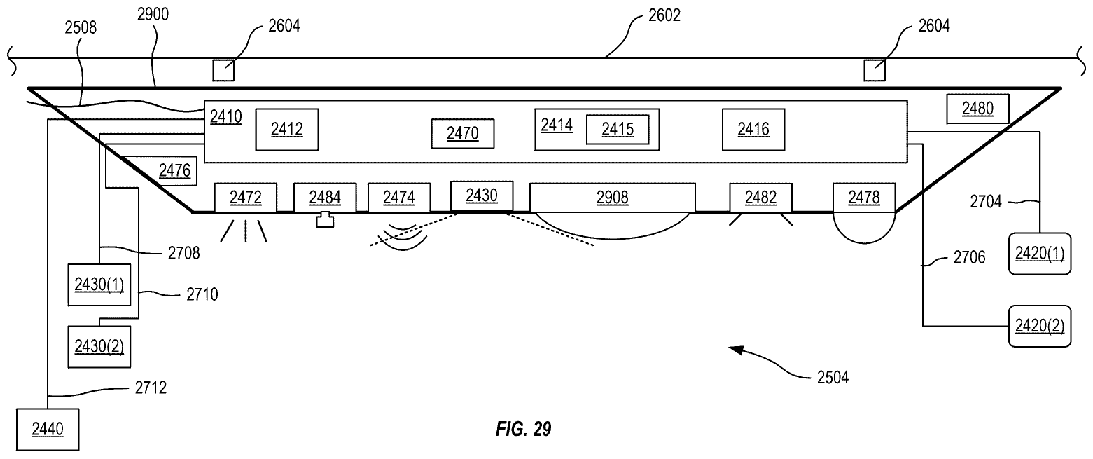

RFID controller 2410 may also include at least one camera 2482 for capturing images of activity detected by one or both of RFID reader 2412 and proximity sensor 2478. The at least one camera 2482 may have a different field of view other than downward as shown in FIG. 29, such as forward, or rearward towards the entrance to cargo area 2504. RFID controller 2410 may store captured images for a predetermined period of time and allow retrieval of images for detected events.

RFID controller 2410 may also include an input device 2484 that allows an operator and/or an installation technician to provide inputs to RFID controller 2410. Input device 2484 may include a button, or other touch screen control. Input device 2484 may additionally or alternatively include a microphone for inputting audio, such as for enabling one or two-way communication between the user within the cargo area and another device. In embodiments, display device 2476 and input device 2484 may act as a user interface for RFID controller 2410.

Advantageously, where assets loaded into a vehicle are equipped with an RFID tape node (e.g., adhered to the asset or stored inside a portion of the asset or asset's container, such as a box). RFID reader system 2400 configured with the vehicle may then: capture movement of assets into the vehicle from rear door; capture movement of assets from a cargo area of the vehicle to a driver's cabin of the vehicle, and vice versa; capture real time inventory of the vehicle by detecting incremental changes to the inventory; and capture movement of packages out of the driver's cabin through a front door of the vehicle.

Installation within Vehicle

FIG. 25 is a schematic diagram illustrating example RFID reader system 2400 installed within a vehicle 2501, in embodiments. Vehicle 2501 is for example a delivery van, a truck, a package car, cargo van, or some other vehicle for storing and transporting assets 2506. In other embodiments, the vehicle 2501 is a different type of vehicle, such as a passenger vehicle, an airplane, a boat, a helicopter, or some other vehicle which can store and transport assets and people. As shown, vehicle 2501 includes a driver cabin 2502 where the driver of vehicle 2501 sits to drive vehicle 2501 and a cargo area 2504 where assets 2506 or other objects are loaded for transportation by vehicle 2501. As shown, cargo area 2504 is separate from driver cabin 2502; however, in other vehicles, driver cabin 2502 connects with cargo area 2504 via a door, window, or opening that allows assets 2506, objects or people to pass between driver cabin 2502 and cargo area 2504 directly.

In this embodiment, vehicle 2501 is fitted with RFID reader system 2400 that includes RFID controller 2410, cargo area RFID antennas 2430(1) and 2430(2) positioned within cargo area 2504, and power manager 2416. That is, external RFID antennas 2420 and driver cabin RFID antenna 2440 are omitted in this embodiment. Although shown with two cargo area RFID antennas 2430, RFID reader system 2400 may have more or fewer cargo area RFID antennas 2430 without departing from the scope hereof. For example, RFID reader system 2400 may include a single RFID antenna 2430 positioned near the center of the ceiling of the cargo area of vehicle 2501 that operates to both transmit an RFID interrogation signal 2432 and receive any RFID response signal(s) 2434. In another example where RFID reader system 2400 includes two or more cargo RFID antennas 2430, one cargo RFID antenna 2430(1) may operate to transmit the RFID interrogation signal 2432 and the other cargo RFID antennas 2430 may operate to receive any RFID response signal(s) 2434. In yet other embodiments, an external RFID device generates the RFID interrogation signal 2432 and each cargo RFID antenna 2430 operates to receive any RFID response signals 2434.

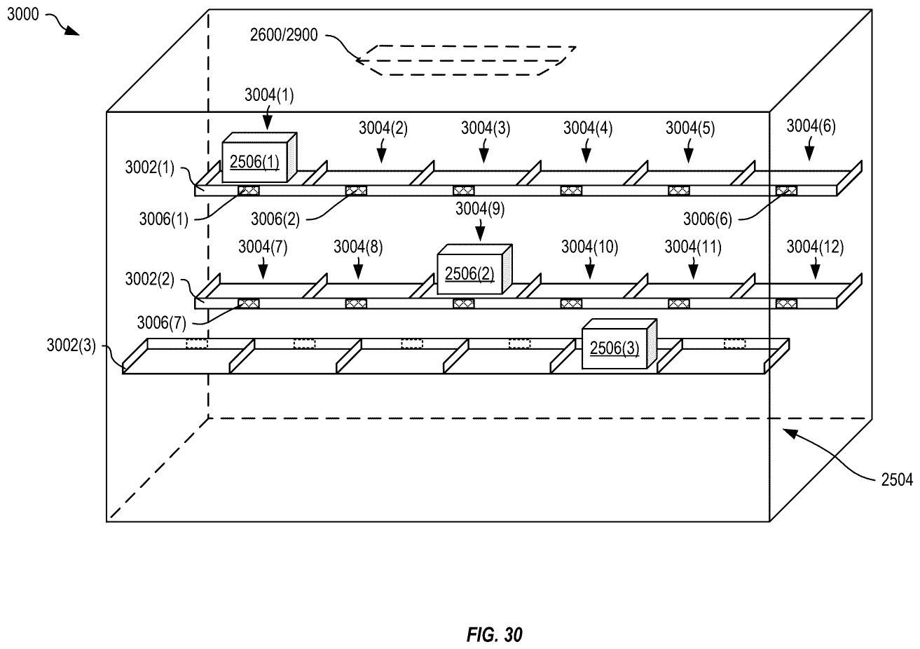

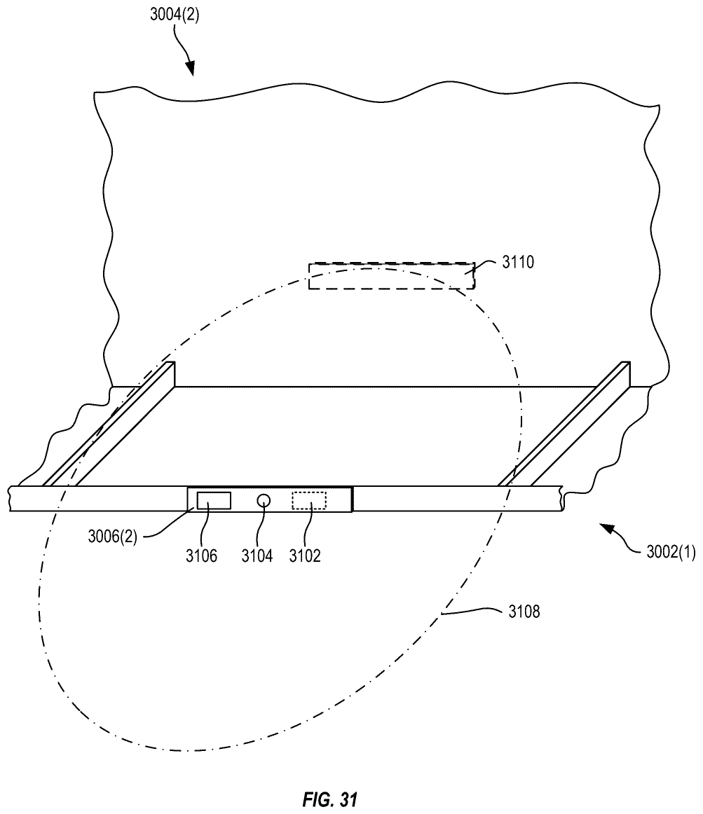

The RFID antenna 2430 collectively have field of view that spans the locations where packages enter and/or are loaded into cargo area 2504 of vehicle 2501. In embodiments, the RFID antenna 2430 are controlled such that they do not detect RFID signals generated from outside of the cargo area (e.g., via beam steering, or sensitivity control) to provide granularity in the detected signals by the RFID antennas 2430. In some embodiments, the RFID controller may detect an RFID response signal 2434 from an RFID tag 2490 at an RFID antenna (e.g., either at the RFID controller 2410 or at another device such as another RFID tag 2490, or slot antenna discussed herein, or other gateway capable of detecting said RFID response signal), but the detecting device will not register an RFID detection event or track location within a specified zone if the received signal strength is not above a threshold value. Settings and locations of the RFID antennas 2430 may be implemented to increase the granularity of the detection area, such as by putting antennas associated with slots of an asset rack as discussed with respect to FIGS. 30 and 31, below. The type and configuration of the RFID antenna 2430 may vary based on the number of RFID antennas 2430 included in system 2400. For example, in one embodiment where a single RFID antenna 2430 is used, a patch (or otherwise planar) antenna may be implemented to increase the spatial coverage of the FOV of the antenna to allow for more coverage in the cargo area. Non-patch RFID antennas may be implemented in multi-RFID antenna 2430 embodiments, or where a single RFID antenna 2430 is monitoring a smaller cargo area and a patch antenna is not needed to provide adequate spatial coverage. Multi-RFID antenna 2430 embodiments may include combination of patch and non-patch antennas.

Although shown separately and within cargo area 2504, RFID controller 2410 and power manager 2416 may be combined into a single device that may be within cargo area 2504 or positioned elsewhere on vehicle 2501. Power manager 2416 is shown receiving electrical power from a battery 2510 of vehicle 2501 via a power cable 2508. Power cable 2508 may connect to other power sources (e.g., a fuse box, a power socket, light socket, solar panel, etc.) of, or attached to, vehicle 2501 without departing from the scope hereof.

In one example of operation, RFID controller 2410 controls RFID reader 2412 to detect RFID tags 2490 within cargo area 2504 using cargo area RFID antennas 2430(1) and 2430(2). RFID reader system 2400 may determine which RFID tags 2490 and corresponding assets 2506 are added to, or removed from, cargo area 2504 or cabin 2502. RFID controller 2410 and/or RFID reader 2412 may communicate detected RFID tags 2490, or changes to detected RFID tags 2490, to wireless gateway node 2414, which may relay the information to tracking system 800 of FIG. 8, or components thereof.

The assets 2506 may be packages, cargo, or other tangible assets, in an embodiment. In another embodiment, the asset 2506 is a person, such as a driver, loader, or unloader of the vehicle 2501, wherein the person is wearing, holding, or otherwise associated with one or more of the RFID tags 2490 in the form of a wearable, necklace, bracelet, smart device (e.g., smartphone), ticket, etc. Thus, it should be appreciated that the vehicle 2501 need not be a cargo vehicle as shown, but may also be a passenger transport vehicle (such as a bus, train, plane, rideshare vehicle, etc.), where the RFID tag 2490 is associated with a passenger who is utilizing the passenger transport vehicle. The “cargo area 2504” in the passenger transport vehicle need not be a component of the vehicle itself, but may also be an intermediate loading device, such as a jet bridge in an airport gate, etc., wherein the RFID system 2400 is operating to identify passengers loading/unloading a plane (or train, etc.) as they pass through the intermediate loading device.

In certain embodiments, RFID controller 2410 may receive a manifest 2456 from a remote server (e.g., server 804 of tracking system 800) that defines RFID identifiers of RFID tags 2490 that should be within vehicle 2501 and at which locations within the vehicle 2501. For example, manifest 2456 may list RFID identifiers of RFID tags 2490 corresponding to assets 2506 that should be loaded onto vehicle 2501 at a transfer depot. Further, manifest 2456 may also define a location or area where each RFID tag 2490 should be removed from vehicle 2501 (e.g., for delivery), based on a delivery address of the corresponding asset 2506 not being within threshold distance of a current location and/or a predefined route of vehicle 2501. Advantageously, RFID controller 2410 may immediately indicate, using status indicator 2472 (e.g., a red flashing light) and or audio generator 2474 (e.g., an alert sound), when an incorrect asset is loaded onto vehicle 2501, such as when an RFID identifier 2492 read from an RFID tag 2490 (e.g., included in an RFID response signal 2434) is not included in manifest 2456. Accordingly, an operator of vehicle 2501 is alerted of a potential error in loading of vehicle 2501. Further, when RFID controller 2410 no longer detects the RFID identifier of RFID tag 2490 within cargo area 2504 prior to vehicle 2501 reaching a delivery location of the corresponding asset, RFID controller 2410 may immediately generate an alert using one or both of status indicator 2472 (e.g., a red flashing light) and or audio generator 2474. Accordingly, the operator of vehicle 2501 is immediately alerted of a potential delivery error.

### Monolithic Apparatus

FIG. 26 is a schematic illustrating one example monolithic RFID reader apparatus 2600, in embodiments. Monolithic RFID reader apparatus 2600 is a single device that includes functionality of RFID reader system 2400 as described for the embodiment of FIG. 25 in a single package that simplifies retrofitting of a vehicle with RFID reader system 2400. In one example of installation, monolithic RFID reader apparatus 2600 is attached to a ceiling 2602 or ceiling ribs 2604 of cargo area 2504 of vehicle 2501 of FIG. 25. Monolithic RFID reader apparatus 2600 includes RFID controller 2410 with RFID reader 2412, at least one cargo area RFID antenna 2430, wireless gateway node 2414 with at least one network antenna 2415, and power manager 2416 that is optionally connected to electrical power of vehicle 2501 via single power cable 2508. Monolithic RFID reader apparatus 2600 may include one or more sensors 2470, status indicator 2472, audio generator 2474, and input device 2484. Network antenna 2415 may be positioned on an external surface of Monolithic RFID reader apparatus 2600 for example.

In embodiments where monolithic RFID reader apparatus 2600 includes a single cargo RFID antenna 2430, the single cargo RFID antenna 2430 operates to both transmit an RFID interrogation signal 2432 and receive any RFID response signal(s) 2434. In another example where monolithic RFID reader apparatus 2600 includes two or more cargo RFID antennas 2430, one cargo RFID antenna 2430(1) may operate to transmit the RFID interrogation signal 2432 and the other cargo RFID antennas 2430 may operate to receive any RFID response signal(s) 2434. In yet other embodiments, an external RFID device generates the RFID interrogation signal 2432 and each cargo RFID antenna 2430 within monolithic RFID reader apparatus 2600 operates to receive any RFID response signal(s) 2434.

Monolithic RFID reader apparatus 2600 may also include any one or more of display device 2476, proximity sensor 2478, vehicle interface 2480, at least one camera 2482, and combination thereof; however, since this embodiment represents a minimal install, they are omitted.

Advantageously, installation of monolithic RFID reader apparatus 2600 is simple, requiring minimal wiring (e.g., only power cable 2606) and is therefore convenient for retrofitting of existing vehicles. Monolithic RFID reader apparatus 2600 may also include a lamp 2608, allowing Monolithic RFID reader apparatus 2600 to be installed by replacing an existing lamp of vehicle 2501.

### High-Fidelity Configuration

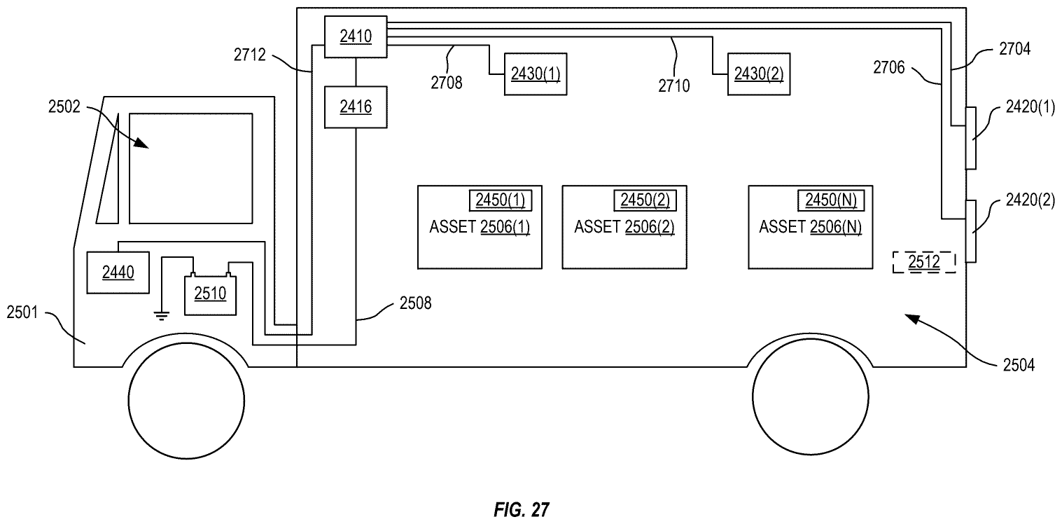

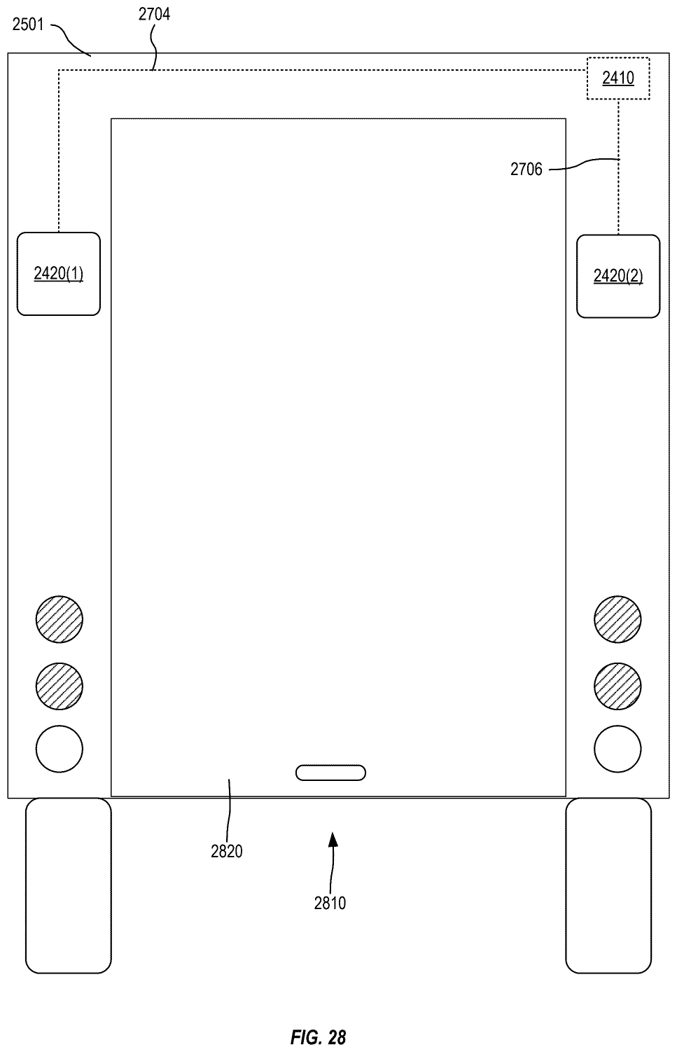

FIG. 27 is a schematic diagram illustrating example fitting of RFID reader system 2400 to vehicle 2501 of FIG. 25, in embodiments. FIG. 28 is a diagram illustrating a rear end 2810 of vehicle 2501 of FIG. 27, according to certain embodiments. FIGS. 27 and 28 are best viewed together with the following description. The embodiments of FIGS. 27 and 28 establish additional features that may be included in the RFID reader system 2400 to improve the fidelity of the RFID reader system in analyzing the vehicle and associated cargo area to identify assets therein and potential mis-load applications.

Vehicle 2501 is fitted with RFID reader system 2400 that includes RFID controller 2410, cargo area RFID antennas 2430(1) and 2430(2) that connected to RFID reader 2412 by cables 2708 and 2710 such that they are positionable within cargo area 2504, external RFID antennas 2420(1) and 2420(2) connected to RFID reader 2412 by cables 2704 and 2706 such that they are positionable at an external surface of rear end 2810 of vehicle 2501, driver cabin RFID antenna 2440 connected to RFID reader 2412 such that it is positionable within driver cabin 2502, and power manager 2416 that may be coupled by cable 2508 to vehicle power (e.g., a battery 2510 of vehicle 2501). Although shown separately and within cargo area 2504, RFID controller 2410 and power manager 2416 may be combined into a single device that may be within cargo area 2504 or positioned elsewhere on vehicle 2501. Although power manager 2416 is shown connected to battery 2510, power manager 2416 may connect to other power sources (e.g., a fuse box, a power socket, light socket, solar panel, etc.) of, or attached to, vehicle 2501 without departing from the scope hereof.

As shown in FIG. 28, external RFID antennas 2420 are positioned on an external surface of vehicle 2501 either side of rear door 2820 to face rearward from vehicle 2501. Each external RFID antenna 2420 is directional having a substantially rear-facing lobe. Accordingly, external RFID antennas 2420 detect RFID tags 2490 external of cargo area 2504 and rearward of vehicle 2501. In certain embodiments, external RFID antennas 2420 are used for vehicle-to-vehicle (V2V) communication under certain circumstances, as described in detail below.

In embodiments, one cargo RFID antenna 2430(1) may operate to transmit an RFID interrogation signal 2432 and the other cargo RFID antennas 2430, cabin RFID antenna 2440 and external RFID antennas 2430 may operate to receive any RFID response signal(s) 2434. In yet other embodiments, an external RFID device generates the RFID interrogation signal 2432 and each cargo RFID antenna 2430, cabin RFID antenna 2440, and external RFID antenna 2430 of RFID reader system 2400 operates to receive any RFID response signal(s) 2434. In other embodiments, one cargo RFID antenna 2430 may operate to transmit the RFID interrogation signal 2432, the other cargo RFID antenna 2430 may operate to receive any RFID response signal(s) 2434. Also in this embodiment, cabin RFID antenna and external RFID antenna 2430 may operate to both transmit the RFID interrogation signal 2432 and receive any RFID response signal(s) 2434.

### High-Fidelity Monolithic Apparatus

FIG. 29 shows one example monolithic RFID reader apparatus 2900, in embodiments. Monolithic RFID reader apparatus 2900 is similar to monolithic RFID reader apparatus 2600 of FIG. 26, but includes functionality and connectivity to facilitate higher-fidelity implementation of RFID reader system 2400 as shown in the embodiment of FIGS. 27 and 28.

Monolithic RFID reader apparatus 2900 is a single device that includes functionality of RFID reader system 2400 as described for the embodiment of FIGS. 27 and 28 in a single package that simplifies retrofitting of a vehicle with RFID reader system 2400, while maintain the versatility of adding any number (including zero) of additional RFID antennas external to the monolithic housing of monolithic RFID reader apparatus 2900, such as zero, one, or more additional cargo area RFID antennas 2930 (which are equivalent to cargo area RFID antennas 2430 discussed above) positionable outside of monolithic RFID reader apparatus 2900, at least one driver cabin RFID antenna 2440, and external RFID antennas 2420. In one example of installation, monolithic RFID reader apparatus 2900 is attached to a ceiling 2602 or ceiling ribs 2604 of cargo area 2504 of vehicle 2501. Monolithic RFID reader apparatus 2900 includes RFID controller 2410, RFID reader 2412, RFID antenna 2430 wireless gateway node 2414 with at least one, power manager 2416 that is optionally connected to electrical power of vehicle 2501 via single power cable 2508, display device 2476, proximity sensor 2478, vehicle interface 2480, and at least one camera 2482. Network antenna 2415 may be positioned on an external surface of Monolithic RFID reader apparatus 2900 for example.

Monolithic RFID reader apparatus 2900 may include at least one connector for coupling with cables 2704 and 2706 that connect external RFID antennas 2420 to RFID reader 2412, at least one connector for coupling with cables 2708 and 2710 that connect cargo area RFID antennas 2930(1) and 2930(2) to RFID reader 2412 (more or fewer cargo area RFID antennas 2930 may be used without departing from scope hereof), and at least one connector for coupling with cable 2712 that connects driver cabin RFID antenna 2440 with RFID reader 2412. Monolithic RFID reader apparatus 2600 may include one or more sensors 2470, status indicator 2472, audio generator 2474, and input device 2484.

The RFID antenna 2430 may be an integrated antenna housed within the monolithic RFID reader apparatus 2900, and have field of view that spans downward when the monolithic RFID reader apparatus 2900 is mounted at a ceiling, or high, location within the cargo area (or other monitored area such as a intermediate loading device, such as a jet bridge in an airport gate, etc.) to monitor the locations where packages enter and/or are loaded into cargo area 2504 of vehicle 2501 and eventually positioned during transport. The type and configuration of the RFID antenna 2430 may vary based on the number of RFID antennas 2430, and additional RFID antennas 2930 that are coupled with the monolithic RFID reader apparatus 2900 (e.g., via cables 2708 and/or 2710). For example, in one embodiment where a single RFID antenna 2430 is used, a patch (or otherwise planar) antenna may be implemented to increase the spatial coverage of the read area (FOV) of the antenna to allow for more coverage in the cargo area. Non-patch RFID antennas may be implemented as the RFID antenna 2430, and/or any of the external cargo area RFID antennas 2930 without departing from scope hereof, such as where a single RFID antenna 2430 is monitoring a smaller cargo area and a patch antenna is not needed to provide adequate spatial coverage. Multi-RFID antenna embodiments that include an internal cargo area RFID antenna 2430 and additional external cargo area RFID antennas 2930 may include combination of patch and non-patch antennas.

Installation of RFID reader system 2400 required mounting of monolithic RFID reader apparatus 2900, mounting of antenna 2420, 2430, and 2440, running of cabling 2508,2704, 2706, 2708, 2710, and 2712. Thus, monolithic RFID reader apparatus 2900 provides a convenient way to retrofit existing vehicles. Monolithic RFID reader apparatus 2900 may also include a lamp 2908, allowing Monolithic RFID reader apparatus 2900 to be installed by replacing an existing lamp of vehicle 2501.

Although shown with two external RFID antennas 2420, two cargo area RFID antennas 2430, and one driver cabin RFID antenna 2440, RFID reader system 2400 may have more or fewer RFID antennas 2420, 2430, and 2440 without departing from the scope hereof. As shown in FIG. 28, one external RFID antenna 2420 is mounted each side of a rear door 2820.

In embodiments, at least one of the RFID antennas 2430 (e.g., one cargo RFID antenna 2430(1)) may operate to transmit an RFID interrogation signal 2432 and the other cargo RFID antennas 2430, cabin RFID antenna 2440 and external RFID antennas 2430 may operate to receive any RFID response signal(s) 2434. In yet other embodiments, an external RFID device generates the RFID interrogation signal 2432 and each cargo RFID antenna 2430, cabin RFID antenna 2440, and external RFID antenna 2430 of RFID reader system 2400 operates to receive any RFID response signal(s) 2434. In other embodiments, one cargo RFID antenna 2430 may operate to transmit the RFID interrogation signal 2432, the other cargo RFID antenna 2430 may operate to receive any RFID response signal(s) 2434. Also in this embodiment, cabin RFID antenna and external RFID antenna 2430 may operate to both transmit the RFID interrogation signal 2432 and receive any RFID response signal(s) 2434. Additionally or alternatively, at least one of the RFID antennas 2430 may transmit the RFID interrogation signal 2432, and another RFID tag, such as one or more of RFID tags 2490 attached to each asset, may receive an RFID response signal 2434 to the RFID interrogation signal 2432 from a responding one of the RFID tags 2490. The one or more RFID tags 2490 that receive the RFID response signal(s) 2434 may then relay the received RFID response signal 2434 to the vehicular RFID reader system 2400 (e.g., vehicular RFID controller 2410), or another device such as server 804 discussed above in FIG. 8.

RFID reader system 2400 detects RFID tags 2490 entering vehicle 2501, within vehicle 2501, and exiting vehicle 2501. That is, RFID reader system 2400 tracks the assets 2506, or other objects, based on detecting and identifying RFID tags 2490 associated with the assets 2506 or objects being transported. Particularly, RFID reader system 2400 may detect RFID tags 2490 within driver cabin 2502 using driver cabin RFID antenna 2440 and may detect RFID tags 2490 within cargo area 2504 using cargo area RFID antenna 2430. RFID reader system 2400 may also detect RFID tags 2490 approaching a rear end 2810 of vehicle 2501 or leaving vehicle 2501 in a rearward direction. RFID controller 2410 records inventory within vehicle cargo area 2504 and driver cabin 2502, and may thereby discern when RFID tags 2490 enter or exit these areas. Accordingly, using previous RFID control and decode iterations, RFID reader system 2400 may detect when assets 2506 or objects move into, or out of, driver cabin 2502 and/or cargo area 2504 based on when previously detected RFID tags 2490 are no longer detected, and when previously undetected RFID tags 2490 are newly detected. Further, by knowing the relationship between the driver cabin 2502, cargo area 2504, and area behind vehicle 2501, RFID controller 2410 may determine a direction of movement of RFID tags 2490 and thus associated assets 2506.

In one example of operation, at intervals, RFID controller 2410 controls RFID reader 2412 to detect RFID tags 2490 within cargo area 2504 using cargo area RFID antennas 2430(1) and 2430(2), to detect RFID tags 2490 within driver cabin 2502 using driver cabin RFID antenna 2440, and to detect RFID tags 2490 behind vehicle 2501 using external RFID antennas 2420. Accordingly, RFID controller 2410 determines when inventory within these areas changes, and which assets 2506 are added or removed. RFID controller 2410 may communicate inventory, or changes to the inventory, within each of driver cabin 2502 and cargo area 2504 to wireless gateway node 2414, which may relay the information to tracking system 800 of FIG. 8, or components thereof, such as server 804 for example.

Accordingly, when asset 2506 is inside the vehicle, RFID reader system 2400 may detect where specifically inside the vehicle asset 2506 is located by detecting RFID tag 2490 attached to asset 2506. In particular, RFID reader system 2400 may determine whether an asset is inside cargo area 2504 or driver cabin 2502, in addition to detecting an asset moving between cargo area 2504 and driver cabin 2502. Additionally, RFID reader system 2400 may determine whether the asset has exited vehicle 2501 from cargo area 2504 or from driver cabin 2502.

Further, external RFID antennas 2420 may be used to track location and movement of assets 2506 relative to vehicle 2501 based upon detecting the corresponding RFID tags 2490 using external RFID antennas 2420. Using more than one RFID antenna increases signal to noise and increases the ability of RFID reader system 2400 to determine directionality of RFID tags 2490 with respect to vehicle 2501 (using triangulation, trilateration, multilateration, and/or other techniques based off of received signal strength and directionality of received signals).

In certain embodiments, RFID controller 2410 includes a passive combiner 2421 (see FIG. 24) to combine outputs of one or more of the RFID antennas (e.g., external RFID antennas 2420(1) and 2420(2)) as a single input into RFID reader 2412. Passive combiner 2421 adds the signals received from the external RFID antennas 2420 together and provides the combined signal as an input (e.g., corresponding to the overall antenna array 2420) to RFID reader 2412 in RFID controller 2410.

External RFID antennas 2420(1) and 2420(2) connect to passive combiner 2421 via cables 2704 and 2706, respectively, and the length of cables 2704 and 2706 are tuned to ensure outputs from external RFID antennas 2420 are phase matched to each other, where cable 2704 adds a phase of P₁ to the output of external RFID antenna 2420(1) and cable 2706 adds a phase of P₂ to the output of external RFID antenna 2420(2). For a given operational frequency of external RFID antennas 2420, an electrical length of cables 2704 and 2706 are adjusted such that, P₁=2nπ+P₂.

Vehicle Racks with Asset Tracking

FIG. 30 is a perspective schematic illustrating one example slot tracking system 3000 within vehicle 2501 of FIG. 25, in embodiments. Slot tracking system 3000 includes RFID reader system 2400 (illustratively shown as either monolithic RFID reader apparatus 2600 or 2900). Following the example of FIGS. 24, 25, and 27, cargo area 2504 of vehicle 2501 is fitted with racks 3002 (also referred to as shelves) that are partitioned into slots 3004 (also referred to as bins) sized and shaped for storing assets 2506 during transportation by vehicle 2501. Although not shown in FIG. 30 for clarity of illustration, floor space within cargo area 2504 may also be divided into slots 3004. FIG. 31 is a perspective view showing slot 3004(2) of FIG. 30 in further example detail, in embodiments. FIGS. 30 and 31 are best viewed together with the following description.

Racks 3002(1) and 3002(2) are mounted at a first side wall (rearward in FIG. 30) of cargo area 2504 and rack 3002(3) is mounted at a second side wall (forward in FIG. 30 and shown in dashed outline for clarity of illustration) of cargo area 2504. Cargo area 2504 may have more or fewer racks 3002 and slots 3004 without departing from the scope hereof. Slot tracking system 3000 extends RFID reader system 2400 by further including a slot RFID device 3006 (which may be a tape node, in which case it is referred to herein as slot tape node 3006 (e.g., an RFID tape node) attached (e.g., adhered) to each slot 3004. For clarity purposes herein, slot RFID device 3006 is referred to as slot tape node 3006, but does not necessarily need to be a tape node and may additionally or alternatively be integral with the rack or otherwise have a different form factor than a tape node. The slot tape node 3006 may operate as an RFID reader node as discussed above, where it operates to receive RFID response signals to a generated RFID interrogation signal. The slot tape node 3006 may generate the RFID interrogation signal, or the RFID interrogation signal may be generated by another device such as another slot tape node 3006, or an RFID antenna associated with the monolithic device 2600 or 2900 as discussed above.

In embodiments, the slot tape node 3006 is a wireless, battery-powered device. Alternatively, the slot tape node 3006 is wired and/or line-powered. E.g., if a more permanent installation is preferred, the slot tape node 3006 may be wired to either a gateway node, the vehicle power, the power manager 2416 discussed above, another wired power source, a solar panel, or combinations thereof.

Slot tape node 3006 includes a wireless transducing circuit 3102 (e.g., wireless transducing circuit 410 of FIG. 4) that facilitates communication with RFID controller 2410 via wireless gateway node 2414 and further includes RFID capability such that it may detect proximity of RFID tags 2490. In embodiments, slot tape node 3006 does not generate an RFID interrogation signal 2432, but detects wireless response signal(s) (e.g., RFID response signal 2434, discussed above) from RFID tags 2490 that are within range when triggered by an RFID interrogation signal 2432 generated by RFID reader system 2400 or by an externally generated RFID interrogation signal 2432. In other embodiments, each slot tape node 3006 generates its own RFID interrogation signal to interrogate RFID tags 2490. Slot tape node 3006 may also include one or both of an indicator 3104 (e.g., an LED) and a display 3106 (e.g., an LCD display, an LED display, an e-ink display, etc.).

Sensitivity and/or operational RFID range (including one or more of RFID channel, transmit power control, hopping protocol (multiplexing between frequency channels), RF beam profile, and receiver sensitivities indicated by ellipse 3108) of slot tape node 3006 is configured to primarily detect RFID tags 2490 within its slot 3004. As such, the operational RFID range may be less than a full operational range of the hardware components such that the RFID operation of slot tape node 3006 reduces interference with alternate RFID components within the vehicle (such as other components of RFID reader system 2400 discussed herein). Alternatively, slot tape node 3006 may use signal strength to determines whether a detected RFID tag 2490 is within its slot 3004. Although slot tape node 3006 is shown positioned at the front of its slot 3004, it may alternatively be positioned at the back of its slot 3004, indicated as slot tape node position 3110, or at any other location in the given slot 3004. In some embodiments, each slot 3004 may have multiple slot tape nodes 3006 that communicate to determine when a detected RFID tag 2490 is within its slot 3004. In addition, additional RFID reader nodes may be located throughout the monitored area, and not just as the slot tape nodes 3006. Wireless configuration and adaptivity of use of the RFID tape nodes (and multiple types/configurations of the RFID tape nodes such as some that are just RFID reader nodes, and/or some that are RFID illumination nodes, and/or some that are just passive/active RFID nodes, etc.)

Each asset 2506 may have a shipping label, or other label, that displays transit information including a truck number (e.g., an identifier of vehicle 2501), and optionally other information, to assist an employee or operator in loading, unloading, transporting, and storing the asset. The transit information may further include a shelf/rack identifier and/or a slot identifier. That is, the label on asset 2506 may identify one of slots 3004 within vehicle 2501 for storing the asset. In certain embodiments, the shipping label attached to asset 2506 is an RFID tape node that may be detected and read by RFID reader system 2400. This RFID tape node may also store the transit information corresponding to its asset 2506 in its memory/storage, and may transmit at least part of the transit information in response to RFID interrogation from RFID reader system 2400. Accordingly, RFID reader system 2400 may learn of the designated slot for the asset and may provide further guidance to the operator in loading of asset 2506 into the designated slot 3004 based on the received transmit information. For example, the indicator 3104 or display 3106 on the slot tape node 3006 associated with the designated slot 3004 may be controlled to indicate the asset 2506 should be loaded into the designated slot 3004 (or is wrongly loaded).

In one embodiment, one cargo RFID antenna 2430 of RFID reader system 2400, or an external RFID device, may transmit an RFID interrogation signal (e.g., RFID interrogation signal 2432) within cargo area 2504 and other cargo RFID antennas 2430 and each slot tape node 3006 operate to receive any RFID response signal(s) (e.g., RFID response signal(s) 2434). However, in certain embodiments, one or more slot tape nodes 3006 may both generate an RFID interrogation signal and receive any RFID response signals.

In one example of operation, when RFID controller 2410 detects the RFID tag 2490 on asset 2506 and determines that it is being loaded into vehicle 2501, RFID controller 2410 may determine which slot 3004 asset 2506 is assigned to and send instructions to the corresponding slot tape node 3006 located at the assigned slot to indicate, via activation (e.g., turning on, or turning to a specific color) of the indicator 3104 or display 3106, the destination for asset 2506. In one example, the tape node on asset 2506(1) sends a message to RFID controller 2410 indicating slot 3004(1). In another example, RFID controller 2410 determines slot 3004(1) is assigned to asset 2506(1) based on an RFID identifier read from RFID tag 2490 on asset 2506(1) and manifest 2456. RFID controller 2410 may then instruct, via wireless gateway node 2414, slot tape node 3006(1) to activate its indicator 3104 (e.g., one or more of turn on the indicator, turn the indicator to a designated color, flash the indicator, and the like) and/or instruct slot tape node 3006(1) to display an identifier of asset 2506(1) on its display 3106. Advantageously, the operator bringing asset 2506(1) into vehicle 2501 is aided in placement of asset 2506(1) into slot 3004(1).

Similar functionality may be performed via vehicle unloading. For example, RFID controller 2410 may monitor location of the vehicle 2501, and, based on manifest 2456 determine that a given package is to be delivered at the current location. Additionally, or alternatively, a signal may be transmitted to the RFID controller 2410, or one or more of the slot tape nodes 3006 indicating that a package is up for current delivery. The RFID controller 2410 may, in turn, transmit a control message to instruct the designated slot tape node 3006 associated with the package up for delivery to activate its indicator 3104 (e.g., one or more of turn on the indicator, turn the indicator to a designated color, flash the indicator, and the like) and/or instruct slot tape node 3006(1) to display an identifier of asset 2506(1) on its display 3106. This advantageously allows the delivery personnel to quickly and efficiently obtain the package set for delivery from the rack.

In certain embodiments, as asset 2506 is placed into slot 3004, the corresponding slot tape node 3006 detects the RFID tag 2490 on asset 2506 and sends the RFID identifier to RFID controller 2410. RFID controller 2410 may then verify that asset 2506 is stored in the correct slot 3004, for example by comparing the asset 2506 against the manifest 2456. Further, RFID controller 2410 may generate an alert (e.g., an alarm sounds and/or visual indication) to indicate when asset 2506 is stored correctly and/or incorrectly. For example, where asset 2506(1) is incorrectly placed into slot 3004(2), slot tape node 3006(2) may report detection of asset 2506(1) to RFID controller 2410, which may then generate the alert, allowing the operator to reposition asset 2506(1), rather than be unable to find asset 2506(1) at a later time. A further advantage is that RFID reader system 2400 operates to direct the operator in storing and retrieving assets 2506 without direct interaction with the operator. That is, the operation receives direction just by carrying asset 2506, and is automatically corrected when positioned errors are made. By ensuring assets 2506 are stored in the correct slot 3004, the operator retrieves the asset 2506 quickly when offloading it (e.g., delivering it to a specific address) from vehicle 2501. Advantageously, RFID reader system 2400, racks 3002, slots 3004, and slot tape nodes 3006 facilitate storage and retrieval of assets 2506 by alerting the operator to storing errors and thereby avoiding problems locating misplaced assets.

Although slot tracking system 3000 is shown within vehicle 2501, slot tracking system 3000 may be used within other environments (e.g., warehouses, storage areas, loading docks, ships, aircraft, and so on) without departing from the scope hereof. Further, slot tracking system 3000 may be used to determine inventory and/or capacity of each slot 3004. For example, since each slot tape node 3006 detects and reports identified RFID tags 2490 within its respective slot 3004, RFID controller 2410 (or server 804) may maintain a database of assets 2506 stored in each slot 3004, and thereby determine space available in each slot 3004. For example, based on and know size of slots 3004 and size of each asset 2506 (e.g., defined within manifest 2456), RFID controller 2410 may determine space remaining in each slot for additional assets.

### Warehouse Racks

In one example of operation, slot tracking system 3000 is implemented in a warehouse where an operator is to move assets from a pile (e.g., pallet) into racks for storage. To the operator, the racks may seem full and therefore the operator has difficulty in placing the assets on the racks. Advantageously, slot tracking system 3000 inventories assets already stored in slots 3004, determines which slots 3004 have remaining space, and directs the operator to store assets from the pile in the slots having the remaining space. For example, RFID controller 2410 may direct each slot tape node 3006 corresponding to slots with remaining space to blink its status indicator 2472 to indicate the available space to the operator, thereby simplifying the operators task of storing assets from the pile onto the racks. As assets are loaded into the slots, RFID controller 2410 recalculates slot inventories and updates the indications of slots with available space.

Further, since each slot tape node 3006 identifies assets stored in that slot, RFID controller 2410 facilitates retrieval of a particular asset from racks 3002 by directing the operator to the slot containing the particular asset. For example, based on the RFID identifier corresponding to the asset being retrieved, RFID controller 2410 determines the slot 3004 in which it is stored and instructs the corresponding slot tape node 3006 to flash its status indicator 2472. Advantageously, the operator is immediately directed to the slot containing the required asset.

### Additional Use of External RFID Antennas

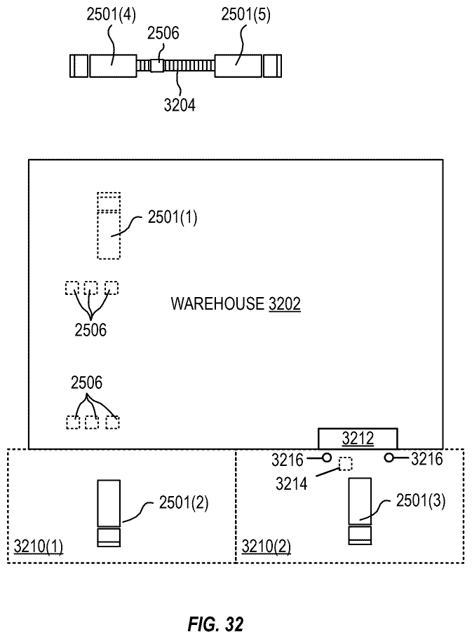

Further to detecting loading and unloading of RFID tags 2490 to and from vehicle 2501 via rear door 2820, external RFID antennas 2420 have additional uses. FIG. 32 is a block diagram showing a warehouse 3202 that stores (e.g., as a depot) assets for transportation by vehicles 2501(1)-5), in embodiments. In this example, a first vehicle 2501(1) is posited within warehouse 3202 for loading, and second and third vehicles 2501(2) and 2501(3) are posited at external loading bays of warehouse 3202. Vehicles 2501(1), 2501(2), and 2501(3) are fitted with RFID reader system 2400 as shown in FIGS. 27 and 28.

In one example, external RFID antennas 2420 may be used for sensing objects and obstacles behind vehicle 2501, thereby assisting the driver when maneuvering vehicle 2501. As the environment behind vehicle 2501 changed during a maneuver (e.g., reversing), wireless signals reflected and/or absorbed by objects behind vehicle 2501 also change and may be detected by RFID reader 2412. For example, as vehicle 2501(3) reverses towards the loading bay 3212 of warehouse 3202, external RFID antennas 2420 may be used to sense objects (expected and/or unexpected) blocking passage of vehicle 2501(3). Further, as vehicle 2501(3) reverses towards the loading bay 3212 of warehouse 3202, external RFID antennas 2420 may be used to sense a distance between vehicle 2501(3) and warehouse 3202.

For example, an asset 3214 with an RFID tag (e.g., RFID tag 2490) may be located on a street or curb or otherwise in an area to which the vehicle 2501(3) is backing up, and the system 2400 can identify said asset 3214 using external RFID antennas 2420 and can warn that the driver is about reverse over it by performing RFID-based location sensing with the RFID tag 2490 attached to the asset 3214. Similarly, RFID tags can be placed on objects of interest, like a stationary part of a loading bay or a wall such as posts 3216. Thus, proximity sensing using the RFID communication with the RFID tag 2490 on posts 3216 or other objects can be used to warn/guide a driver.

In another example, external RFID antennas 2420 may be used to detect assets 2506 being transferred into or out of vehicle 2501(4) on a conveyor belt 3204, such as when assets are transferred between vehicles 2501(4) and 2501(5). Accordingly, based on manifest 2456, RFID controller 2410 may detect when an expected asset 2506 is missed and when an unexpected asset is transferred unintentionally.

In another example, external RFID antennas 2420 may be used for communication between two vehicles 2501 when rear ends 2810 of each vehicle are facing one another. It should be appreciated that external RFID antennas 2420 need not be only on the rear of the vehicle 2501, but may also be located on sides and/or front of the vehicle (or top/bottom). In such situations, the communication may be made between two vehicles 2501 that are not rear to rear facing, but instead parallel parked, or otherwise including one external RFID antenna 2420 that is facing or within range of a second external RFID antenna 2420 on a second vehicle. That is, external RFID antennas 2420 are repurposed for local inter-vehicle communication when other communication paths may be blocked. For example, when vehicle 2501(1) is within warehouse 3202, one or both of gateway nodes 2414 and 2512 on vehicle 2501(1) is blocked (e.g., by the structure of warehouse 3202, by other similar structures, or blocked by local interference) from using long-range communication protocols, but gateway nodes on vehicle 2501(2), positioned outside of warehouse 3202 is not blocked and is available for long-range communication with other nodes of tracking system 800. In this situation, vehicle 2501(1) may use external RFID antennas 2420 communicate with vehicle 2501(2), which may then use its gateway nodes to relay the messages to tracking system 800. Under certain conditions, wireless gateway nodes 2414 of the two vehicles 2501(1) and 2501(2) may also communicate directly; however, when such communication is blocked (e.g., due to wireless interference etc.), external RFID antennas 2420 may be used to form a communication path between the two vehicles 2501(1) and 2501(2), and other vehicles as needed, to permit communication. Further, V2V communication may be used between two vehicles 2501 to share telematics data or to provide a communication path for vehicle diagnostic data, OBD data, tracking data, and so on.

RFID antennas may also be used for proximity detection between vehicles. For example, RSSI associated with signals generated by one or more antennas (e.g., external RFID antennas 2420, cargo antennas 2430 and/or driver cab antennas 2440) located on a first vehicle (e.g., 2501(4)) may be captured by a second vehicle (e.g., 2501(5)), and used to determine how close the first and second vehicles are to one another. Thus, if a given vehicle is backing up or maneuvering nearby another vehicle where an antenna is, proximity-based analysis based on RSSI of RFID signals between the two vehicles can be used for warning/guiding a driver.

Where both vehicle 2501 are in a geographical area with poor wireless signal reception, each vehicle may exchange data destined for tracking system 800 that is stored by gateway nodes 2414 and/or 2512 until such time when communication with tracking system 800 is available (e.g., when the gateway nodes 2414, 2512 move to a geographic area where long-range communication is available, or when within Wi-Fi range of another node of tracking system 800). In some embodiments, a first vehicle with poor signal reception or connectivity to the cloud (e.g., external server 804) may transfer some data stored on its memory/storage (e.g., memory 2452) to a nearby second vehicle using V2V communication that is scheduled to depart soon. The second vehicle stores the received data from the first vehicle and a timestamp of when it received the data. The second vehicle departs and reaches a location with adequate cellular signal reception or adequate connectivity to the cloud via another communication network and uploads the data to a database (e.g., database 708) hosted on the cloud using cellular communications. If the first vehicle does not reach a location with adequate cellular signal or connectivity to the cloud before the second vehicle does, the cloud is able to be updated with the data from the first vehicle with lower latency than without V2V communication. When the first vehicle reaches an area of adequate cellular signal or cloud connectivity at an earlier time than the second vehicle, the second vehicle's upload of the data received from the first vehicle may be ignored or overwritten by the cloud server, in some embodiments. When the first vehicle reaches a location of adequate cellular signal or cloud connectivity at a later time than the second vehicle, the first vehicle may communicate with the cloud to update the database with the most recent data or confirm that the uploaded data from the second vehicle is still valid.

In some examples, data may be transmitted over LoRa-based communication connections to wireless nodes with LoRa communication capabilities (e.g., medium or high-power wireless communication interfaces as discussed above) or over 900 ISM-based communications using the external RFID antennas, since 900 ISM may be used by the RFID transceivers (sometimes by cellular and narrowband Internet of Things, NB-IOT). In certain embodiments, other wireless nodes of tracking system 800 relay the data to a cellular equipped wireless node (and/or a medium or high-power wireless communication interface as discussed above) which then uploads the data to server 804 of tracking system 800. In some embodiments, wireless gateway node 2414 and/or gateway node 2512 instructs other nearby wireless nodes of tracking system 800 to search for a backup communication path to server 804. For example, a backup path may be via one or more of (a) a gateway node installed at a building or other location, (b) another vehicle RFID gateway that has cellular or satellite communication capabilities, (c) a smartphone of a user or driver, or (d) via another wireless node associated with the tracking system 800.

Each vehicle 2501 operates RFID reader system 2400 using an RFID configuration 2458, illustratively shown stored in memory 2452 of RFID controller 2410, FIG. 24, that defines one or more of RFID channel, transmit power control, hopping protocol (multiplexing between frequency channels), RF beam profile, and receiver sensitivities. The RFID configuration settings 2458 may be determined internally by the RFID controller 2410, and/or are received from an external device and dynamically changed based on RFID configuration of nearby RFID systems. The external device may be one or more of a server (e.g. server 804 discussed above), another RFID controller associated with a different vehicle, or a warehouse management system. In one embodiment, the RFID configuration 2458 may change automatically based on location of the vehicle. For example, area 2501(1) may have a designated set of RFID configuration 2458, and area 3210(2) may have a second designated set of RFID configuration 2458. As each vehicle 2501 moves within the area encompassing areas 3210(1) and 3210(2), the RFID controller may automatically change to the designated set of RFID configuration 2458 associated with the given area 3210. Location of the vehicle may be determined using on-board navigation system, or other location determining means herein, or via an external device such as a camera, etc. Vehicle-to-vehicle communication may also be used to resolve or avoid RFID interference between two vehicles that are near one another. RFID interference occurs when both vehicles are using the same, or similar, RFID configuration. System parameters, such as one or more of RFID channel, hopping protocol (multiplexing between frequency channels), and high receiver sensitivities may be altered in one vehicle to avoid interference. In one example of operation, to avoid or resolve any RFID interference, two vehicles 2501(5) and 2501(5) may (a) determine that they are near one another, and (b) exchange RFID configuration 2458 and thereby learn of potential interference. Accordingly, RFID controller 2410 may dynamically change parameters of RFID configuration 2458 to avoid interference from nearby vehicles. For example, where RFID controller 2410 within vehicle 2501(4) receives, from nearby vehicle 150(5)1, RFID configuration 2458 defining an RFID channel and hopping protocol that is the same as its current RFID configuration 2458, it may change one or both of its RFID channel and hopping protocol to avoid or resolve interference. RFID controller 2410 may change any parameters of RFID configuration 2458 as needed. In certain embodiments, RFID controller 2410 in each vehicle 2501(4) and 2501(5) may communicate potential changes to RFID configuration 2458 prior to making them and thereby avoid further interference issues.

Vehicle 2501 may include a gateway node 2512 (see FIGS. 25 and 27) that is independent of RFID reader system 2400. Gateway node 2512 may represent any one of the short range, medium range, and long range adhesive tape platform tape nodes shown in FIGS. 6A-6C and FIG. 9, and/or one of mobile gateways 810 and 812 of FIG. 8. Gateway node 2512 may communicate with other nodes of tracking system 800, such as to provide tracking of vehicle 2501 and/or of non-RFID based assets. In certain embodiments, gateway node 2512 stores RFID configuration 2458 and communicates with similar gateway nodes on other vehicles to exchange RFID configuration 2458 and thereby avoid interferences due to proximity. Gateway node 2512 may communicate received RFID configurations received from a gateway node on another vehicle to its local RFID controller 2410, via wireless gateway node 2414 for example, whereby RFID controller 2410 may change its own RFID configuration 2458 to avoid interference with the other vehicle. RFID controller 2410 may send RFID configuration 2458 to gateway node 2512 whenever it is changed such that it may be shared with other nearby vehicles by gateway node 2512.

### Additional Configuration Information

The foregoing description of the embodiments of the disclosure have been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

Computer apparatus 2320 of FIG. 23 may also represent computing apparatus of any of RFID controller 2410, RFID reader 2412, and wireless gateway node 2414 of FIG. 24.

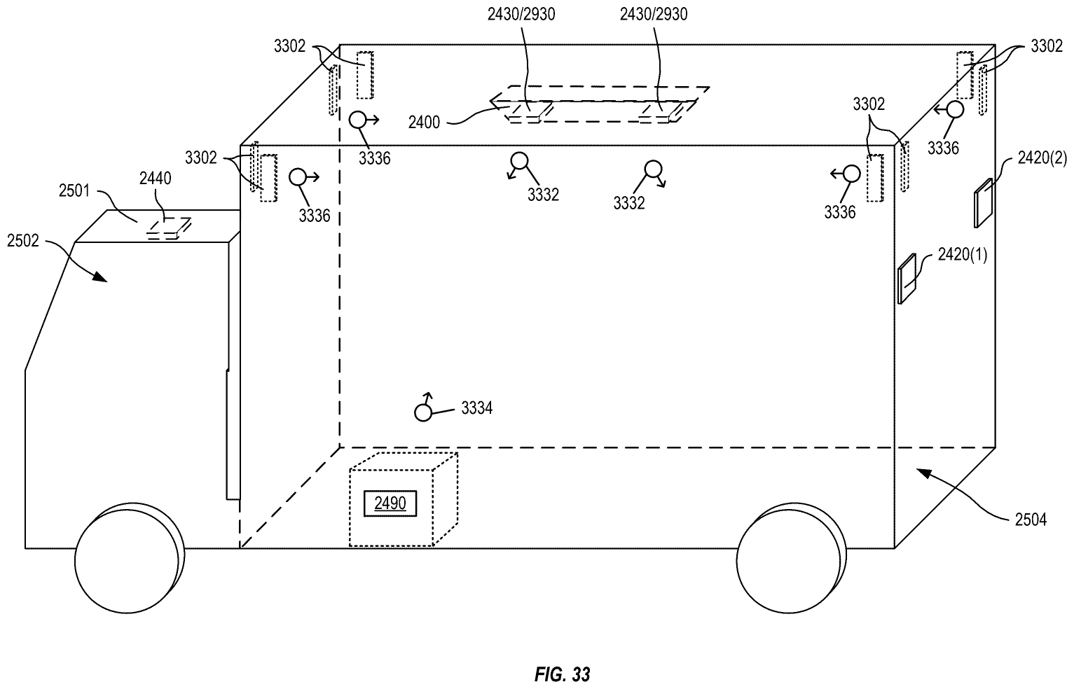

FIG. 33 is a perspective diagram illustrating example use of reference RFID reader tape nodes 3302 within a vehicle 2501 to improve the fidelity of RFID reader system 2400 of FIGS. 24-30, in embodiments. The RFID reader tape nodes 3302 may be any of the above-discussed tape nodes discussed with reference to FIGS. 1-13. As shown, a pair of RFID reader tape nodes 3302 are attached to each top internal corner of cargo area 2504. More or fewer RFID reader tape nodes 3302 may be used without departing from the scope hereof. Each RFID reader tape node includes at least an RFID receiver, and a wireless communication system for transmitting data based on received RFID signals. In embodiments, each RFID reader tape node 3302 may also include an RFID transmitter for transmitting RFID interrogation signals. However, in embodiments where the RFID reader tape node 3302 does not include the RFID transmitter, the RFID reader tape node 3302 reduces its operational power consumption because the line-powered RFID antenna 2430 in the RFID system 2400/2600/2900 supplies the higher-power requiring interrogation signal.

The RFID reader tape nodes 3302 may be wireless RFID readers similar to the slot RFID tape nodes 3006, 3110 discussed above (or any other wireless tape node discussed herein. The RFID reader tape nodes 3302 provide the advantage of customized placement and flexibility in achieving high-fidelity monitoring of the cargo area. As such, the RFID reader tape nodes 3302 may be used in replacement of, or additionally to, RFID antennas 2430. In the monolithic configurations 2600/2900, the RFID reader tape nodes may supplement the central RFID antenna 2430 located in the monolithic housing without requirement of additional cables connecting the RFID reader tape nodes 3302 to the monolithic housing.

In one example of operation, RFID reader system 2400 interrogates RFID tags 2490 attached to assets by transmitting a interrogation signal 3332 from one or more RFID antenna 2430 (or one or more RFID reader nodes 3302). One or more of the RFID reader node 3302 measures a signal strength of a RFID response signal 3334 generated by each RFID tag 2490 and generates a relayed response 3336 which may be transmitted back to the RFID reader system 2400. The relayed response 3336 may be transmitted back to the gateway node 2414 using wireless communication, e.g. a wireless communication method and system other than RFID, in some embodiments. In further embodiments, Bluetooth-based communications are used to communicate between the gateway node 2414 and the RFID reader tape nodes.

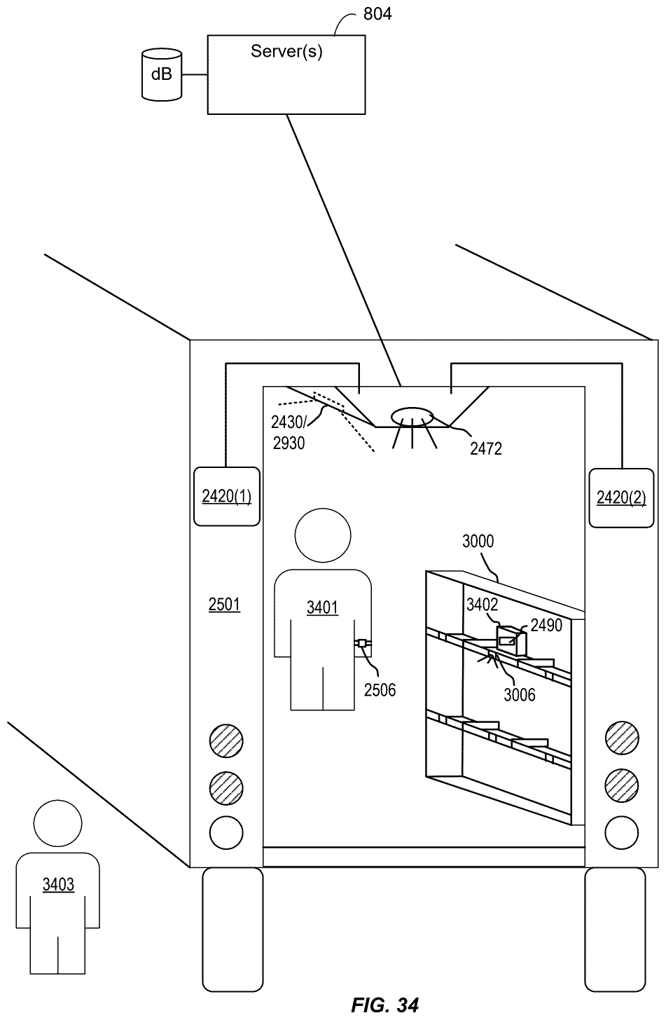

FIG. 34 shows an example operating environment of the RFID reader system 2400, in embodiments. A user 3401 loads package 3402 into cargo area of vehicle 2501, which is an example of the above-discussed assets. Package 3402 has a RFID tag 2490 attached to it. As the user 3401 (or another user, or the package via a conveyor belt) approaches entrance 3406 to of the vehicle 2501, rear-facing external RFID antennas 2420 may identify tag 2490, and compare it to a manifest (e.g., manifest 2456 discussed above). Additionally the RFID reader system 2400 is able to distinguish if the RFID tag 2490 is inside of the vehicle 2501, outside of the vehicle 2501, currently being loaded into the vehicle 2501, and currently being unloaded from the vehicle 2501. These functions may also be triggered using one or more of the above-described components of RFID reader system 2400, including those described with respect to monolithic reader system 2600 and/or 2900. Because RFID reader system 2400 includes locally-stored manifest 2456, the RFID reader system 2400 is capable of in near-real time (e.g., within seconds as opposed to minutes, or within less than a second) provide an indication of whether the correct asset is being loaded, or whether an incorrect asset is being loaded. This indication may be in the form of controller 2410 activating status indicator 2472 (e.g., one or more of turn on the indicator, turn the indicator to a designated color, flash the indicator, and the like) such that a visual indication is observable by the user 3401 and/or user 3403. Other indications may be implemented, such as audio or tactile indication (e.g., using audio generator 2474). The other indications may additionally or alternatively be implemented using an external device, such as via transmission of an indicator instruction to a device 3406 worn by one or both of users 3401 and 3403 that causes the device 3406 to vibrate. The device 3406 need not be a watch, or wearable, but may be a device used by the user 3401 or user 3403, such as a smartphone, personal device, local display nearby the user 3401/3403, etc. The indication to the external device may be implemented using RFID transmission, or other wireless transmission protocol, such as Bluetooth connectivity between the RFID controller 2410 (or wireless gateway node 2414) and the external device 3406. The user 3401 (or another user outside of the vehicle assisting with loading/unloading of assets within the vehicle) may then have real-time feedback of correct loading as opposed to other systems which require transmission of an alert to a server, and then relay back to a given indication device. Such non-local indication lags and is not appropriate for the fast-paced interaction required a distribution centers and loading/unloading zones.

FIG. 34 also shows the optional slot tracking system 3000 (but it is not necessary in all embodiments). In embodiments using slot tape nodes 3006 (only one of which is labeled in FIG. 34 for clarity) that have integral indicator 3104 and/or a display 3106, the slot tape nodes 3006 may determine whether the package is properly loaded into the correct slot. If so, or if the asset 3402 in the slot is due for delivery, the slot tape nodes 3006 may activate (e.g., one or more of turn on the indicator, turn the indicator to a designated color, flash the indicator, and the like) the indicator 3104 to indicate proper/improper/or current loading/unloading.

Although local indication is provided by the system shown in FIG. 34 (and discussed above regarding wireless RFID reader systems 2400/2600/2900), it should be appreciated that the RFID controller 2410 may still be in operational communication with an external server (e.g., server 804 discussed above) for providing information to (e.g., alerts and/or status updates regarding loaded assets within cargo area and/or driver cabin) and receiving information from (e.g., manifest 2456).

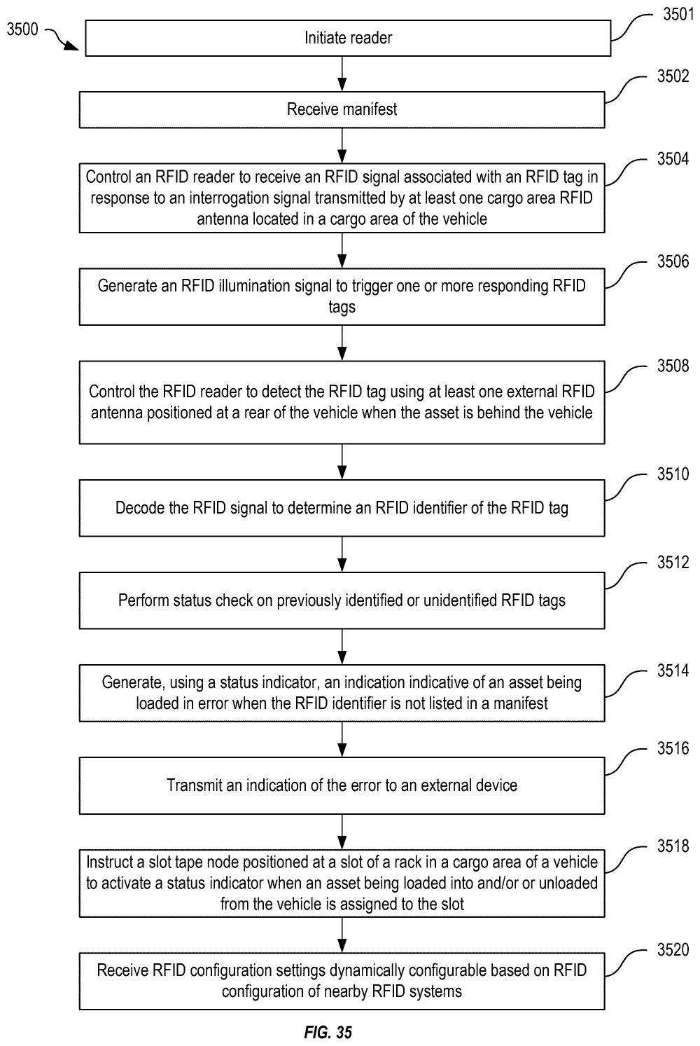

FIG. 35 is a flowchart showing one example method 3500 for detecting and tracking assets in a vehicle, in embodiments. Method 3500 is implemented using the RFID wireless system 2400, 2600, and/or 2900 discussed above in FIGS. 24-33, such as using RFID controller 2410, for example.

In block 3501, the RFID wireless system is initiated. In one example of block 3501, a proximity sensor (e.g., proximity sensor 2478 located internal to the RFID reader system 2400/2600/2900, or an external proximity sensor located in the vehicle or proximate thereto) may be used to wake up the RFID controller 2410 and to start scanning the cargo area using cargo area RFID antennas 2430 and/or proximate area nearby the vehicle using external RFID antenna 2420 and/or driver cabin using driver cabin RFID antenna 2440. In alternate or additional example, a door open/close sensor on one of the vehicle's doors may be used to wake up the RFID controller 2410. In alternate or additional example, the RFID wireless system is initiated in response to the RFID controller 2410, or an external device thereto detecting change in momentum of the vehicle using an accelerometer, change in location data (including GPS), or other system change that may be used as a trigger point for waking up the RFID controller and/or reader and scanning for egress/ingress or updating the status of loaded assets.

In block 3502, method 3500 receives a manifest. In one example of block 3502, RFID controller 2410 receives manifest 2456. The manifest 2456 may be received from an external device, such as server 804 of FIG. 8 discussed above.

In block 3504, the method 3500 controls an RFID reader to receive an RFID signal associated with an RFID tag in response to an interrogation signal transmitted by at least one cargo area RFID antenna located in a cargo area of the vehicle. In one example of block 3504, RFID controller 2410 controls RFID reader 2412 to receive RFID response 2434 in response to RFID interrogation signal 2432 being transmitted by one or more of RFID antenna 2420, cargo area RFID antenna 2430, and driver cabin RFID antenna 2440.

Method 3500 may optionally include block 3506 performed prior to block 3504. In block 3506, the method 3500 generates an RFID illumination signal to trigger one or more responding RFID tags. In on example of block 3506, the RFID controller 2410 controls one or more of RFID antenna 2420, cargo area RFID antenna 2430, and driver cabin RFID antenna 2440 to generate RFID illumination signal 2432 as discussed above. If block 3506 is included, in certain embodiments, block 3504 may include receiving an RFID signal as a relayed RFID response signal from an RFID device other than the one or more responding RFID tags. Using the relayed response signal embodiments provides the advantage that fidelity of the system may be increased because the response signal 2434 generated by the RFID tag 2490 responding to interrogation signal 2432 may have too much noise for accurate and specific location determination if it was required to be detected by the ceiling-mounted RFID reader 2412. Using other RFID devices (such as other ones of the RFID tags 2490, or the slot tape nodes 3006 discussed above, allows the fidelity of the location detection to be improved because the response signal 2434 generated by the responding one of the RFID tags 2490 is detected by another RFID device that is closer to the responding one of the RFID tags 2490, or detected by multiple other RFID devices and then triangulated or subjected to multilateration to improve the accuracy of the position/location determination.

Method 3500 may additionally optionally include block 3508 performed prior to blocks 3504 and/or 3506. If block 3508 is included, method 3500 controls the RFID reader to detect the RFID tag using at least one external RFID antenna positioned at a rear of the vehicle when the asset is behind the vehicle. In one example of operation of block 3508, RFID controller 2410 controls RFID reader 2412 to detect an oncoming RFID tag 2490 using one or more external RFID antenna 2420 that is positioned on the rear of vehicle 2501. Detection of the oncoming RFID tag 2490 may initiate other steps in method 3500, such as blocks 3504 and 3506 to save power consumption when no RFID tag 2490 is expected. Alternate or additional embodiments of block 3508 may include using a proximity sensor (e.g., proximity sensor 2478, or camera 2482) to determine when an object is approaching the RFID wireless system 2400 to initiate aspects of method 3500.

In block 3510, method 3500 decodes the RFID signal to determine an RFID identifier of the RFID tag. In one example of block 3510, the RFID controller 2410 decodes the received RFID signal (either the directly received RFID response signal 2434, or a relayed implementation thereof), to determine an RFID identifier 2492 associated with the responding RFID tag 2490.

Method 3500 may additionally optionally include block 3512. In block 3512, method 3500 performs a status check on previously identified or unidentified RFID tags. In one example of block 3512, method 3500 determines, based on previous controlling and decoding iterations, that the RFID identifier is newly detected and/or no longer detected. In one example of block 3512, RFID controller 2410 compares previously determined RFID identifiers 2492 received within a threshold period prior to the currently-identified RFID identifier to determine that the currently-identified RFID identifier is newly detected and/or a previously-identified RFID identifier is no longer detected. This allows method 3500 to ignore responding RFID tags 2490 that have already been analyzed, and also allows method 3500 to determine when an RFID tag 2490 that may have been loaded in error has been removed from the vehicle.

In another example of block 3512, RFID controller 2410 updates a list of “currently loaded” assets by re-scanning all RFID tags 2490 (e.g., transmitting an RFID interrogation signal and receiving an RFID response signal or relayed RFID response signal associated with each RFID tag 2490) currently located within the cargo area. Block 3512 may be triggered based on a current operational status of the vehicle 2501, or other trigger. For example, block 3512 may be triggered when the vehicle stops for a threshold period, periodically triggered, triggered in response to identification of a wireless network (e.g., identification of a network associated with a distribution center or other warehouse), location of the vehicle, and the like. The RFID controller 2410 may then store any changes or differences from the manifest 2456 and report said changes or differences to an external device such as server 804.

In block 3514, method 3500 generates, using a status indicator, an indication indicative of an asset being loaded in error when the RFID identifier is not listed in a manifest or not in error when the RFID identifier corresponds to the manifest. In one example of block 3500, controller 2410 controls status indicator 2472 to provide an indication (e.g., visual, audio, or tactile indication) when the asset associated with RFID tag 2490 associated with the RFID identifier determined in block 3510 is not listed in manifest 2456.

Method 3500 may additionally optionally include block 3516. In block 3516, method 3500 transmits an indication of the error or non-error to an external device. In one example of block 3516, the RFID controller 2410 transmits an indication of the error or non-error to an external device. For example, the RFID controller 2410 may transmit an indication of the error to external server 804 discussed above with respect to FIG. 7. Block 3516 may be implemented using wireless gateway node 2414 discussed above. Additionally or alternatively, block 3516 may be implemented using one or more external RFID antennas 2420. For example, as discussed above with respect to FIG. 32, the RFID controller 2410 may relay communication between one or more vehicles when each of the vehicles 2501 has an external RFID antenna 2420 that is facing another external RFID antenna 2420 of another vehicle. This allows the advantage of transmitting data to an external server (or other device) even when communication via wireless gateway node 2414, or another communication system, is unavailable. The transmittal of the indication may cause the overall asset management system (that the external server 804 may be associated with) to perform at least one of: canceling a shipment, diverting another shipment of another similar asset, changing a delivery window time, or issuing a new shipment in response to the asset not being removed from the vehicle

Method 3500 may additionally be implemented using the rack system discussed above with respect to FIGS. 30-31. For example, method 3500 may additionally include block 3518. In block 3518, method 3500 instructs a slot tape node positioned at a slot of a rack in a cargo area of a vehicle to activate a status indicator when an asset being loaded into and/or or unloaded from the vehicle is assigned to the slot. In one example of block 3518, a slot tape node 3006 receives an instruction from RFID controller 2410 (or otherwise determines the instruction locally) to activate a status indicator of the slot tape node 3006 when an asset being loaded into and/or unloaded from the vehicle is assigned to the slot 3004. Correlation of the asset being loaded into and/or unloaded from the vehicle is assigned to the slot 3004 may be determined by comparing (e.g., by the slot tape node 3006 and/or the RFID controller 2410) the received RFID identifier 2492 to the manifest 2456. Moreover, additional information may be used to determine what slot 3004 the asset is to be loaded into, such as location of the vehicle to determine that the asset is at it's destination location for delivery, and/or size and shape of the asset and/or slot to determine necessary available space for storing the asset in the slot. Additional functionality discussed above with respect to FIGS. 30-31 may be implemented in addition to block 3518 and in conjunction with or without other blocks of method 3500.

Aspects of method 3500 may be modified based on the overall RFID wireless environment that the method 3500 is being implemented in. For example, block 3520, if included in method 3500, includes receiving RFID configuration settings dynamically configurable based on RFID configuration of nearby RFID systems, wherein the controlling an RFID reader includes operating the at least one cargo area RFID antenna according to the RFID configuration settings. In one example of block 3520, the RFID controller 2410 may receive RFID configuration settings 2458, either from an external device or locally determined by the RFID controller 2410, that are dynamically configurable based on RFID configuration of nearby RFID systems. Block 3504-3510 may then be implemented using the RFID configuration settings 2458. In examples of block 3520, the configuration settings 2458 are further identified using location of the vehicle that the RFID controller 2410 is installed. As discussed above with respect to FIG. 3232, a given wireless environment may be divided into areas 3210, and the RFID configuration settings 2458 may automatically change when the RFID controller 2410 identifies that it has transitioned from one area 3210 to a second area 3210. Additionally and/or alternatively, the RFID controller 2410 may receive RFID signals generated by another RFID system, and manipulate its own RFID configuration 2458 to prevent interference with the another RFID system.

Additional functionality discussed above with respect to FIGS. 24-33 may be included in method 3500, even if not expressly stated herein. As such, it should be appreciated that the functionality discussed herein may be implemented using one or more software, hardware, and firmware modules that operate according to computer-readable instructions that when executed by a processor operate to control the given system to implement said functionality.

Thus, it should be appreciated that the RFID reader systems may be utilized with other spaces other than cargo vehicles. For example, the wireless RFID reader systems may be utilized with passenger transport vehicles (such as a bus, train, plane, rideshare vehicle, etc.), where the RFID tag 2490 is associated with a passenger who is utilizing the passenger transport vehicle. The “cargo area” in the passenger transport vehicle need not be a component of the vehicle itself, but may also be an intermediate loading device, such as a jet bridge in an airport gate, etc., wherein the RFID system is operating to identify passengers loading/unloading a plane (or train, etc.) as they pass through the intermediate loading device. Additionally, the RFID reader systems discussed herein may be applied to any enclosed spaces, such as spaces with Faraday caging/interference (e.g., shipping containers, etc.), warehouses, storage facilities, residences, cold storage (refrigerators and/or freezers), etc. without departing from the scope hereof. The RFID reader systems may also be used in multiple portions of vehicles, such as a trailer, a tractor, a coach, a recreational vehicle, or other examples of vehicles.

### Combination of Features

Features described above as well as those claimed below may be combined in various ways without departing from the scope hereof. The following enumerated examples illustrate some possible, non-limiting combinations:

(A1) A method for fine locationing using a multi-communication-interface system includes: detecting, at a first time using a first wireless-communication interface of a first multi-communication-interface tape node located at a first location in an area, a first wireless signal from a second tape node; activating a first receiver of a second wireless-communication interface of the first multi-communication-interface tape node in response to detecting the first wireless signal; receiving, using the first receiver, a first response signal from a first wireless tag in response to an interrogation signal; deactivating the first receiver; and determining a location of the first wireless tag at the first time as the first location.

(A2) The embodiment (A1) further including receiving, via the first wireless-communication interface, a bit sequence of the interrogation signal; and decoding the first response signal based on the bit sequence.

(A3) In either of embodiments (A1) or (A2), the first wireless-communication interface having a first coverage area greater than a second coverage areas of the first receiver.

(A4) In any of embodiments (A1)-(A3), the first wireless-communication interface implementing a Bluetooth protocol and the second wireless-communication interface implementing an RFID protocol.

(A5) Any of embodiments (A1)-(A4) further including decoding a wireless tag identifier from the first response signal; and correlating the wireless tag identifier to a manifest of wireless tag identifiers associated with the area.

(A6) In any of embodiments (A1)-(A5), the interrogation signal being generated by an external illuminator independent of the first multi-communication-interface tape node.

(A7) Any of embodiments (A1)-(A6) further including activating the external illuminator in response to detecting the first wireless signal.

(A8) Any of embodiments (A1)-(A7) further including activating a transmitter of the second wireless-communication interface in response to detecting the first wireless signal, the transmitter generating the interrogation signal.

(A9) Any of embodiments (A1)-(A8) further including sending a trigger event message from the first multi-communication-interface tape node via the first wireless-communication interface in response to detecting the first wireless signal.

(A10) The embodiment (A9) further including activating a second receiver of a second multi-communication-interface tape node located at a second location in the area, different from the first location, in response to the second multi-communication-interface tape node receiving the trigger event message; detecting, at a second time and using the second receiver, a second response signal transmitted by a second wireless tag in response to the interrogation signal; deactivating the second receiver; and determining a location of the second wireless tag as the second location at the second time.

(A11) In the embodiment (A10), the first multi-communication-interface tape node and the second multi-communication-interface tape node being deployed within the area to resolve bleed-through and multi-path wireless tag detection errors.

(A12) In any of embodiments (A10)-(A11), the first location and the second location being selected such that coverage areas of the first multi-communication-interface tape node and the second multi-communication-interface tape node are within the area, wherein the first multi-communication-interface tape node and the second multi-communication-interface tape node are used collectively to detect only wireless tags within the area.

(A13) In any of embodiments (A10)-(A12), each of a coverage area of the first wireless-communication interface is dynamically configurable by one or more of user interaction and directives from a gateway node.

(A14) In any of embodiments (A10)-(A13), each of a coverage area of the second wireless-communication interface is dynamically configurable by one or more of user interaction and directives from a gateway node.

(A15) In any of embodiments (A10)-(A14), the first multi-communication-interface tape node and the second multi-communication-interface tape node are associated with each other or are associated with the same asset.

(B1) A method for fine locationing using a multi-communication-interface system includes: detecting, using a first wireless-communication interface of a first multi-communication-interface tape node at a first doorway of a first area, a first wireless signal transmitted from a second wireless-communication interface of a wearable multi-communication-interface tape node worn by an operator; sending, from the first multi-communication-interface tape node and via the first wireless-communication interface, a trigger event message; activating a first reader of at least one second multi-communication-interface tape node positioned within the first area in response to receiving the trigger event message; detecting at least one first response signal from at least one first wireless tag within a coverage area of the first reader; and deactivating the first reader, after detecting the at least one first response signal, to conserve power within an internal battery of the at least one second multi-communication-interface tape node.

(B2) In embodiments of (B1), the first multi-communication-interface tape node having a second coverage area that is restricted to the first doorway, the second coverage area forming a curtain at the first doorway to detect the first wireless signal only when the wearable multi-communication-interface tape node is at the first doorway.

(B3) The embodiment (B2) further including determining a direction of movement of the wearable multi-communication-interface tape node based on the first wireless signal.

(B4) Any of embodiments (B1)-(B3) further including activating a second reader of the wearable multi-communication-interface tape node in response to the wearable multi-communication-interface tape node receiving the trigger event message; and detecting, using the second reader, a second response signal from a wireless tag attached to an asset being carried by the operator.

(B5) The embodiment (B4) further including decoding a wireless tag identifier from the second response signal; and validating the wireless tag identifier based on a manifest.

(B6) Any of embodiments (B1)-(B5) further including activating a second reader of the first multi-communication-interface tape node in response to detecting the first wireless signal; and detecting, using the second reader, a second response signal from a second wireless tag attached to an asset being carried by the operator.

(B7) The embodiment (B6) further including decoding a wireless tag identifier from the second response signal; and validating the wireless tag identifier based on a manifest.

(B8) In any of embodiments (B1)-(B7), the first area being a freight area of a vehicle and the first doorway being a bulkhead door between a cab area and the freight area of the vehicle.

(C1) A multi-communication-interface tape node powered from an internal battery includes: a first wireless-communication interface implementing a first wireless protocol; a second wireless-communication interface implementing a second wireless protocol that consumes more power than the first wireless protocol when operational, the second wireless-communication interface having a transmitter and a receiver; a processor; and memory storing machine-readable instructions that, when executed by the processor, cause the processor to: detect a trigger event using the first wireless-communication interface; transition the second wireless-communication interface from an off state to an on state; receive a wireless response signal from a wireless tag via the receiver; decode a wireless identifier from the wireless response signal; and transition the second wireless-communication interface from the on state to the off state to conserve power in the internal battery.

(C2) In embodiments of (C1), the transmitter transmitting a wireless interrogation signal when the second wireless-communication interface is activated.

(C3) In either of embodiments (C1) or (C2), the multi-communication-interface tape node having an adhesive tape platform form factor that facilitates rapid deployment.

(C4) In any of embodiments (C1)-(C3), the second wireless-communication interface having a wireless coverage area configurable with a resolution of less than one foot.

(C5) In any of embodiments (C1)-(C4), the memory storing further machine-readable instructions that, when executed by the processor, further cause the processor to collaborate with at least one other multi-communication-interface tape node to improve locationing within an area that includes the multi-communication-interface tape node and the at least one other multi-communication-interface tape node.

(C6) In any of embodiments (C1)-(C5), the first wireless protocol being Bluetooth and the second wireless protocol being RFID based.

In embodiment (D1) of a first aspect, a system for a detecting and tracking assets in a vehicle, comprises: an RFID reader; at least one cargo area RFID antenna positioned within a cargo area of the vehicle and communicatively coupled with the RFID reader; and an RFID controller comprising: a status indicator for generating a visual indication; a processor; and memory, communicatively coupled with the processor and storing: a manifest defining RFID identifiers corresponding to assets expected to be transported by the vehicle; and firmware having machine-readable instructions that, when executed by the processor, cause the processor to: control the RFID reader to receive an RFID signal from an RFID tag using one of the at least one cargo area RFID antenna, decode the RFID signal to determine an RFID identifier of the RFID tag, and generate, using the status indicator, a visual indication indicative of an asset being loaded in error when the RFID identifier does not correspond to the manifest or not in error when the RFID identifier corresponds to the manifest.

In embodiment (D2) of the first aspect, in the embodiment (D1), the system further comprises a gateway node having wireless communication capability to communicate with a tracking system, wherein the manifest is received via the gateway node from a server of the tracking system.

In embodiment (D3) of the first aspect, in either of the embodiments (D1) or (D2), the firmware further comprises machine-readable instructions that, when executed by the processor, cause the processor to determine, based on previous control and decode iterations, that the RFID identifier is newly detected.

In embodiment (D4) of the first aspect, in any of the embodiments (D1) through (D3), the firmware further comprises machine-readable instructions that, when executed by the processor, cause the processor to determine, based on previous control and decode iterations, that the RFID identifier is no longer detected.

In embodiment (D5) of the first aspect, in any of the embodiments (D1) through (D4), the machine-readable instructions that, when executed by the processor, cause the processor to generate, using the status indicator, a visual indication indicative of an asset being loaded in error when the RFID identifier does not correspond to the manifest, include identifying that the RFID identifier listed in the manifest does not have a delivery address within a threshold distance of a current location of the vehicle or a predefined route of the vehicle.

In embodiment (D6) of the first aspect, in any of the embodiments (D5), the current location of the vehicle is determined using global navigation satellite system (GNSS).

In embodiment (D7) of the first aspect, in any of the embodiments (D5) or (D6), the current location of the vehicle is received from a navigation system of the vehicle.

In embodiment (D8) of the first aspect, in any of the embodiments (D1) through (D7), the RFID tag being an RFID tape node.

In embodiment (D9) of the first aspect, in any of the embodiments (D1) through (D8), the firmware further comprising machine-readable instructions that, when executed by the processor, cause the processor to control the RFID reader to generate an electromagnetic interrogation pulse using one of the at least one cargo area RFID antenna.

In embodiment (D10) of the first aspect, in any of the embodiments (D1) through (D9), wherein an electromagnetic interrogation pulse is generated by an antenna external to the system.

In embodiment (D11) of the first aspect, in any of the embodiments (D1) through (D10), the system further comprises: at least one slot tape node positioned respectively at a slot of a rack in the vehicle and having a status indicator; and the firmware further comprising machine-readable instructions that, when executed by the processor, cause the processor to send an instruction to the slot tape node to activate the status indicator when the asset being loaded is assigned to the slot.

In embodiment (D12) of the first aspect, in any of the embodiments (D11), the manifest defining the slot assigned to the asset.

In embodiment (D13) of the first aspect, in any of the embodiments (D11) or (D12), the slot being one of a plurality of slots within the vehicle, each of the plurality of slots having one or more of the at least one slot tape node.

In embodiment (D14) of the first aspect, in any of the embodiments (D13), each of the slot tape nodes being configured with an operational RFID range limited to detect RFID tags within its slot.

In embodiment (D15) of the first aspect, in any of the embodiments (D11) through (D14), the firmware further comprising machine-readable instructions that, when executed by the processor, cause the processor to instruct the slot tape node to activate its status indicator when the asset in the slot is to be unloaded from the vehicle.

In embodiment (D16) of the first aspect, in any of the embodiments (D1) through (D15), the system further comprises: a driver cabin RFID antenna electrically coupled with the RFID reader; and the firmware further comprising machine-readable instructions that, when executed by the processor, cause the processor to control the RFID reader to detect the RFID tag using the driver cabin RFID antenna when the asset is moved from a cargo area of the vehicle to the driver cabin.

In embodiment (D17) of the first aspect, in any of the embodiments (D1) through (D16), the system further comprises: at least one external RFID antenna mounted at a rear end of the vehicle and facing rearwards; and the firmware further comprising machine-readable instructions that, when executed by the processor, cause the processor to control the RFID reader to detect the RFID tag using the at least one external RFID antenna when the asset is behind the vehicle.

In embodiment (D18) of the first aspect, in any of the embodiments (D17), the firmware further comprises machine-readable instructions that, when executed by the processor, cause the processor to determine that the asset is being delivered when the RFID tag is detected by the at least one external RFID antenna.

In embodiment (D19) of the first aspect, in any of the embodiments (D1) through (D18), wherein the RFID reader, the at least one cargo area RFID antenna, and the RFID controller are co-housed in a monolithic housing.

In embodiment (D20) of the first aspect, in any of the embodiments (D19), the monolithic housing configured to retrofit a cargo area via one or more of, coupling to a ceiling of the cargo area, coupling to ribs within the cargo area, and replacing an existing lamp within the cargo area.

In embodiment (D21) of the first aspect, in any of the embodiments (D19) through (D20), the system further comprises a connector for coupling with additional RFID antennas located external to the monolithic housing.

In embodiment (D22) of the first aspect, in any of the embodiments (D19) through (D21), the system further comprises one or more of a proximity sensor, a vehicle interface for communicating with components of the vehicle, a camera, an input device, a light, and an audio generator.

In embodiment (D23) of the first aspect, in any of the embodiments (D1) through (D22), the system further comprising a power manager coupled to the RFID reader, the at least one cargo area RFID antenna, and the RFID controller to provide power thereto.

In embodiment (D24) of the first aspect, in any of the embodiments (D23), the power manager coupled to a vehicle power source of the vehicle.

In embodiment (D25) of the first aspect, in any of the embodiments (D1) through (D24), the memory further storing RFID configuration settings, wherein the RFID configuration settings are received from an external device and dynamically configurable based on RFID configuration of nearby RFID systems.

In embodiment (D26) of the first aspect, in any of the embodiments (D25), the external device being one or more of a server, another RFID controller associated with a different vehicle, or a warehouse management system.

In embodiment (D27) of the first aspect, in any of the embodiments (D25) through (D26), the RFID configuration settings defining one or more of RFID channel, transmit power control, hopping protocol, and receiver sensitivities for operating the at least one cargo RFID antenna or another RFID antenna.

In embodiment (D28) of the first aspect, in any of the embodiments (D1) through (D27), the firmware storing further computer-readable instructions that, when executed by the processor, cause the system to transmit an indication of the error to an external device.

In embodiment (D29) of the first aspect, in any of the embodiments (D1) through (D28), the system further comprising an external RFID antenna positioned on an exterior of the vehicle, wherein the transmit an indication of the error includes transmitting an indication of the error using the external RFID antenna to another vehicle for relay to an external server.

In embodiment (D30) of the first aspect, in any of the embodiments (D1) through (D29), the firmware storing further computer-readable instructions that, when executed by the processor, cause the system to generate an RFID illumination signal to trigger one or more responding RFID tags, wherein the control an RFID reader includes receive an RFID signal as a relayed RFID response signal from an RFID device other than the one or more responding RFID tags.

In embodiment (D31) of the first aspect, in any of the embodiments (D30), the RFID device being a slot RFID device attached to a package rack within the vehicle.

In embodiment (D32) of the first aspect, in any of the embodiments (D30) through (D31), the RFID device being a RFID tag located on an asset other than the RFID tag associated with the RFID identifier.

In embodiment (E1) of a second aspect, a method comprises: receiving data indicative of a potential change in a load status of assets in a vehicle; in response, controlling an RFID reader to generate an interrogation signal by at least one cargo area RFID antenna located in a cargo area of the vehicle and receive an RFID signal associated with an RFID tag attached to an asset in response to the interrogation signal; determining that an asset is being loaded onto the vehicle based on the received RFID signal; decoding the RFID signal to determine an RFID identifier of the RFID tag; updating a local database stored on a device in the vehicle with the RFID identifier; and tracking the location of the asset within the interior of the vehicle, based on further received RFID signals from the RFID tag.

In embodiment (E2) of the second aspect, in the embodiment (E1), the determining if the asset is being loaded onto the vehicle based on detecting a trajectory of the asset corresponding to entry into the vehicle based on received signal strength of the received RFID signal associated with the RFID tag.

In embodiment (E3) of the second aspect, in either embodiment (E1) or (E2), the method further comprises: comparing the RFID identifier to a received manifest; determining that the asset was erroneously loaded onto the vehicle based on the RFID identifier not being included in the received manifest; notifying a user that the asset was erroneously loaded, within a threshold period of time from when the user began loading the vehicle with the asset.

In embodiment (E4) of the second aspect, in any of the embodiments (E3), wherein the notifying the user comprises activating an indicator on the vehicle.

In embodiment (E5) of the second aspect, in any of the embodiments (E3) through (E4), wherein the notifying the user comprises sending a notification or message to a client device associated with the user.

In embodiment (E6) of the second aspect, in any of the embodiments (E1) through (E5), the method further comprises, responsive to the asset not being removed from the vehicle after notifying the user, communicating with a server to update a database on the asset being located on the vehicle.

In embodiment (E7) of the second aspect, in any of the embodiments (E6), the method further comprising, performing at least one of: canceling a shipment, diverting another shipment of another similar asset, or issuing a new shipment in response to the asset not being removed from the vehicle.

In embodiment (E8) of the second aspect, in any of the embodiments (E1) through (E7), wherein receiving data indicative of a potential load status of assets in the vehicle further comprises receiving sensor data that corresponds to a user entering or exiting the vehicle.

In embodiment (E9) of the second aspect, in any of the embodiments (E8), further comprising detecting the opening or closing of a door of the vehicle.

In embodiment (E10) of the second aspect, in any of the embodiments (E9), wherein the door is a door leading from a driver's cabin to a cargo storage area of the vehicle.

In embodiment (E11) of the second aspect, in any of the embodiments (E9), wherein the door is a door leading from outside of the vehicle to an interior of the vehicle.

In embodiment (E12) of the second aspect, in any of the embodiments (E1) through (E11), further comprising detecting that the asset has moved from a first location inside of the vehicle to a second location inside of the vehicle based on the further received RFID signals from the RFID tag.

In embodiment (E13) of the second aspect, in any of the embodiments (E1) through (E12), further comprising detecting that the asset has moved from a cargo area to a driver's cabin.

In embodiment (E14) of the second aspect, in any of the embodiments (E1) through (E13), further comprising detecting that the asset has moved from a driver's cabin to a cargo area.

In embodiment (E15) of the second aspect, in any of the embodiments (E1) through (E14), further comprising: receiving an inquiry on the location of the asset within the interior of the vehicle, and sending location data corresponding to the location of the asset within the interior of the vehicle, in response.

In embodiment (E16) of the second aspect, in any of the embodiments (E1) through (E17), wherein the location data comprises a rack identifier corresponding to a location on a rack in the vehicle that is holding the asset.

In embodiment (F1) of a third aspect, a method for a detecting and tracking assets in a vehicle, comprising: controlling an RFID reader to receive an RFID signal associated with an RFID tag in response to an interrogation signal transmitted by at least one cargo area RFID antenna located in a cargo area of the vehicle; decoding the RFID signal to determine an RFID identifier of the RFID tag; and generating, using a status indicator, a visual indication indicative of an asset being loaded in error when the RFID identifier is not listed in a manifest or not in error when the RFID identifier corresponds to the manifest.

In embodiment (F2) of the third aspect, in the embodiment (F1), further comprising receiving the manifest from a server of a tracking system.

In embodiment (F3) of the third aspect, in either of the embodiments (F1) or (F2), the method further comprises determining, based on previous controlling and decoding iterations, that the RFID identifier is newly detected.

In embodiment (F4) of the third aspect, in any of the embodiments (F1) through (F3), the method further comprises determining, based on previous controlling and decoding iterations, that the RFID identifier is no longer detected.

In embodiment (F5) of the third aspect, in any of the embodiments (F1) through (F4), the method further comprises generating the visual indication includes identifying the asset being unloaded in error when the RFID identifier listed in the manifest does not have a delivery address within a threshold distance of a current location of the vehicle or a predefined route of the vehicle.

In embodiment (F6) of the third aspect, in any of the embodiments (F5), the method further comprising determining the current location of the vehicle using a global navigation satellite system (GNSS).

In embodiment (F7) of the third aspect, in any of the embodiments (F5) through (F6), further comprising receiving the current location of the vehicle from a navigation system of the vehicle.

In embodiment (F8) of the third aspect, in any of the embodiments (F1) through (F7), further comprising generating an electromagnetic interrogation pulse using at least one cargo area RFID antenna.

In embodiment (F9) of the third aspect, in any of the embodiments (F1) through (F8), further comprising instructing a slot tape node positioned at a slot of a rack in a cargo area of a vehicle to activate a status indicator when an asset being loaded into the vehicle is assigned to the slot.

In embodiment (F10) of the third aspect, in any of the embodiments (F9), wherein the manifest defines the slot assigned to the asset.

In embodiment (F11) of the third aspect, in any of the embodiments (F9) through (F10), wherein the slot is one of a plurality of slots within the vehicle, and each of the plurality of slots has a slot tape node.

In embodiment (F12) of the third aspect, in any of the embodiments (F11), wherein each of the slot tape nodes is configured with an operational RFID range that is configured in a manner to primarily detect RFID tags within its slot.

In embodiment (F13) of the third aspect, in any of the embodiments (F11) through (F12), the method further comprising instructing the slot tape node to activate its status indicator when an asset in the slot is to be unloaded from the vehicle.

In embodiment (F14) of the third aspect, in any of the embodiments (F11) through (F13), the method further comprising controlling the RFID reader to detect the RFID tag using a cabin RFID antenna position in a driver cabin of the vehicle when the asset is moved from the cargo area of the vehicle to the driver cabin.

In embodiment (F15) of the third aspect, in any of the embodiments (F11) through (F14), the method further comprising controlling the RFID reader to detect the RFID tag using at least one external RFID antenna positioned at a rear of the vehicle when the asset is behind the vehicle.

In embodiment (F16) of the third aspect, in any of the embodiments (F11) through (F15), the method further comprising determining that the asset is being delivered when the RFID tag is detected by at least one external RFID antenna.

In embodiment (F17) of the third aspect, in any of the embodiments (F1) through (F16), further comprising receiving RFID configuration settings dynamically configurable based on RFID configuration of nearby RFID systems, wherein the controlling an RFID reader includes operating the at least one cargo area RFID antenna according to the RFID configuration settings.

In embodiment (F18) of the third aspect, in any of the embodiments (F17), the RFID configuration settings being received from an external device, the external device being one or more of a server, another RFID controller associated with a different vehicle, or a warehouse management system.

In embodiment (F19) of the third aspect, in any of the embodiments (F17) through (F18), the RFID configuration settings defining one or more of RFID channel, transmit power control, hopping protocol, and receiver sensitivities for operating the at least one cargo RFID antenna or another RFID antenna of a vehicle.

In embodiment (F20) of the third aspect, in any of the embodiments (F1) through (F19), the method further comprising transmitting an indication of the error to an external device.

In embodiment (F21) of the third aspect, in any of the embodiments (F20), wherein the transmit an indication of the error includes transmit an indication of the error using an external RFID antenna to another vehicle for relay to an external server.

In embodiment (F22) of the third aspect, in any of the embodiments (F1) through (F21), further comprising generating an RFID illumination signal to trigger one or more responding RFID tags, wherein the controlling an RFID reader includes receiving an RFID signal as a relayed RFID response signal from an RFID device other than the one or more responding RFID tags.

In embodiment (F23) of the third aspect, in any of the embodiments (F22), the RFID device being a slot RFID device coupled to a package rack within the vehicle.

In embodiment (F24) of the third aspect, in any of the embodiments (F22), the RFID device being a RFID tag located on an asset other than the RFID tag associated with the RFID identifier.

In embodiment (G1) of a fourth aspect, a system for assisting in loading an unloading a vehicle, comprises: a rack having a plurality of slots each sized and shaped for storing an asset; a plurality of slot RFID devices each associated with one of the slots, each slot RFID device comprising: a wireless transducing circuit that facilitates communication with an RFID controller external to the slot RFID device, a processor, and memory storing computer-readable instructions that when executed by the processor cause the slot RFID device to respectively: identify one or more RFID tags located within the respective slot, transmit indication of presence of one or more RFID tags located within the slot.

In embodiment (G2) of the fourth aspect, in the embodiment (G1), wherein sensitivity and/or operational RFID range of the plurality of slot RFID devices are configured to primarily detected RFID tags primarily within the associated slot.

In embodiment (G3) of the fourth aspect, in any embodiment (G2), wherein the sensitivity and/or operational RFID range of the plurality of slot RFID devices configured based on manipulating one or more of RFID channel, transmit power control, hopping protocol, RF beam profile, and receiver sensitivity of each slot RFID device.

In embodiment (G4) of the fourth aspect, in any of the embodiments (G1) through (G3), at least some of the slot RFID devices further comprising an indicator and/or display.

In embodiment (G5) of the fourth aspect, in any of the embodiments (G4), the at least some of the RFID devices storing further computer-readable instructions that, when executed by the respective processor cause the at least some of the RFID devices to activate the indicator and/or display in response to identification of intended loading or unloading spot of an asset within the rack.

In embodiment (G6) of the fourth aspect, in any of the embodiments (G5), the at least some of the RFID devices storing additional computer-readable instructions that, when executed by the respective processor cause the at least some of the RFID device to receive instruction from an external device indicating the intended loading or unloading spot of an asset within the rack.

In embodiment (G7) of the fourth aspect, in any of the embodiments (G6), the intended loading or unloading spot being based on package size associated with the asset and shape or size of the associated slot.

In embodiment (G8) of the fourth aspect, in any of the embodiments (G1) through (G7), the plurality of RFID devices storing further computer-readable instructions that, when executed by the respective processor cause the respective RFID device to receive an RFID response signal from the RFID tag after an RFID interrogation signal is generated.

In embodiment (G9) of the fourth aspect, in any of the embodiments (G8), the RFID interrogation signal being generated by the RFID controller.

In embodiment (G10) of the fourth aspect, in any of the embodiments (G8), the RFID interrogation signal being generated by the respective RFID slot device.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A multi-communication-interface tape node, comprising:
a wireless transducing circuit;
a passive wireless tag; and
a wake circuit electrically coupled to the passive wireless tag and the wireless transducing circuit;
wherein the wake circuit is configured to activate the wireless transducing circuit in response to an electrical input from the passive wireless tag.

2. The multi-communication-interface tape node of claim 1, the wireless transducing circuit comprising:
a processor;
memory; and
at least one wireless communication interface.

3. The multi-communication-interface tape node of claim 2, further comprising an internal energy source, wherein the wake circuit delivers power from the internal energy source to the wireless transducing circuit in response to the electrical input.

4. The multi-communication-interface tape node of claim 2, the at least one wireless communication interface implementing Bluetooth.

5. The multi-communication-interface tape node of claim 1, wherein the passive wireless tag comprises a passive RFID tag.

6. The multi-communication-interface tape node of claim 5, wherein the passive wireless tag is activated by an RFID interrogation signal.

7. The multi-communication-interface tape node of claim 1, wherein the wireless transducing circuit is configured to deactivate after completing a predetermined function to conserve power.

8. The multi-communication-interface tape node of claim 1, wherein the passive wireless tag is embedded within the multi-communication-interface tape node.

9. The multi-communication-interface tape node of claim 1, further comprising an adhesive layer for attaching the multi-communication-interface tape node to an asset or a surface.

10. A method for activating a wireless transducing circuit of a multi-communication-interface tape node, comprising:
receiving an interrogation signal by a passive wireless tag embedded in the multi-communication-interface tape node;
inputting an electrical signal from the passive wireless tag to a wake circuit of the multi-communication-interface tape node in response to the interrogation signal; and
activating the wireless transducing circuit by the wake circuit.

11. The method of claim 10, wherein the wake circuit connects power to the wireless transducing circuit from an internal energy source of the multi-communication-interface tape node in response to an electrical input from the wake circuit.

12. The method of claim 10, wherein the wake circuit provides an interrupt signal to a processor of the wireless transducing circuit.

13. The method of claim 12, further comprising tracking an asset using a wireless communication interface of the wireless transducing circuit when activated via the passive wireless tag.

14. The method of claim 10, further comprising deactivating the wireless transducing circuit after completion of a predetermined operation.

15. The method of claim 14, wherein the wireless transducing circuit is deactivated by powering down until reactivated by the passive wireless tag.

16. The method of claim 14, wherein the wireless transducing circuit is deactivated by transitioning to a low power state.

17. The method of claim 10, wherein the interrogation signal is generated by an external RFID reader.

18. The method of claim 10, wherein the multi-communication-interface tape node is deployed on an asset in a storage area and the interrogation signal is periodically transmitted by a fixed reader of the storage area.
